(19) United States
(12) Patent Application Publication
(10) Pub. No.: US 2026/0286973 A1
(43) Pub. Date: Sep. 24, 2026

(54) TURBOFAN ENGINE INCLUDING A FAN ACTUATION SYSTEM

(71) Applicant: General Electric Company, Evendale, OH (US)

(72) Inventors: Randy M. Vondrell, Newport, KY (US); Keith A. Miedema, Fairfield, OH (US)

(21) Appl. No.: 19/684,579

(22) Filed: May 21, 2026

Related U.S. Application Data
(63) Continuation-in-part of application No. 19/357,928, filed on Oct. 14, 2025.
Application No. 19/357,928 is a continuation-in-part of application No. 19/097,493, filed on Apr. 1, 2025, now Pat. No. 12,480,415.
Application No. 19/097,493 is a continuation-in-part of application No. 18/400,746, filed on Dec. 29, 2023, now Pat. No. 12,345,178.

(51) Int. Cl. F04D 29/36; F02C 3/06

(52) U.S. Cl. CPC F04D 29/362; F02C 3/06; F05D 2220/323; F05D 2220/36; F05D 2260/15; F05D 2260/74; F05D 2260/79; F05D 2270/64

(57) ABSTRACT

A turbofan engine for an aircraft includes a fan and a fan actuation system. The fan has a plurality of fan blades coupled to a fan shaft having one or more fan bearings. The fan blades are rotatable about a pitch axis. The fan actuation system is disposed within a fan hub and includes one or more actuators for rotating the fan blades about the pitch axis and one or more radial thrust bearings. The fan actuation system is characterized by a fan actuation system length envelope in a range from 8.5 to 24 and given by

$$\frac{{N}_{FB} \times {D}_{FT}}{{L}_{AXIAL} \times ( \frac{{R}_{TB}}{{N}_{FB}} )} .$$

N_{FB} is a number of the fan blades, D_{FT} is a fan tip diameter of the fan blades, R_{TB} is a thrust bearing radius of the radial thrust bearings, and L_{AXIAL} is an axial length from a fan hub tip to the fan bearings.

### CROSS REFERENCE TO RELATED APPLICATIONS

This application is a continuation-in-part of U.S. patent application Ser. No. 19/357,928, filed Oct. 14, 2025, which is a continuation-in-part of U.S. patent application Ser. No. 19/097,493, filed Apr. 1, 2025, and issued as U.S. Pat. No. 12,480,415 on Nov. 25, 2025, which is a continuation-in-part of U.S. patent application Ser. No. 18/400,746, filed on Dec. 29, 2023, and issued as U.S. Pat. No. 12,345,178 on Jul. 1, 2025, the contents of all of which are hereby incorporated by reference herein in their entireties.

### TECHNICAL FIELD

The present disclosure relates generally to fan actuation systems for turbofan engines.

### BACKGROUND

Turbofan engines, for example, for an aircraft, generally include a fan having fan blades, a compressor section, a combustion section, and a turbine section arranged in flow communication with one another. Some turbofan engines include a fan actuation system for actuating the fan blades of the fan.

### BRIEF DESCRIPTION OF THE DRAWINGS

The foregoing and other features and advantages will be apparent from the following, more particular, description of various exemplary aspects, as illustrated in the accompanying drawings, wherein like reference numbers generally indicate identical, functionally similar, or structurally similar elements.

FIG. 1 is a schematic cross-sectional diagram of a turbofan engine, taken along a longitudinal centerline axis of the turbofan engine, according to the present disclosure.

FIG. 2 shows a schematic view of a turbofan engine, according to the present disclosure.

FIG. 3 shows a fan having a fan actuation system, according to the present disclosure.

FIG. 4 is a schematic cross-sectional diagram of a fan actuation system for a turbofan engine, taken along a longitudinal centerline axis of the turbofan engine, according to the present disclosure.

FIG. 5 is a schematic cross-sectional view of a fan actuation system for a turbofan engine, according to another aspect.

FIG. 6 is a schematic cross-sectional view of a fan actuation system for the turbofan engine, taken along the longitudinal centerline axis of the turbofan engine, according to the present disclosure.

FIG. 7 is a schematic cross-sectional view of a fan actuation system for the turbofan engine, taken along the longitudinal centerline axis of the turbofan engine, according to another aspect.

FIG. 8 is a schematic cross-sectional view of a fan actuation system for the turbofan engine, taken along the longitudinal centerline axis of the turbofan engine, according to another aspect.

FIG. 9 is a schematic cross-sectional view of a fan actuation system for the turbofan engine, taken along the longitudinal centerline axis of the turbofan engine, according to another aspect.

FIG. 10 is a schematic cross-sectional view of a fan actuation system for the turbofan engine, taken along the longitudinal centerline axis of the turbofan engine, according to another aspect.

FIG. 11 represents, in graph form, a fan actuation system envelope as a function of a loading envelope, according to the present disclosure.

FIG. 12 represents, in graph form, the fan actuation system envelope as a function of a spacing envelope, according to the present disclosure.

FIG. 13 represents, in graph form, a fan actuation system length envelope as a function of a loading envelope, according to the present disclosure.

FIG. 14 represents, in graph form, the fan actuation system length envelope as a function of a spacing envelope, according to the present disclosure.

FIG. 15 is a schematic view of a forward end of a fan of the turbofan engine of FIG. 2, according to the present disclosure.

FIG. 16 is an enlarged, schematic, cross-sectional diagram of the turbofan engine of FIG. 1 and having one or more fan bearings, taken at detail 16 in FIG. 1, according to the present disclosure.

FIG. 17 is an enlarged, schematic, cross-sectional diagram of the turbofan engine of FIG. 1 and having one or more fan bearings, taken along the longitudinal centerline axis, according to another aspect.

FIG. 18 is a schematic cross-sectional view of a fan bearing for the turbofan engine of FIG. 1, according to another aspect.

FIG. 19 represents, in graph form, a fan bearing envelope as a function of a takeoff thrust of the turbofan engine, according to the present disclosure.

FIG. 20 represents, in graph form, the fan bearing envelope as a function of the takeoff thrust, according to another aspect.

FIG. 21 is an enlarged schematic, cross-sectional view of a segment of a fan of having a fan actuation system, according to another aspect.

FIG. 22 includes side views of blades of the fan of FIG. 3 in three different pitch angles.

FIG. 23 illustrates an example implementation of a first pitch control protection system with a protection valve in a first position.

FIG. 24 illustrates an example implementation of the first pitch control protection system of FIG. 23 with a protection valve in a second position.

FIG. 25 illustrates an example implementation of the first pitch control protection system of FIG. 23 with a protection valve in a third position.

FIG. 26 illustrates an example implementation of the first pitch control protection system of FIG. 23 with a protection valve in a fourth position.

FIG. 27 illustrates an example implementation of the first pitch control protection system of FIG. 23 with a protection valve in a fifth position.

FIG. 28 illustrates example functions that may be implemented by a protection valve controller of FIGS. 23-27.

FIG. 29 is a block diagram of an example implementation of the protection valve controller of FIGS. 23-27.

FIG. 30 is a flowchart representative of example machine-readable instructions and/or operations that may be executed, instantiated, and/or performed by programmable circuitry to implement the protection valve controller of FIG. 29 in connection with the example pitch control system of FIGS. 23-27.

FIG. 31 illustrates an example implementation of a second pitch control protection system with a protection valve in a first position.

FIG. 32 illustrates an example implementation of the second pitch control protection system of FIG. 31 with a protection valve in a second position.

FIG. 33 illustrates an example implementation of the second pitch control protection system of FIG. 33 with a protection valve in a third position.

FIG. 34 illustrates an example implementation of the second pitch control protection system with a protection valve in a fourth position.

FIG. 35 illustrates an alternative example implementation of the second pitch control protection system of FIG. 31 with a ground range valve in a first position.

FIG. 36 illustrates an example implementation of the second pitch control protection system of FIG. 35 with a ground range valve in a second position.

FIG. 37 illustrates another alternative example implementation of the second pitch control protection system of FIG. 31 with a protection valve in a first position.

FIG. 38 illustrates an example implementation of the second pitch control protection system of FIG. 37 with a protection valve in a second position.

FIG. 39 illustrates example functions that may be implemented by a protection valve controller of FIGS. 31-38.

FIG. 40 is a flowchart representative of example machine-readable instructions and/or operations that may be executed, instantiated, and/or performed by programmable circuitry to implement the protection valve controller of FIG. 29 in connection with the example pitch control system of FIGS. 31-38.

FIG. 41 illustrates an example implementation of a third pitch control protection system with a protection valve in a first position.

FIG. 42 illustrates an example implementation of the third pitch control protection system of FIG. 41 with a protection valve in a second position.

FIG. 43 illustrates an example implementation of the third pitch control protection system of FIG. 41 with a protection valve in a third position.

FIG. 44 illustrates an example implementation of the third pitch control protection system of FIG. 41 with a protection valve in a fourth position.

FIG. 45 illustrates example functions that may be implemented by a protection valve controller of FIGS. 41-44.

FIG. 46 is a flowchart representative of example machine-readable instructions and/or operations that may be executed, instantiated, and/or performed by programmable circuitry to implement the protection valve controller of FIG. 29 in connection with the example pitch control system of FIGS. 31-38.

FIG. 47 is a flowchart representative of example machine-readable instructions and/or operations that may be executed, instantiated, and/or performed by programmable circuitry to implement the protection valve controller of FIG. 29 in connection with the example pitch control system of FIGS. 31-38.

FIG. 48 is a block diagram of an example processing platform including programmable circuitry structured to execute, instantiate, and/or perform the example machine-readable instructions and/or perform the example operations of FIGS. 30, 40, 46, and/or 47 to implement the protection valve controller of FIG. 29.

### DETAILED DESCRIPTION

Features, advantages, and aspects of the present disclosure are set forth or apparent from a consideration of the following detailed description, drawings, and claims.

Moreover, the following detailed description is exemplary and intended to provide further explanation without limiting the scope of the disclosure as claimed.

Various aspects of the present disclosure are discussed in detail below. While specific aspects are discussed, this is done for illustration purposes only. A person skilled in the relevant art will recognize that other components and configurations may be used without departing from the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle, and refer to the normal operational attitude of the turbofan engine or vehicle. For example, with regard to a turbofan engine, forward refers to a position closer to an engine inlet and aft refers to a position closer to an engine nozzle or exhaust.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbofan engine. Moreover, the terms “radial” and “radially” refer to directions and orientations that extend substantially perpendicular to the centerline of the turbofan engine. In addition, as used herein, the terms “circumferential” and “circumferentially” refer to directions and orientations that extend arcuately about the centerline of the turbofan engine.

As used herein, a “turbofan engine” includes a core flowpath defined by a compressor section, a combustion section, and a turbine section, and a fan that directs air into the core flowpath, and rated for use in a regional aircraft, a narrow body aircraft, or a wide body aircraft. A turbofan engine rated for use on a regional aircraft will have a maximum takeoff thrust in a range from ten thousand pound-force to twenty thousand pound-force (10,000 lbf to 20,000 lbf). A turbofan engine rated for use on a narrow body aircraft will have a maximum takeoff thrust in a range from fifteen thousand pound-force to thirty thousand pound-force (15,000 lbf to 30,000 lbf). A turbofan engine rated for use on a wide body aircraft will have a maximum takeoff thrust in a range from forty thousand pound-force to one hundred ten thousand pound-force (40,000 lbf to 110,000 lbf).

As used herein, the term “cruise” or “cruising speed” refers to operation of a turbofan engine utilized to power an aircraft that may operate at a cruising speed when the aircraft levels after climbing to a specified altitude. A turbofan engine may operate at a cruising speed that is from 50% to 90% of a rated speed, such as from 70% to 80% of the rated speed. In some aspects, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is in a range from approximately 28,000 ft. to approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is in a range from approximately 4.85 psia to approximately 0.82 psia based on a sea-level pressure of approximately 14.70 psia and sea-level temperature at approximately 59 degrees Fahrenheit. In another example, cruise altitude is in a range from approximately 4.85 psia to approximately 2.14 psia. In certain examples, the ranges of cruise altitude defined by pressure may be adjusted based on a different reference sea-level pressure and/or sea-level temperature.

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a “fan tip diameter” is defined as a diameter of a fan blade and is measured through the longitudinal centerline axis of the turbofan engine to a fan tip of the fan blade at an axial location of the blade where the diameter is a maximum.

As used herein, a Mach number is a ratio of the speed of the aircraft to the speed of sound in the surrounding airflow. The Mach number at cruise as defined herein is a maximum operating Mach number as provided by a Type Certificate Data Sheet (TCDS) for the turbofan engine.

An aircraft's quoted cruise Mach number is generally known in the industry to be applied during a “standard day” temperature day. Therefore, the temperature is a fixed value based on altitude according to the established International Standard Atmosphere (ISA) tables. High speed civil gas turbine powered transport aircraft quote their speed by Mach number and have set cruising altitudes based on their size and mission profile (e.g., smaller aircraft fly at lower altitudes). Turboprops and smaller aircraft may have their cruising speed quoted in knots such as VTAS (velocity true airspeed) or KCAS (knots calibrated air speed), where ambient temperature is considered. Engine performance can be modeled for “hot days” or “cold days” where the ambient temperature is hotter or cooler than standard day by a prescribed amount, but this is part of off-design performance. Further, between 36,000 and 80,000 feet, where most commercial aircraft cruise, the ambient temperature is actually constant.

As used herein, a “thrust bearing radius” of a radial thrust bearing is defined in the radial direction through the longitudinal centerline axis to a radial center of the radial thrust bearing. Particularly, the radial center of the radial thrust bearing is a radial center of the rolling elements of the radial thrust bearing.

As used herein, a “fan hub axial length” is an axial length, in the axial direction (e.g., parallel with the longitudinal centerline axis 112) from a fan hub tip of the fan hub to a pitch axis P of the fan blades of the fan.

As used herein, a “fan actuation system axial length” is an axial length, in the axial direction (e.g., parallel with the longitudinal centerline axis 112), from an axially forward-most surface of the fan actuation system to the pitch axis P of the fan blades of the fan.

As used herein, a “fan bearing axial length” is an axial length, in the axial direction (e.g., parallel with the longitudinal centerline axis 112) from the pitch axis P of the fan blades of the fan to an axial center of one or more fan bearings that support rotation of the fan shaft.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

As used herein, a “rolling element diameter” of a rolling element of the fan bearing is a distance of a straight line passing from side to side through a center of the rolling element.

As used herein, a “fan hub trailing edge radius” or “R_{FHTE}” of a fan hub is defined in the radial direction from the longitudinal centerline axis to the fan hub at a trailing edge of the fan blades.

As used herein, a “fan tip radius” of a fan blade is defined in the radial direction from the longitudinal centerline axis to the fan tip at the trailing edge of the fan blade.

As used herein, a “fan hub radius ratio” is defined as a ratio of the fan hub trailing edge radius R_{FHTE} to the fan tip radius of the fan blades.

As used herein, a “fan hub leading edge radius” or “R_{FHLE}” of a fan hub is defined in the radial direction from the longitudinal centerline axis to the fan hub at a leading edge of the fan blades.

As used herein, a “fan bearing radius” or “R_{FBRG}” of a fan bearing is defined as a distance along the radial direction from the longitudinal centerline axis of the turbofan engine to a central axis or a center point of the fan bearing.

As used herein, a “fan bearing radius ratio” or “R_{FHLE}:R_{FBRG}” is a ratio of the fan hub leading edge radius R_{FHLE} to the fan bearing radius R_{FBRG}.

As used herein a “port” is an opening in a device (e.g., such as a valve) which fluid can flow into or out from. In some examples, a port may be referred to as an input (a port with fluid flowing in) and/or an output (a port with fluid flowing out).

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for turbofan engines that have a variable pitch fan. Such engines include a fan actuation system that includes one or more actuators for changing a pitch of fan blades of the variable pitch fan. The fan actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch of the fan blades. Some fan actuation systems are designed for turboprop engines that include a propeller, rather than a fan.

Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The loading environment associated with the variable pitch mechanism for turboprop engines is less than the loading environment presented for a variable pitch turbofan engine. There is a lower disk loading capability requirement on parts (e.g., trunnion, bearings, gearing, actuators, etc.) and associated less actuation force resources needed (e.g., hydraulic fluid) to operate a variable pitch turboprop as compared to a variable pitch turbofan engine. At the same time, the available space, the desirable space, or the volume in that part of the engine for the higher-load-carrying fan blade pitch actuation system and the greater number of blades of a turbofan engine is not correspondingly larger than the space available for the lower-load-carrying fan blade pitch actuation system with fewer fan blades of a turboprop. Turbofan engines having variable pitch fan blades require more compactness for the pitch change system, relative to a turboprop, when considering the larger space requirements assumed if one were to simply scale-up a pitch actuation system for a turboprop for use in a turbofan engine. This can be realized when one considers that a larger, stronger structure is needed to support the more numerous blades and react the higher pitch loads associated with a turbofan engine. One cannot simply scale-up the space available for a pitch change mechanism and associated structure, and also scale up to account for the impact of a significantly increased number of blades when designing a variable pitch turbofan engine. Accommodation of the pitch change mechanism, trunnion, and associated structure for holding and articulating the fan blades within an engine housing therefore presents unique challenges for the turbofan engine in terms of the available space. The existing pitch change mechanisms and structure used to support blades in turboprop engines are not faced with similar challenges and therefore provide limited insight into how to implement a variable pitch mechanism within the more limited space, and more numerous fan blade system of a turbofan engine.

Many actuation systems for turboprop engines include a counterweight system to help pitch the propeller blades (e.g., the weight counteracts inertial loading associated with turning the propeller blade). For turbofan engines, a counterweight system may not be feasible because there is not the space available to accommodate the counterweight system. Thus, an alternative is needed to articulate the blades without exceeding load limits, which implies more compactness given the limited space available. Additionally, it was realized that pitch lock devices to lock the more-numerous fan blades in a feather position for turbofan engines, in case of fan actuation system failure, need to be considered when determining the minimum size needed for the turbofan engine fan actuation system. Additionally, it should be realized the very different types of inlets between a turboprop engine, on the one hand, and turbofan engine on the other hand, impact the amount of available space within the engine housing. Inlets to the turbofan engine (e.g., inlet to the hot gas path through the compressor section, the combustion section, and the turbine section) of a turboprop engine have a relatively narrow circumferential extent (sometimes called “chin” inlets). As such, there is more space available for a pitch change mechanism. Inlets to turbofan engines, however, have annular inlets, which take up more space within the engine housing than the more limited circumferential extent occupied by a turboprop inlet. Accommodating both a pitch change mechanism and annular inlet poses a unique challenge for a turbofan engine with variable pitch fan blades.

For at least these reasons, the loading on a pitch change mechanism and packaging of this system for a turbofan engine having greater number of blades than a turboprop engine presents challenges. It is not simply a matter of scaling-up the space available and size of component parts used in a turboprop engine fan actuation system. Indeed, it has been found that the problem is both unique to the engine type and complex—not amenable to a ready solution based on pre-existing variable pitch turboprop engine design. The inventors, seeking a need to find a solution to this problem, designed and tested several different turbofan engine architectures in an effort to arrive at a fan actuation system that met both the higher loading and more compact space requirements of a turbofan engine.

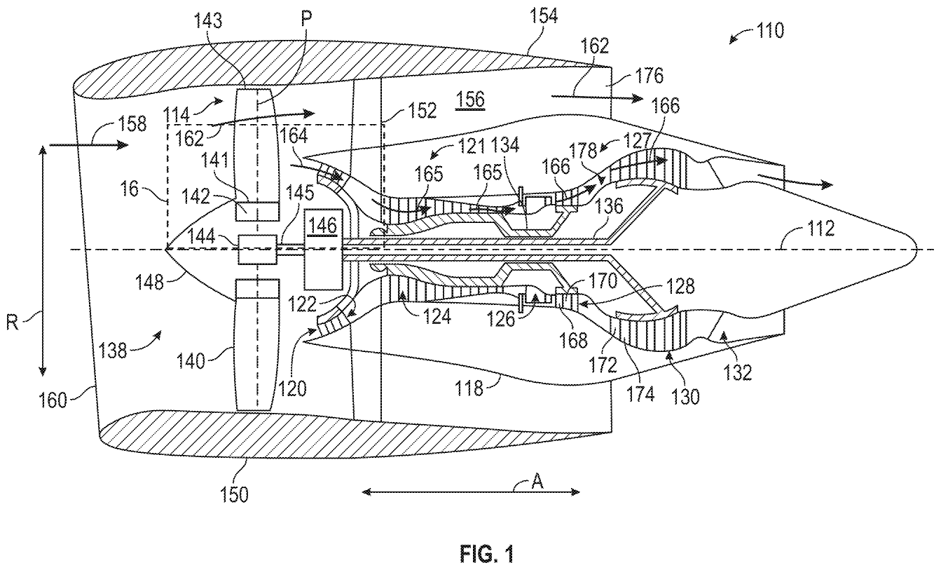

Referring now to the drawings, FIG. 1 is a schematic cross-sectional diagram of a turbofan engine 110, taken along a longitudinal centerline axis 112 of the turbofan engine 110, according to an aspect of the present disclosure. As shown in FIG. 1, the turbofan engine 110 defines an axial direction A (extending parallel to the longitudinal centerline axis 112 provided for reference) and a radial direction R that is normal to the axial direction A. In general, the turbofan engine 110 includes, in serial flow relationship, a fan assembly 114, a compressor section 121, a combustion section 126, and a turbine section 127. The compressor section 121, the combustion section 126, and the turbine section 127 are substantially enclosed within a core cowl 118 that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustion section 126 is downstream of the compressor section 121 and includes a combustor. The turbine section 127 is downstream of the combustion section 126 and includes a high-pressure (HP) turbine 128 followed downstream by a low-pressure (LP) turbine 130, also referred to as a power turbine. The turbofan engine 110 also includes a core exhaust nozzle 132 that is downstream of the turbine section 127. The turbofan engine 110 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbofan engine 110 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustion section 126, the turbine section 127, and the core exhaust nozzle 132 together define a core air flow path.

In FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R from a fan root 141 to a fan tip 143. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are together rotatable about the longitudinal centerline axis 112 via a fan shaft 145 that is powered by the LP shaft 136 across a power gearbox, also referred to as a gearbox assembly 146.

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range from 3.5:1 to 5:1 for a ducted engine (e.g., the turbofan engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbofan engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

The fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the core cowl 118. In this way, the turbofan engine 110 is a ducted engine. The nacelle 150 is supported relative to the core cowl 118 by a plurality of fan guide vanes 152, also referred to as outlet guide vanes, that is spaced circumferentially about the nacelle 150. Moreover, a downstream section 154 of the nacelle 150 extends over an outer portion of the core cowl 118 to define a bypass airflow passage 156 therebetween.

During operation of the turbofan engine 110, a volume of air 158 enters the turbofan engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to form compressed air 165, and the compressed air 165 is routed through the HP compressor 124 and into the combustion section 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine blades 174 that are coupled to the LP shaft 136. This causes the LP shaft 136 to rotate, thereby supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 to provide propulsive thrust at a thrust level of the turbofan engine 110. The thrust level of the turbofan engine 110 includes a cruise thrust level defined by a cruise Mach number M_{cruise} that is the Mach number of the turbofan engine 110 at cruise conditions, or mid-level power conditions. Simultaneously, the bypass air 162 is directed through the bypass airflow passage 156 before being exhausted from a fan exhaust nozzle 176 of the turbofan engine 110, also providing propulsive thrust. The HP turbine 128, the LP turbine 130, and the core exhaust nozzle 132 at least partially define a hot gas path 178 for routing the combustion gases 166 through the turbofan engine 110.

The turbofan engine 110 depicted in FIG. 1 is by way of example only. In other aspects, the turbofan engine 110 may have other suitable configurations. In other aspects, any other suitable number or configuration of compressors, turbines, shafts, or a combination thereof may be provided. The turbofan engine 110 may also be a direct drive engine, which does not have a power gearbox. The fan speed is the same as the LP shaft speed for a direct drive engine. In still other aspects, aspects of the present disclosure may be incorporated into other suitable turbofan engines, such as, for example, propfan (e.g., unducted fan) engines.

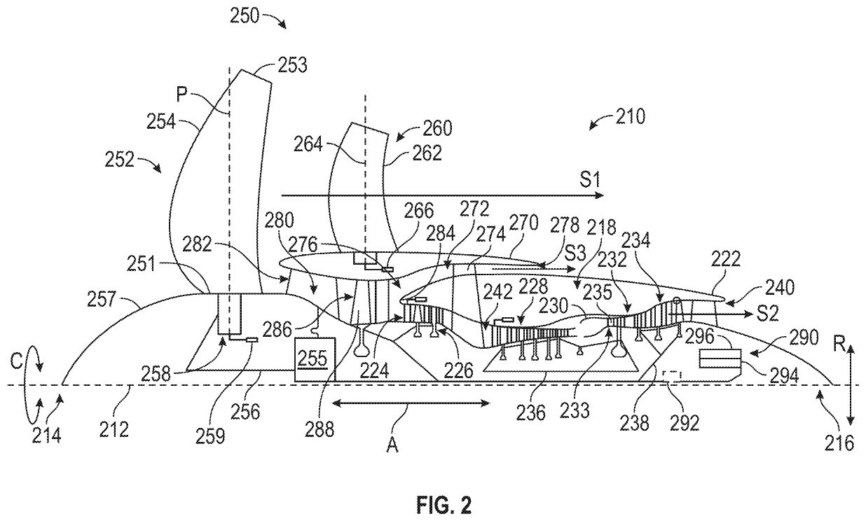

FIG. 2 shows a schematic view of an unducted, three-stream, turbofan engine 210 for an aircraft, that may incorporate one or more aspects of the present disclosure. In this way, the turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. Moreover, the turbofan engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a fan assembly 250, a compressor section, a combustion section, a turbine section, and an exhaust section. Particularly, as shown in FIG. 2, the turbofan engine 210 includes an engine core 218 and a core cowl 222 that annularly surrounds the compressor section, the combustion section, and the turbine section. The core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbofan engine 210 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in FIG. 2. After driving each of the HP turbine 232 and the LP turbine 234, the combustion gases exit the turbofan engine 210 through a core exhaust nozzle 240. The turbofan engine 210 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252, also referred to as a primary fan. In FIG. 2, the fan 252 is an open rotor fan, also referred to as an unducted fan. However, in other aspects, the fan 252 may be ducted, e.g., by a fan casing or a nacelle circumferentially surrounding the fan 252, similar to the aspect of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 for an unducted fan engine (e.g., the turbofan engine 210). The gearbox may be a single stage gearbox or a compound gearbox (e.g., having a plurality of stages). The LP shaft 238, the gearbox assembly 255, and the fan shaft 256 are disposed in an in-line configuration such that the LP shaft 238, the gearbox assembly 255, and the fan shaft 256 are coaxial and are each disposed about the longitudinal centerline axis 212.

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. In FIG. 2, each of the plurality of fan blades 254 of the fan 252 is rotatable about their respective pitch axis P, e.g., in unison with one another. A fan actuation system 258 controls one or more actuators 259 to pitch the fan blades 254 about their respective pitch axis P. The fan actuation system 258 is disposed within the fan hub 257.

The fan assembly 250 further includes a fan guide vane array 260 that includes a plurality of fan guide vanes 262 (only one shown in FIG. 2) disposed around the longitudinal centerline axis 212. In FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. In FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other aspects, each of the plurality of fan guide vanes 262 is fixed or is unable to be pitched about the vane pitch axis 264. The plurality of fan guide vanes 262 is mounted to a fan cowl 270.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228, and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234, and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total propulsion system thrust. In some aspects, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain aspects, an operating temperature of the secondary air stream is less than a maximum compressor discharge temperature for the engine. Furthermore, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other aspects, the turbofan engine 210 may have other suitable configurations. For example, the fan 252 can be ducted by a fan casing or a nacelle such that a bypass passage is defined between the fan casing and the fan cowl 270. Moreover, in other aspects, any other suitable number or configuration of compressors, turbines, shafts, or a combination thereof may be provided. Further, aspects of the present disclosure may be incorporated into any other suitable turbofan engine, such as, for example, turbofan engines defining two streams (e.g., a bypass stream and a core air stream).

Further, in FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some aspects, the electric machine 290 can be coupled with the LP shaft 238 and positioned forward of the mid-fan 286 along the axial direction A. In some aspects, the turbofan engine of FIG. 1 also includes an electric machine coupled to the LP shaft and located in the tail cone of the engine.

In some aspects, the electric machine 290 can be an electric motor operable to drive or to motor the LP shaft 238. In other aspects, the electric machine 290 can be an electric generator operable to convert mechanical energy into electrical energy. In this way, electrical power generated by the electric machine 290 can be directed to various engine systems or aircraft systems. In some aspects, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

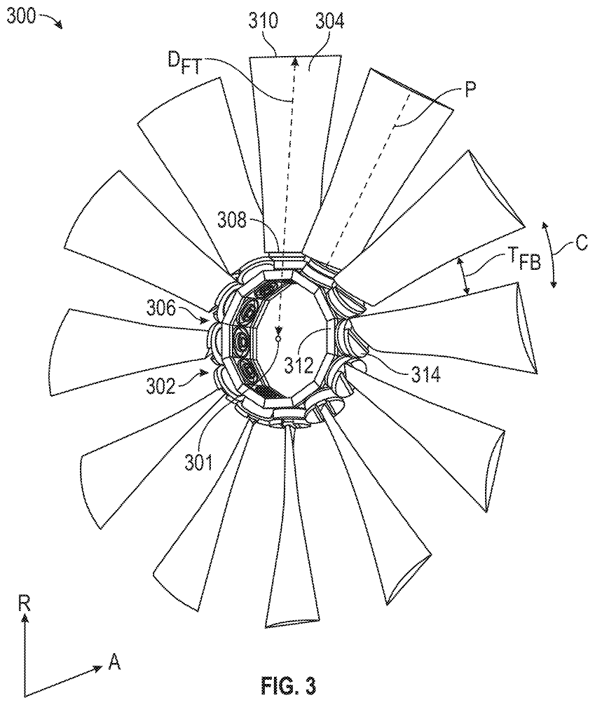

FIG. 3 shows a fan 300 having a fan actuation system 302, according to the present disclosure. The fan 300 can be utilized as the fan 138 of FIG. 1 or as the fan 252 of FIG. 2. The fan 300 includes a plurality of fan blades 304 that is coupled to a disk 306 and is spaced circumferentially about a longitudinal centerline axis 301 of the fan 300. The fan 300 includes a number of fan blades, and, in particular, includes ten to eighteen fan blades 304. In FIG. 3, the fan 300 includes twelve fan blades 304. Each fan blade 304 extends in the radial direction R along a span of the fan blade 304 and from a fan root 308 to a fan tip 310. Each fan blade 304 has a fan tip diameter D_{FT} that extends from the longitudinal centerline axis 301 to the fan tip 310 of each fan blade 304. While the fan tip diameter D_{FT} is detailed with respect to the plurality of fan blades 304, the fan tip diameter D_{FT} is a measurement of any of the fan blades detailed herein. The fan tip diameter D_{FT} is in a range from seven feet to fourteen feet (7 ft. to 14 ft.), as detailed further below. A tangential fan blade distance T_{FB} is defined in the circumferential direction C as a circumferential distance or a tangential distance between adjacent fan blades 304. As used herein, adjacent means two fan blades with no intervening fan blade therebetween.

The disk 306 includes a plurality of disk segments 312 that is rigidly coupled together or integrally molded together in a generally annular shape. One fan blade 304 is coupled to each disk segment 312 at a trunnion mechanism 314 of the fan actuation system 302. The trunnion mechanism 314 facilitates retaining the respective fan blade 304 on the disk 306 during rotation of the disk 306, while still rendering the respective fan blade 304 rotatable relative to the disk 306 about a pitch axis P of the fan blade 304. For example, the trunnion mechanism 314 provides a load path to the disk 306 for the centrifugal load generated by the fan blade 304 during rotation of the fan blade 304 about the longitudinal centerline axis 301. The trunnion mechanism 314 includes a plurality of bearings disposed within the disk segment 312 that allows the fan blade 304 to rotate about the pitch axis P.

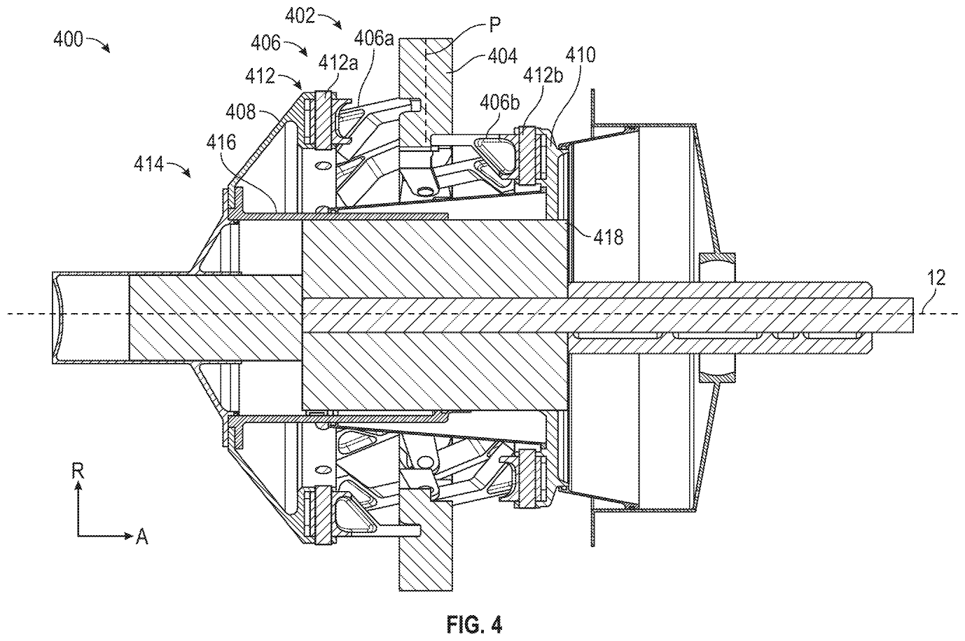

FIG. 4 is a schematic cross-sectional diagram of a fan actuation system 400 for a turbofan engine, taken along a longitudinal centerline axis 112 of the turbofan engine, according to the present disclosure. The fan actuation system 400 can be utilized for any of the fans detailed herein. The fan actuation system 400 includes a trunnion mechanism 402 and one or more actuators 414. The trunnion mechanism 402 includes a plurality of trunnions 404. Each fan blade of the fan is coupled to a respective trunnion 404. Each of the plurality of trunnions 404 is rotatable about a pitch axis P to pitch the fan blades of the fan. The trunnion mechanism 402 includes a plurality of trunnion links 406 that is coupled to the plurality of trunnions 404. For example, a respective trunnion link 406 is coupled to a respective trunnion 404. The plurality of trunnion links 406 includes a plurality of forward trunnion links 406a and a plurality of aft trunnion links 406b that are coupled to the plurality of trunnions 404. The plurality of forward trunnion links 406a is pivotably coupled to the plurality of trunnions 404.

The trunnion mechanism 402 includes a plurality of unison rings 408, 410 including a forward unison ring 408 positioned forward of the plurality of trunnions 404 and an aft unison ring 410 positioned aft of the plurality of trunnions 404. The forward unison ring 408 and the aft unison ring 410 couple the plurality of trunnions 404 together. The plurality of trunnion links 406 is coupled to the forward unison ring 408 or the aft unison ring 410 via a plurality of pins 412. The plurality of forward trunnion links 406a is pivotably coupled to the forward unison ring 408 by a plurality of forward pins 412a such that the plurality of trunnions 404 is coupled to the forward unison ring 408. For example, each forward trunnion link 406a extends forward from a respective trunnion 404 to the forward unison ring 408 and a respective forward pin 412a is disposed through the forward trunnion link 406a at the forward unison ring 408 to pivotably couple the forward trunnion link 406a to the forward unison ring 408. Each aft trunnion link 406b extends aftward from the respective trunnion 404 to the aft unison ring 410 and a respective aft pin 412b is disposed through the aft trunnion link 406b at the aft unison ring 410 to pivotably couple the aft trunnion link 406b to the aft unison ring 410. In this way, each of the plurality of trunnions 404 is pivotably coupled to the forward unison ring 408 and to the aft unison ring 410 such that the plurality of trunnions 404 can pivot about the pitch axis P in unison.

The one or more actuators 414 include a hydraulic cylinder 416 and a piston 418 disposed within the hydraulic cylinder 416. The hydraulic cylinder 416 and the piston 418 are movable along the axial direction A. In this way, the one or more actuators 414 are hydraulic linear actuators such that the hydraulic cylinder 416 and the piston 418 move linearly along the axial direction A (e.g., in opposite directions along the longitudinal centerline axis 112). The forward unison ring 408 is coupled to the hydraulic cylinder 416 such that the forward unison ring 408 moves when the hydraulic cylinder 416 moves. The aft unison ring 410 is coupled to the piston 418 such that aft unison ring 410 moves when the piston 418 moves.

In operation, the fan actuation system 400 moves the plurality of fan blades 140 (FIG. 1) between a first end position and a second end position. The first end position, referred to herein as a feather position, corresponds to a position in which the plurality of fan blades 140 produces the least (e.g., minimal) amount of resistance or drag. In some examples, this position corresponds to a position in which the plurality of fan blades 140 is aligned or substantially aligned (e.g., ±5°) with the flow of the volume of air (e.g., the volume of air 158 of FIG. 1). The second end position is a reverse position in which the plurality of fan blades 140 exceeds, for example, a plane that is transverse to the longitudinal centerline axis 112 (the direction of forward movement of the aircraft) by a certain degree (e.g., 30°) so as to assist with the braking of the aircraft. Therefore, in some examples, the angular stroke of the plurality of fan blades 140 between the feather position and the reverse position is, for example, approximately 120°. The plurality of fan blades 140 can be moved to any position or any angle between the feather position and the reverse position depending on the phase of flight to improve (e.g., optimize) efficiency of the turbofan engine 110 (FIG. 1). In some examples, one or more stops or limits are provided to prevent the plurality of fan blades 140 from being rotated beyond the two end positions. In other examples, the fan actuation system 400 can be configured to provide a greater stroke or a lesser stroke and/or the end positions may be different.

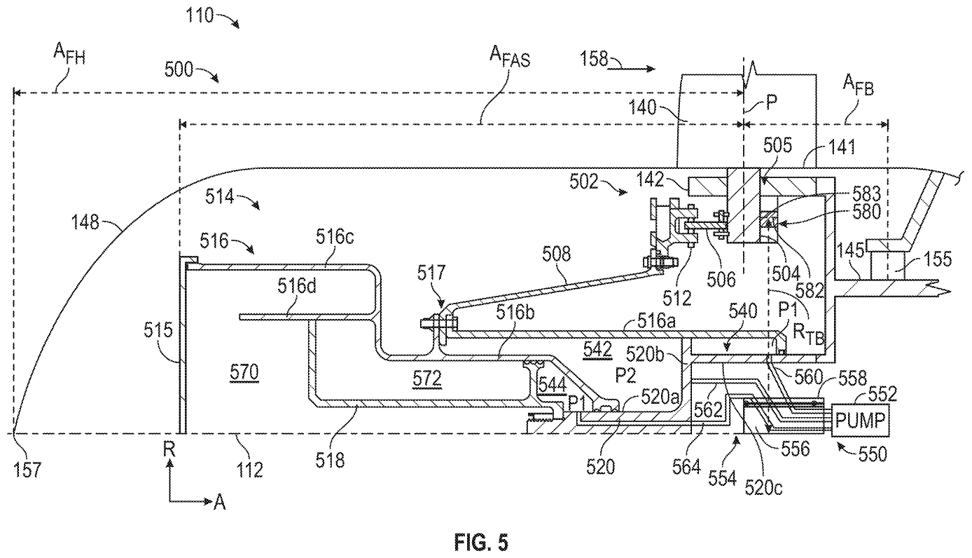

A hydraulic system supplies a hydraulic fluid (e.g., oil) to one or more hydraulic chambers of the one or more actuators 414 to move the hydraulic cylinder 416 and the piston 418 to pitch the plurality of fan blades 140. An exemplary hydraulic system and hydraulic chambers are detailed below with respect to FIG. 5. The plurality of trunnions 404 is disposed in FIG. 4 such that the plurality of fan blades 140 is in the first end position (e.g., the feather position). The pressure of the hydraulic fluid in the one or more hydraulic chambers can be increased to move the hydraulic cylinder 416 in a first direction and to move the piston 418 in a second direction such that the plurality of trunnions 404 move the plurality of fan blades 140 from the feather position towards the reverse position (e.g., the second end position). For example, the hydraulic cylinder 416 can move axially aftward (e.g., to the right in FIG. 4) and the piston 418 can move axially forward (e.g., to the left in FIG. 4) when the pressure of the hydraulic fluid is increased. To move the plurality of fan blades 140 from the reverse position to the feather position, the pressure of the hydraulic fluid in the one or more hydraulic chambers can be decreased to move the hydraulic cylinder 416 in the second direction (e.g., axially forward) and to move the piston 418 in the first direction (e.g., axially aftward).

As the hydraulic cylinder 416 moves axially along the axial direction A, the hydraulic cylinder 416 causes the forward unison ring 408 to move, thereby causing the plurality of forward trunnion links 406a to pivot and to pitch the plurality of trunnions 404, and, therefore, pitching the plurality of fan blades 140 about the pitch axis P. At the same time, movement of the piston 418 along the axial direction A causes the aft unison ring 410 to move, thereby, causing the plurality of aft trunnion links 406b to pivot in an opposite direction as the forward trunnion links 406a, and, therefore, pitching the plurality of fan blades 140 about the pitch axis P. In this way, the fan actuation system 400 translates linear motion of the one or more actuators 414 (e.g., along the axial direction A) into rotational motion of the plurality of fan blades 140. Such a configuration enables a compact and lightweight design of the fan actuation system 400. Further, each of the hydraulic cylinder 416 and the piston 418 provides only half of the force needed to actuate the plurality of trunnions 404 and provides a redundant path in the event that one of the hydraulic cylinder 416 or the piston 418 fails.

FIG. 5 is a schematic cross-sectional view of a fan actuation system 500 for a turbofan engine, according to another aspect. The fan actuation system 500 is shown as being utilized in the turbofan engine 110, but can be utilized in the turbofan engine 210. Only the top half of the fan actuation system 500 is shown in FIG. 5. However, the fan actuation system 500 is symmetrical about the longitudinal centerline axis 112. The fan actuation system 500 may also be referred to as a fan pitch actuation system (FPAS). The fan actuation system 500 controls the pitch (e.g., angle, orientation) of the plurality of fan blades 140 about the pitch axis P. In some examples, the fan actuation system 500 can move the fan blades 140 between a first end position and a second end position.

FIG. 5 shows the fan shaft 145 of the turbofan engine 110 (FIG. 1). The fan shaft 145 is coupled to, and driven by, the LP shaft 136 (FIG. 1). One or more fan bearings 155 support rotation of the fan shaft 145. The one or more fan bearings 155 can include roller bearings, tapered roller bearings, ball bearings, or the like. The one or more fan bearings 155 are disposed aft of the fan disk 142. As shown in FIG. 5, the fan disk 142 is coupled to (e.g., directly or indirectly), and driven by, the fan shaft 145. Each of the plurality of fan blades 140 is coupled to, and extends radially outward from, the fan disk 142. Therefore, as the fan shaft 145 is rotated (via the LP shaft 136), the fan shaft 145 rotates the fan disk 142, which rotates the plurality of fan blades 140 to generate thrust. The fan hub 148 (shown schematically in FIG. 5) includes a fan hub tip 157 that defines an axially forward-most point of the fan hub 148.

The fan actuation system 500 includes a trunnion mechanism 502 including a plurality of trunnions 504. Each fan blade 140 is coupled to a respective one of the plurality of trunnions 504. The plurality of trunnions 504 extends through an opening 505 in the fan disk 142. The plurality of trunnions 504 is rotatable in the opening 505. This enables the plurality of fan blades 140 to rotate about the pitch axis P. As such, the pitch of the plurality of fan blades 140 can be changed relative to the flow of the volume of air 158. In particular, the plurality of fan blades 140 can be rotated (e.g., pitched) to any position between the first end position (e.g., the feather position) and the second end position (e.g., the reverse position). In FIG. 5, the plurality of fan blades 140 is shown in the feather position. In the feather position, the plurality of fan blades 140 is substantially aligned with the flow of the volume of air 158, which reduces resistance or drag. The plurality of fan blades 140 is typically held in the feather position when the turbofan engine 110 (FIG. 1) is not operating.

The fan actuation system 500 includes a plurality of trunnion links 506 and a unison ring 508. The plurality of trunnion links 506 is pivotably coupled to the plurality of trunnions 504. For example, each trunnion link 506 is coupled to a respective trunnion 504 and to the unison ring 508. In this way, the unison ring 508 couples the plurality of trunnions 504 together. The plurality of trunnion links 506 is coupled to the unison ring 508 via a plurality of pins 512. In this way, the plurality of trunnions 504 is pivotably coupled to the unison ring 508 such that the plurality of trunnions 504, and, thus, the plurality of fan blades 140, can pivot about the pitch axis P in unison, as detailed further below.

The fan actuation system 500 includes one or more actuators 514 that include a hydraulic cylinder 516, a piston 518, and a piston retainer 520. The piston retainer 520 is coupled (e.g., bolted) to the fan shaft 145 such that the piston retainer 520 rotates with the fan shaft 145. Therefore, the piston retainer 520 is coupled (e.g., indirectly) to, and rotated by, the LP shaft 136 (FIG. 1). Also, the piston 518 is coupled to, and extends in a forward direction, from the piston retainer 520. Therefore, the piston 518 also rotates with the piston retainer 520 and the fan shaft 145. The hydraulic cylinder 516 also rotate with the piston retainer 520 and the piston 518, but is axially slidable relative to the piston retainer 520 and the piston 518, as disclosed in further detail herein. In some examples, the hydraulic cylinder 516 is disposed within the fan hub 148 (FIG. 1) of the turbofan engine 110 (FIG. 1).

In the illustrated example of FIG. 5, the piston retainer 520 has a first portion 520a (e.g., a post), a second portion 520b (e.g., a flange) that extends radially outward from the first portion 520a, and a third portion 520c (e.g., a shaft) that extends axially from the second portion 520b. The third portion 520c is coupled (e.g., bolted) to the fan shaft 145. The piston retainer 520 can be constructed as multiple parts coupled (e.g., welded) together or as a single unitary part or component (e.g., a monolithic structure). The piston 518 is coupled to, and extends forward from, the first portion 520a of the piston retainer 520.

The hydraulic cylinder 516 is disposed radially outward of (e.g., around, surrounding) the piston retainer 520 and the piston 518. The hydraulic cylinder 516 is keyed to the piston retainer 520. As such, the piston retainer 520 rotates the hydraulic cylinder 516. However, the hydraulic cylinder 516 is slidable along the piston retainer 520 in the axial direction A (left and right in FIG. 5). This movement is used to change the pitch of the plurality of fan blades 140. The hydraulic cylinder 516 is coupled to the unison ring 508 at a joint 517 such that the hydraulic cylinder 516 is coupled to the plurality of fan blades 140 via the trunnion mechanism 502. The fan actuation system 500 can be activated to move the hydraulic cylinder 516 axially (left or right in FIG. 5), which causes the plurality of trunnion links 506 to rotate the plurality of trunnions 504, which rotates the plurality of fan blades 140 about the pitch axis P. As such, movement of the hydraulic cylinder 516 causes all of the fan blades 140 to rotate (e.g., pitch) simultaneously. When the hydraulic cylinder 516 is moved in a first axial direction (the forward direction, or to the left in FIG. 5), the plurality of fan blades 140 is rotated to the feather position, and when the hydraulic cylinder 516 is moved in a second axial direction (the rearward direction, or to the right in FIG. 5), the plurality of fan blades 140 is rotated away from the feather position and toward the reverse position. However, in other examples, the fan actuation system 500 can be configured so that the movement of the hydraulic cylinder 516 is reversed.

The hydraulic cylinder 516 has a first portion 516a, a second portion 516b, a third portion 516c, and a fourth portion 516d. The first portion 516a extends generally in the axial direction A and is coupled to the unison ring 508 at the joint 517 (e.g., a bolted joint). The second portion 516b is disposed radially inward of the first portion 516a and is coupled to the first portion 516a and to the unison ring 508 at the joint 517. The third portion 516c extends forward from the joint 517 (e.g., from the first portion 516a, the second portion 516b, and the unison ring 508) and forms a pressurized pneumatic chamber 570, disclosed in further detail herein. The fourth portion 516d is coupled to, and extends axially within, the third portion 516c. The first portion 516a, the second portion 516b, the third portion 516c, and the fourth portion 516d form the hydraulic cylinder 516. In some examples, the first portion 516a, the second portion 516b, the third portion 516c, and the fourth portion 516d are separate parts or components that are coupled (e.g., welded, bolted) together. In other examples, one or more of the first portion 516a, the second portion 516b, the third portion 516c, and the fourth portion 516d can be constructed as a single unitary part or component (e.g., a monolithic structure). In some aspects, the hydraulic cylinder 516 and the unison ring 508 form a single unitary part or component.

The first portion 516a of the hydraulic cylinder 516 is sealingly engaged with (e.g., engaged with a seal to prevent fluid leakage) the third portion 520c of the piston retainer 520. The second portion 520b of the piston retainer 520 is sealingly engaged with the first portion 516a of the hydraulic cylinder 516. The second portion 516b of the hydraulic cylinder 516 is sealingly engaged with the first portion 520a of the piston retainer 520. The piston 518 is sealingly engaged with the second portion 516b and with the fourth portion 516d of the hydraulic cylinder 516.

The fan actuation system 500 includes one or more hydraulic chambers defined between the hydraulic cylinder 516, the piston 518, and the piston retainer 520. These hydraulic chamber(s) are used to control the position of the hydraulic cylinder 516, and, thus, to control the pitch of the plurality of fan blades 140. As shown in FIG. 5, the fan actuation system 500 includes a first hydraulic chamber 540, a second hydraulic chamber 542, and a third hydraulic chamber 544. The first hydraulic chamber 540 is formed or is defined between the first portion 516a of the hydraulic cylinder 516, the second portion 520b of the piston retainer 520, and the third portion 520c of the piston retainer 520. The second hydraulic chamber 542 is formed or is defined between the first portion 516a of the hydraulic cylinder 516, the second portion 516b of the hydraulic cylinder 516, the first portion 520a of the piston retainer 520, and the second portion 520b of the piston retainer 520. The third hydraulic chamber 544 is formed or is defined between second portion 516b of the hydraulic cylinder 516, an aft end of the piston 518, and the first portion 520a of the piston retainer 520. In this example, the first hydraulic chamber 540 and third hydraulic chamber 544 are provided with hydraulic fluid at a first pressure, referred to herein as P1, and the second hydraulic chamber 542 is provided with hydraulic fluid at a second pressure, referred to herein as P2. The first pressure P1 and the second pressure P2 can be any amount depending on the specific design. In some examples, the first pressure P1 and the second pressure P2 can be as high as one thousand pounds per square inch (1000 psi) or even higher. The first pressure P1 and the second pressure P2 can be increased or can be decreased to cause the hydraulic cylinder 516 to move axially forward or axially rearward, thus changing the pitch of the plurality of fan blades 140. For example, if the force acting on the hydraulic cylinder 516 from the first pressure P1 in the first hydraulic chamber 540 and the third hydraulic chamber 544 is greater than the force acting on the hydraulic cylinder 516 from the second pressure P2 in the second hydraulic chamber 542, the hydraulic cylinder 516 moves (e.g., slides) rearward (axially aftward, or to the right in FIG. 5) along the piston 518 and the piston retainer 520. Conversely, if the force acting on the hydraulic cylinder 516 from the first pressure P1 in the first hydraulic chamber 540 and the third hydraulic chamber 544 is less than the force acting on the hydraulic cylinder 516 from the second pressure P2 in the second hydraulic chamber 542, the hydraulic cylinder 516 moves (e.g., slides) axially forward (to the left in FIG. 5) along the piston 518 and the piston retainer 520. Therefore, the first hydraulic chamber 540 and the third hydraulic chamber 544 receive hydraulic fluid to move the hydraulic cylinder 516 in the rearward direction (e.g., aftward direction) while the second hydraulic chamber 542 receives hydraulic fluid to move the hydraulic cylinder 516 in the forward direction.

The fan actuation system 500 includes a hydraulic system 550 to provide hydraulic fluid, such as oil, to one or more of the hydraulic chambers 540, 542, 544 to control the movement of the hydraulic cylinder 516. The hydraulic system 550 includes a pump 552 to control the first pressure P1 and the second pressure P2. The pump 552 is activated to move the hydraulic fluid into, or out of, the hydraulic chambers 540, 542, 544 to increase or to decrease the first pressure P1 and the second pressure P2, and, therefore, to cause the hydraulic cylinder 516 to move forward or to move rearward. In the illustrated example, the hydraulic system 550 includes an oil transfer bearing 554. The oil transfer bearing 554 includes a fixed portion 556 (e.g., a shaft) with fluid passageways fluidly coupled to the pump 552. The fixed portion 556 is a static component and does not rotate or move axially. The oil transfer bearing 554 includes a sleeve 558 that is rotatable about the fixed portion 556. The hydraulic system 550 includes a first fluid line 560, a second fluid line 562, and a third fluid line 564 fluidly coupled between the oil transfer bearing 554 and the respective hydraulic chambers 540, 542, and 544. The first fluid line 560 is in fluid communication with the first hydraulic chamber 540, the second fluid line 562 is in fluid communication with the second hydraulic chamber 542, and the third fluid line 564 is in fluid communication with the third hydraulic chamber 544. The first fluid line 560, the second fluid line 562, and the third fluid line 564 are coupled to the sleeve 558. The sleeve 558 enables fluid communication among the first fluid line 560, the second fluid line 562, and the third fluid line 564, which are rotating with the fan actuation system 500, and the fixed portion 556 of the oil transfer bearing 554. Thus, the oil transfer bearing 554 enables the hydraulic fluid to be transferred between a stationary component and a rotating component. As disclosed above, the first hydraulic chamber 540 and the third hydraulic chamber 544 are provided with the hydraulic fluid at the same first pressure P1. The oil transfer bearing 554 fluidly couples the hydraulic fluid in the first fluid line 560 and the third fluid lines 564 such that the first hydraulic chamber 540 and the third hydraulic chamber 544 remain at the same first pressure P1.

To move the plurality of fan blades 140 away from the feather position and toward the reverse position, the pump 552 is activated to increase the first pressure P1 in the first hydraulic chamber 540 and the third hydraulic chamber 544 and to reduce the second pressure P2 in the second hydraulic chamber 542. As a result, the hydraulic cylinder 516 moves in the rearward direction (to the right in FIG. 5). The hydraulic cylinder 516 pushes the plurality of trunnion links 506 rearward (to the right in FIG. 5), which causes the plurality of fan blades 140 to rotate away from the feather position and toward the reverse position. In this way, the plurality of fan blades 140 can be moved between the feather position and the reverse position. When the desired position is reached, the pump 552 is deactivated or can otherwise balance the loads on the hydraulic cylinder 516 to maintain the current position. The pump 552 can further increase the first pressure P1 or decrease the second pressure P2 to further move the plurality of fan blades 140 toward the reverse position. Otherwise, to move the plurality of fan blades 140 back to the feather position, the pump 552 is activated to reduce the first pressure P1 in the first hydraulic chamber 540 and the third hydraulic chamber 544 or to increase the second pressure P2 in the second hydraulic chamber 542. Thus, the hydraulic system 550 is used to control the position of the hydraulic cylinder 516 for controlling the pitch of the plurality of fan blades 140 along the pitch axis P. The first pressure P1 being the same in the first hydraulic chamber 540 and the third hydraulic chambers 544 reduces the overall first pressure P1 required to control the hydraulic cylinder 516. In other examples, however, the first hydraulic chamber 540 and the third hydraulic chamber 544 can be pressurized at different pressures.

The pressurized pneumatic chamber 570 is formed or is defined by the third portion 516c of the hydraulic cylinder 516 and the piston 518. The pressurized pneumatic chamber 570 is filled with a pressurized gas. In some examples, the pressurized pneumatic chamber 570 contains pressurized nitrogen. In other examples, the pressurized pneumatic chamber 570 can be filled with another pressurized gas (e.g., air). The pressurized pneumatic chamber 570 is sealed. A such, the volume of the pressurized gas (e.g., nitrogen) in the pressurized pneumatic chamber 570 does not change. During manufacture or assembly of the fan actuation system 500, the pressurized pneumatic chamber 570 can be charged with gas (e.g., nitrogen) and then sealed. The pressurized pneumatic chamber 570 can be pressurized to any amount depending on the size of the pressurized pneumatic chamber 570 and on the size of the hydraulic chambers 540, 542, 544 and the desired biasing force. In some examples, the pressure in the pressurized pneumatic chamber 570 is in a range from seven hundred twenty pounds per square inch to nine hundred twenty pounds per square inch (720 psi to 920 psi). In other examples, however, the pressure may be less than, or greater than, these exemplary values.

The pressurized gas in the pressurized pneumatic chamber 570 generates a constant force or a constant load that biases the hydraulic cylinder 516 in the forward direction (to the left in FIG. 5), which corresponds to the feather position of the plurality of fan blades 140. This provides a failsafe to move the plurality of fan blades 140 to the feather position in an event of failure of the hydraulic system 550 or a shutdown of the turbofan engine 110. For example, if the hydraulic system 550 or the turbofan engine 110 fails or is shut down, the hydraulic system 550 is not able to provide pressurized hydraulic fluid to the hydraulic chambers 540, 542, and 544 to control or to maintain the position of the hydraulic cylinder 516. In such an instance, the force on the hydraulic cylinder 516 from the pressurized gas in the pressurized pneumatic chamber 570 overcomes the force on the hydraulic cylinder 516 from the first hydraulic chamber 540 and the third hydraulic chamber 544. As such, the hydraulic cylinder 516 moves in the forward direction (to the left in FIG. 5), which moves the plurality of fan blades 140 to the feather position shown in FIG. 5. As such, the pressurized pneumatic chamber 570 provides a passive system that moves the plurality of fan blades 140 to the feather position in the event of a failure or a deactivation of the hydraulic system 550, which may occur if the turbofan engine 110 fails or is shut down. Therefore, if one of the turbofan engines of an aircraft fails or is deactivated during flight, the fan actuation system 500 automatically moves the plurality of fan blades 140 to the feather position (FIG. 5). This is advantageous because, in the feather position, the plurality of fan blades 140 produces less resistance, which reduces drag on the turbofan engine 110 and on the aircraft. This also reduces or prevents the plurality of fan blades 140 from spinning (due to incoming airflow) the internal turbo-machinery parts of the turbofan engine 110.

The example pressurized pneumatic chamber 570 is advantageous because it has a high load capability due to the compressibility of the pneumatic gas (e.g., nitrogen). Further, the pressurized pneumatic chamber 570 enables a longer travel of the hydraulic cylinder 516 with relatively little change in load. Therefore, the pressurized pneumatic chamber 570 provides a relatively constant load throughout the stroke. Also, the volume and areas of the pressurized pneumatic chamber 570 and the piston 518 can be varied to optimize the load versus travel of the hydraulic cylinder 516.

Therefore, during normal operation of the fan actuation system 500, the first hydraulic chamber 540 and the third hydraulic chamber 544 act to bias the hydraulic cylinder 516 in the rearward direction, while the second hydraulic chamber 542 and the pressurized pneumatic chamber 570 act to bias the hydraulic cylinder 516 in the forward direction. The pressures in the hydraulic chambers 540, 542, and 544 and in the pressurized pneumatic chamber 570 can be controlled to substantially balance the forces and to maintain the hydraulic cylinder 516 in a desired position. In the illustrated example of FIG. 5, a chamber 572 is formed or is defined between the hydraulic cylinder 516 and the piston 518. The chamber 572 is vented to the atmosphere. As such, the chamber 572 does not provide a force in either direction. In this example, the pressurized pneumatic chamber 570 is forward of the piston retainer 520 and the piston 518. In some examples, this is beneficial because there is additional space forward of these components. In other examples, however, the pressurized pneumatic chamber 570 can be disposed rearward of the piston 518 and the piston retainer 520.

In the example of FIG. 5, the fan actuation system 500 is devoid of a pitch lock device and counterweights for reducing inertial loading associated with rotation of fan blades. In particular, in known fan actuation systems, a separate pitch lock device is required to hold the plurality of fan blades 140 once the plurality of fan blades 140 is in the feather position. Further, in known fan actuation systems, a counterweight is used to provide additional force to help pitch the fan blades. However, with the fan actuation system 500, the pressurized pneumatic chamber 570 provides a constant biasing force to hold the plurality of fan blades 140 in the feather position, which eliminates the need for a separate pitch lock device. Further, the hydraulic system 550 provides the first pressure P1 in both the first hydraulic chamber 540 and the third hydraulic chamber 544 to provide a higher pressure to pitch the fan blades 140, which eliminates the need for a counterweight. This reduces parts, complexity, weight, and costs of the fan actuation system 500.

Examples have been disclosed herein that improve the ability for the fan actuation system 500 to move the fan blades 140 to the feather position in the event of failure of the fan actuation system 500 or a shutdown of the turbofan engine 110. The example systems disclosed herein are passive and, thus, do not require complicated activation components or control systems. The example pressurized pneumatic chamber 570 is capable of handling high rotational speeds and a large variation in operating temperatures, such as encountered during use on aircraft. The examples disclosed herein also eliminate the need for a pitch lock device. As such, the example systems can result in fewer parts, less complexity, reduced weight, and lower costs compared to known systems. The fan actuation system 500 is particularly useful in turbofan engines (e.g., the turbofan engine 110 of FIG. 1 or the turbofan engine 210 of FIG. 2) in which the space for the fan actuation system 500 is smaller as compared to turboprop engines. Components of the fan actuation system 500 can be used in combination with any of the fan actuation systems disclosed herein.

The turbofan engine 110 also includes one or more thrust bearings, also referred to as one or more radial thrust (radial blade load) bearings 580, disposed between the trunnion 504 and the fan disk 142 such that the trunnion 504 rotates about the pitch axis P with respect to the fan disk 142. The one or more radial thrust bearings 580 transmit the load (the radial blade load) from the respective fan blade 140 to a static structure of the turbofan engine 110. In particular, the radial thrust bearings 580 include a plurality of rolling elements 582. The rolling elements 582 can include, for example, ball bearings, tapered roller bearings, or the like, for transmitting the radial blade load from the fan blade 140 to the static structure.

The one or more radial thrust bearings 580 are disposed radially at a thrust bearing radius R_{TB}. The thrust bearing radius R_{TB} is defined in the radial direction R from the longitudinal centerline axis 112 to a radial center 583 of the one or more radial thrust bearings 580. The radial center 583 is a center of the radial thrust bearings 580 in the radial direction R. Particularly, the radial center 583 is defined as a radial center of the rolling elements 582. The amount of space, or the volume, beneath the fan 138 that is available for the fan actuation system 500 is defined by the thrust bearing radius R_{TB}. The fan actuation system 500 needs to be accommodated radially below the one or more radial thrust bearings 580 and within the thrust bearing radius R_{TB}.

The turbofan engine 110 includes a fan hub axial length A_{FH}, a fan actuation system axial length A_{FAS}, and a fan bearing axial length A_{FB}. The fan hub axial length A_{FH} is an axial length, in the axial direction (e.g., parallel with the longitudinal centerline axis 112) from the fan hub tip 157 to the pitch axis P of the fan blades 140. The fan actuation system axial length A_{FAS} is an axial length, in the axial direction (e.g., parallel with the longitudinal centerline axis 112), from an axially forward-most surface 515 of the fan actuation system 500 to the pitch axis P of the fan blades 140. In FIG. 5, the axially forward-most surface 515 is defined by an axially forward-most surface of the actuators 514 (e.g., of the hydraulic cylinder 516). The fan actuation system axial length A_{FAS} is a maximum of 80% of the fan hub axial length A_{FH}. In this way, the fan actuation system 500 fits within the fan hub 148 such that the actuators 514 can move axially without contacting the fan hub 148. The fan bearing axial length A_{FB} is an axial length, in the axial direction (e.g., parallel with the longitudinal centerline axis 112) from the pitch axis P of the fan blades 140 to an axial center of the fan bearings 155.

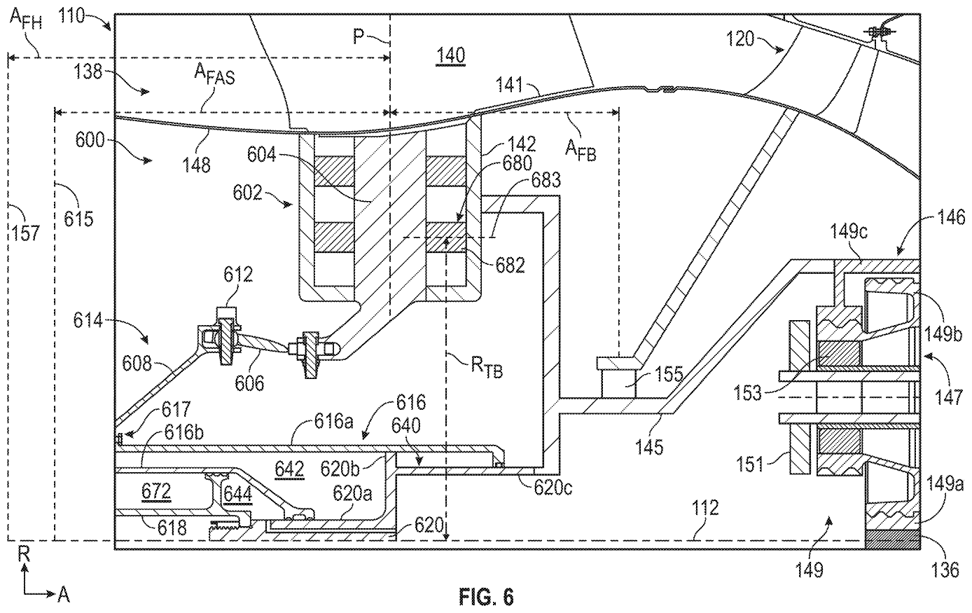

FIG. 6 is a schematic cross-sectional view of a fan actuation system 600 for the turbofan engine 110, taken along the longitudinal centerline axis 112 of the turbofan engine 110, according to the present disclosure. While the fan actuation system 600 is described as being utilized in the turbofan engine 110, the fan actuation system 600 can be utilized in the turbofan engine 210 of FIG. 2. The fan actuation system 600 is substantially similar to the fan actuation system 500 of FIG. 5. The same reference numerals will be used for components of the fan actuation system 600 that are the same as or similar to the components of the fan actuation system 500 discussed above. The description of these components above also applies to this aspect, and a detailed description of these components is omitted here.

The fan actuation system 600 includes a trunnion mechanism 602, a plurality of trunnions 604, a plurality of trunnion links 606, a unison ring 608, a plurality of pins 612, one or more actuators 614, a hydraulic cylinder 616, a joint 617, a piston 618, and a piston retainer 620. The hydraulic cylinder 616 has a first portion 616a and a second portion 616b. Although not shown in the view of FIG. 6, the hydraulic cylinder 616 also includes a third portion and a fourth portion similar to the third portion 516c and the fourth portion 516d of the hydraulic cylinder 516 of FIG. 5. The piston retainer 620 has a first portion 620a, a second portion 620b, and a third portion 620c. The fan actuation system 600 also includes a first hydraulic chamber 640, a second hydraulic chamber 642, a third hydraulic chamber 644, and a pressurized pneumatic chamber (not shown in the view of FIG. 6), and a chamber 672. The first hydraulic chamber 640 and the third hydraulic chamber 644 receive the hydraulic fluid at a first pressure P1, and the second hydraulic chamber 642 receives the hydraulic fluid at a second pressure P2, as detailed above with respect to FIG. 5. The fan actuation system 600 operates substantially similar as to the fan actuation system 500 of FIG. 5.

FIG. 6 shows one fan blade 140 of the fan 138, the core inlet 120, and the gearbox assembly 146. The gearbox assembly 146 includes a gear assembly 147 having a plurality of gears 149 including a first gear 149a, one or more second gears 149b secured by a planet carrier 151, and a third gear 149c. In FIG. 6, the first gear 149a is a sun gear, the one or more second gears 149b are planet gears, and the third gear 149c is a ring gear. The gear assembly 147 is an epicyclic gear assembly. When the gear assembly 147 is an epicyclic gear assembly, the one or more second gears 149b include a plurality of second gears 149b (e.g., two or more second gears 149b).

In the epicyclic gear assembly, the gear assembly 147 can be in a star arrangement or a rotating ring gear type gear assembly (e.g., the third gear 149c is rotating and the planet carrier 151 is fixed and stationary). In such an arrangement, the fan 138 is driven by the third gear 149c. For example, the third gear 149c is coupled to the fan shaft 145 such that rotation of the third gear 149c causes the fan shaft 145, and, thus, the fan 138, to rotate. In this way, the third gear 149c is an output of the gear assembly 147. However, other suitable types of gear assemblies may be employed. In one non-limiting aspect, the gear assembly 147 is a planetary arrangement, in which the third gear 149c is held fixed, with the planet carrier 151 allowed to rotate. In such an arrangement, the fan 138 is driven by the planet carrier 151. For example, the planet carrier 151 is coupled to the fan shaft 145 such that rotation of the planet carrier 151 causes the fan shaft 145, and, thus, the fan 138, to rotate. In this way, the one or more second gears 149b (e.g., via the planet carrier 151) are the output of the gear assembly 147. In another non-limiting aspect, the gear assembly 147 may be a differential gear assembly in which the third gear 149c and the planet carrier 151 are both allowed to rotate. While an epicyclic gear assembly is detailed herein, the gear assembly can include any type of gear assembly including, for example, a single stage gear assembly or a compound gear assembly (e.g., a gear assembly having a plurality of stages).

The plurality of gears 149 includes one or more gear bearings 153 disposed therein. For example, the one or more second gears 149b each includes one or more gear bearings 153 disposed therein. The one or more gear bearings 153 enable the plurality of gears 149 to rotate about the one or more gear bearings 153 such that the plurality of gears 149 rotates. The one or more gear bearings 153 can include any type of bearing for a gear, such as, for example, journal bearings, roller bearings, or the like. The gearbox assembly 146 can include a plurality of gear bearings that includes a forward gear bearing and an aft gear bearing. The one or more gear bearings 153 shown in the view of FIG. 6 are the forward gear bearing.

The first gear 149a is coupled to an input shaft of the turbofan engine 110. For example, the first gear 149a is coupled to the LP shaft 136 such that rotation of the LP shaft 136 causes the first gear 149a to rotate. Radially outward of the first gear 149a, and intermeshing therewith, is the one or more second gears 149b that are coupled together and supported by the planet carrier 151. The planet carrier 151 supports and constrains the one or more second gears 149b such that the each of the one or more second gears 149b is enabled to rotate about a corresponding axis of each second gear 149b without rotating about the periphery of the first gear 149a. Radially outwardly of the one or more second gears 149b, and intermeshing therewith, is the third gear 149c, which is an annular ring gear. The third gear 149c is coupled via an output shaft to the fan 138 and rotates to drive rotation of the fan 138 about the longitudinal centerline axis 112. For example, the fan shaft 145 is coupled to the third gear 149c.

The fan shaft 145 is coupled to the fan disk 142 such that rotation of the fan shaft 145 causes the plurality of fan blades 140 to rotate about the longitudinal centerline axis 112. The turbofan engine 110 also includes one or more radial thrust bearings 680, disposed between the trunnion 604 and the fan disk 142 such that the trunnion 604 rotates about the pitch axis P with respect to the fan disk 142. In particular, the radial thrust bearings 680 include a plurality of rolling elements 682.

The one or more radial thrust bearings 680 are disposed radially at the thrust bearing radius R_{TB} defined in the radial direction R from the longitudinal centerline axis 112 to a radial center 683 of the one or more radial thrust bearings 680, as discussed above. The fan actuation system axial length A_{FAS} is an axial length, in the axial direction (e.g., parallel with the longitudinal centerline axis 112), from an axially forward-most surface 615 (shown schematically in FIG. 6) of the fan actuation system 600 to the pitch axis P of the fan blades 140.

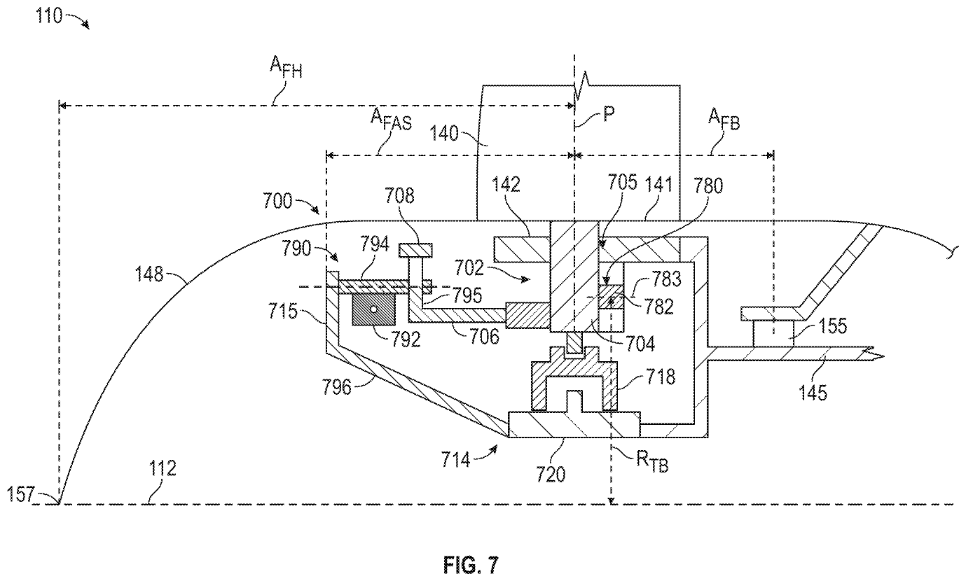

FIG. 7 is a schematic cross-sectional view of a fan actuation system 700 for the turbofan engine 110, taken along the longitudinal centerline axis 112 of the turbofan engine 110, according to the present disclosure. While the fan actuation system 700 is described as being utilized in the turbofan engine 110, the fan actuation system 700 can be utilized in the turbofan engine 210 of FIG. 2. The fan actuation system 700 is substantially similar to the fan actuation system 500 of FIG. 5. The same or similar reference numerals will be used for components of the fan actuation system 700 that are the same as or similar to the components of the fan actuation system 500 discussed above. The description of these components above also applies to this aspect, and a detailed description of these components is omitted here.

The fan actuation system 700 includes a trunnion mechanism 702, a plurality of trunnions 704, an opening 705, one or more trunnion links 706, a unison ring 708, one or more actuators 714, an axially forward-most surface 715, a piston 718, a piston retainer 720, and one or more radial thrust bearings 780. The piston retainer 720 is stationary (e.g., coupled to a static structure of the turbofan engine 110) and the piston 718 moves with respect to the piston retainer 720 to change a pitch of the fan blades 140. For example, the piston 718 can be coupled to a hydraulic cylinder that receives hydraulic fluid for moving the piston 718, as detailed above. The one or more trunnion links 706 include one or more ring gears that mesh with a corresponding gear of the trunnions 704.

The fan actuation system 700 also includes a counterweight assembly 790 including one or more counterweights 792. The counterweights 792 are axially spaced from the trunnions 704 to counter a centrifugal twisting moment of the fan blades 140. The counterweights 792 can be any high-density mass that can rotate about a counterweight centerline. The counterweights 792 can have offset masses that are movable relative to the counterweight centerline. In particular, the counterweights 792 are coupled to one or more counterweight shafts 794 that are drivingly coupled to the trunnion links 706 via one or more counterweight gears 795. The counterweight shafts 794 are supported by one or more counterweight support members 796 that are coupled to the piston retainer 720. In FIG. 7, the axially forward-most surface 715 is defined by an axially forward-most surface of the counterweight support member 796. In this way, the axially forward-most surface 715 is defined by the counterweight assembly 790.

As the trunnions 704 rotate, the trunnions 704 cause the trunnion links 706 to rotate with respect to the unison ring 708, and in turn, the trunnion links 706 cause the counterweight shafts 794 to rotate. As the trunnion links 706 and the counterweight shafts 794 rotate, the counterweights 792 rotate via the counterweight shafts 794. In this way, the counterweights 792 change position relative to the counterweight centerline. Thus, the counterweight assembly 790 counters a centrifugal twisting moment of the fan blades 140 to help rotate the fan blades 140 when the pitch of the fan blades 140 changes.

A mass of the counterweights 792 can be changed based on a length of the counterweight shafts 794. In particular, the counterweights 792 can have less mass with longer counterweight shafts 794 and can have more mass with shorter counterweight shafts 794. In this way, the axially further the counterweights 792 are disposed from the pitch axis P of the fan blades 140, the lesser mass the counterweights 792 can have, while still countering the centrifugal twisting moment of the fan blades 140 and helping to rotate the fan blades 140 when the pitch of the fan blades 140 changes. Accordingly, the mass of the counterweights 792 needed to pitch the fan blades 140 and counter the twisting moment is a function of the axial position of the counterweights 792 with respect to the pitch axis P.

The one or more radial thrust bearings 780 are disposed radially at the thrust bearing radius R_{TB} defined in the radial direction R from the longitudinal centerline axis 112 to a radial center 783 of a plurality of rolling elements 782 of the radial thrust bearings 780, as discussed above. The fan actuation system axial length A_{FAS} is an axial length, in the axial direction (e.g., parallel with the longitudinal centerline axis 112), from an axially forward-most surface 715 of the fan actuation system 700 to the pitch axis P of the fan blades 140.

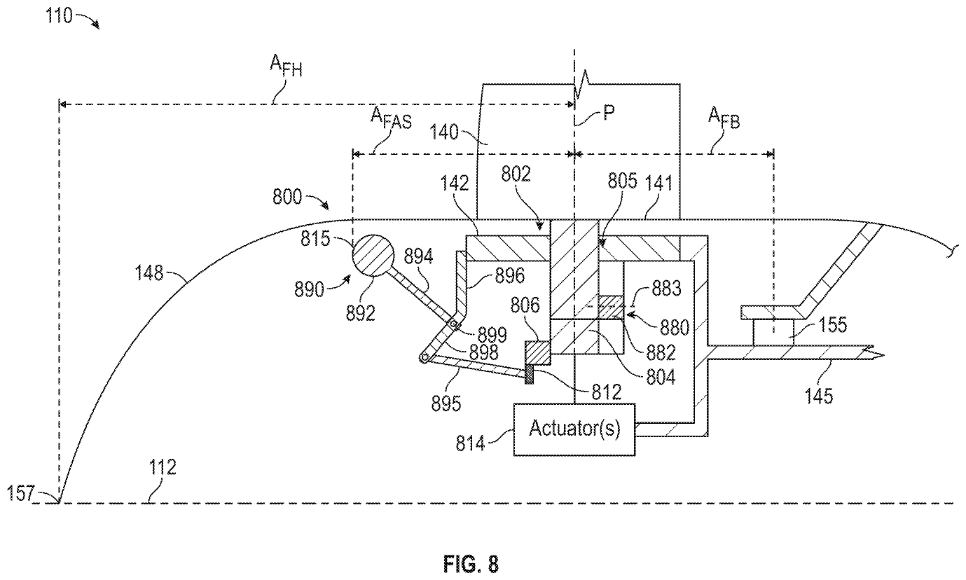

FIG. 8 is a schematic cross-sectional view of a fan actuation system 800 for the turbofan engine 110, taken along the longitudinal centerline axis 112 of the turbofan engine 110, according to the present disclosure. While the fan actuation system 800 is described as being utilized in the turbofan engine 110, the fan actuation system 800 can be utilized in the turbofan engine 210 of FIG. 2. The fan actuation system 800 is substantially similar to the fan actuation system 700 of FIG. 7. The same or similar reference numerals will be used for components of the fan actuation system 800 that are the same as or similar to the components of the fan actuation system 700 discussed above. The description of these components above also applies to this aspect, and a detailed description of these components is omitted here.

The fan actuation system 800 includes a trunnion mechanism 802, a plurality of trunnions 804, an opening 805, one or more trunnion links 806, a plurality of pins 812, one or more actuators 814 (shown schematically in FIG. 8), an axially forward-most surface 815, and one or more radial thrust bearings 880. The actuators 814 can include any of the actuators disclosed herein for changing a pitch of the fan blades 140. The one or more trunnion links 806 include arms that extend from the trunnions 804. The pins 812 extend through the arms and are coupled to a counterweight assembly 890.

The counterweight assembly 890 includes one or more counterweights 892, one or more counterweight shafts 894, and one or more counterweight support members 896. The one or more counterweight support members 896 are coupled to the fan disk 142 such that the counterweight assembly 890 rotates about the longitudinal centerline axis 112 with rotation of the fan 138. The counterweight assembly 890 also includes one or more link arms 895 and one or more lever arms 898. The one or more lever arms 898 are pivotably coupled to the counterweight support members 896 via a pivot 899. The link arms 895 are coupled to the trunnion links 806 via the pins 812 and are pivotably coupled to the lever arms 898. The counterweight shafts 894 are pivotably coupled to the lever arms 898 at the pivot 899.

In FIG. 8, the axially forward-most surface 815 is defined by an axially forward-most surface of the counterweights 892 at a maximum axial extent of the counterweights 892, as detailed further below. In this way, the axially forward-most surface 815 is defined by the counterweight assembly 890.

As the trunnions 804 rotate, the trunnions 804 cause the trunnion links 806 to rotate, and in turn, the trunnion links 806 cause the pins 812 to rotate, and, thus, cause the link arms 895 to pivot. As the link arms 895 pivot, the link arms 895 cause the lever arms 898 to pivot, and, thus, cause the counterweight shafts 894 to pivot about the pivot 899. In this way, the counterweight shafts 894 cause the counterweights 892 to travel along a partially circular arc radially outward away from the longitudinal centerline axis 112 or radially inward towards the longitudinal centerline axis 112. Thus, the counterweight assembly 890 counters a centrifugal twisting moment of the fan blades 140 to help rotate the fan blades 140 when the pitch of the fan blades 140 changes.

The one or more radial thrust bearings 880 are disposed radially at the thrust bearing radius R_{TB} defined in the radial direction R from the longitudinal centerline axis 112 to a radial center 883 of a plurality of rolling elements 882 of the radial thrust bearings 880, as discussed above. The fan actuation system axial length A_{FAS} is an axial length, in the axial direction (e.g., parallel with the longitudinal centerline axis 112), from an axially forward-most surface 815 of the fan actuation system 800 to the pitch axis P of the fan blades 140.

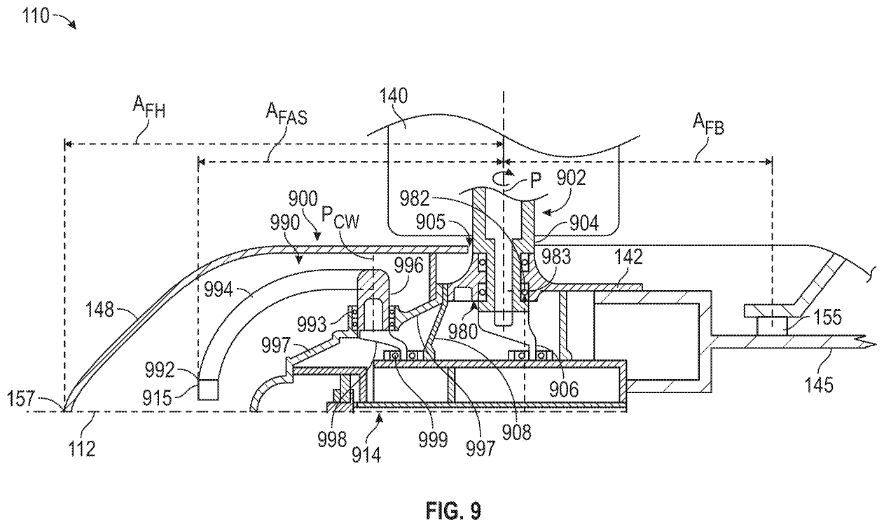

FIG. 9 is a schematic cross-sectional view of a fan actuation system 900 for the turbofan engine 110, taken along the longitudinal centerline axis 112 of the turbofan engine 110, according to the present disclosure. While the fan actuation system 900 is described as being utilized in the turbofan engine 110, the fan actuation system 900 can be utilized in the turbofan engine 210 of FIG. 2. The fan actuation system 900 is substantially similar to the fan actuation system 700 of FIG. 7. The same or similar reference numerals will be used for components of the fan actuation system 900 that are the same as or similar to the components of the fan actuation system 700 discussed above. The description of these components above also applies to this aspect, and a detailed description of these components is omitted here.

The fan actuation system 900 includes a trunnion mechanism 902, a plurality of trunnions 904, an opening 905, one or more trunnion links 906, a unison ring 908, one or more actuators 914, an axially forward-most surface 915, and one or more radial thrust bearings 980. The actuators 914 can include any of the actuators disclosed herein for changing a pitch of the fan blades 140. The one or more trunnion links 906 and the unison ring 908 couple the trunnions 904 to the actuators 914 such that movement of the actuators 914 causes the trunnions 904 to rotate, thus, causing the fan blades 140 to rotate about the pitch axis P.

The counterweight assembly 990 includes one or more counterweights 992, one or more counterweight shafts 994, one or more counterweight support members 996, and one or more lever arms 998. In FIG. 9, the counterweight shafts 994 are counterweight levers and the counterweight support members 996 are counterweight trunnions.

The counterweight assembly 990 includes a counterweight hub 997 that may be connected to the fan disk 142, such that rotation of the fan disk 142 about the longitudinal centerline axis 112 drives rotation of the counterweight hub 997 about the longitudinal centerline axis 112. The counterweight shafts 994 are rotationally connected to the counterweight hub 997. For example, each of the counterweight shafts 994 may be mounted to the counterweight hub 997 via one or more counterweight bearings 993 that provide the ability for the counterweight shafts 994 to rotate about a counterweight lever rotational axis P_{CW}. The counterweight bearings 993 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing Each of the counterweight support members 996 are rotational about a counterweight lever rotational axis P_{CW} that extends through a respective counterweight support member 996 and extends radially (i.e., in the radial direction R) from the longitudinal centerline axis 112.

Each counterweight shaft 994 is a cantilever arm having a first end connected to a respective counterweight support member 996 and a second end offset from the respective counterweight lever rotational axis P_{CW}. A respective counterweight 992 is connected to the second end of the counterweight shaft 994. Each counterweight 992 has a counterweight center-of-gravity that is utilized in locating the counterweight 992 within the counterweight assembly 990.

The one or more counterweight support members 996 are coupled to the fan disk 142 such that the counterweight assembly 990 rotates about the longitudinal centerline axis 112 with rotation of the fan 138. The counterweight assembly 990 also includes one or more lever arms 998 that are rotationally connected to the actuators 914 via one or more lever bearings 999. The lever arms 998 are connected to the counterweight support members 996 such that axial translation of the actuators 914 along the longitudinal centerline axis 112 drives the lever arms 998 and the counterweight support members 996 about the respective counterweight lever rotational axis P_{CW} so as to rotate the counterweight shafts 994. In FIG. 9, the counterweight shafts 994 are at a ninety-degree rotated position.

In FIG. 9, the axially forward-most surface 915 is defined by an axially forward-most surface of the counterweights 992 at a maximum axial extent of the counterweights 992 (e.g., at the ninety-degree rotated position). In this way, the axially forward-most surface 915 is defined by the counterweight assembly 990.

As the actuators 914 move axially, the actuators 914 cause the trunnions 904 and the counterweight support members 996 to rotate. In turn, the counterweight support members 996 cause the counterweight shafts 994 to rotate about the counterweight lever rotational axis P_{CW}, and, thus, cause the counterweights 992 to rotate. In particular, the counterweight shafts 994, and the counterweights 992, rotate in to or out of the page between the ninety-degree rotated position that defines a maximum axial extent of the counterweights 992 and a zero-degree rotated position that defines a minimum axial extend of the counterweights 992. Thus, the counterweight assembly 990 counters a centrifugal twisting moment of the fan blades 140 to help rotate the fan blades 140 when the pitch of the fan blades 140 changes.

The one or more radial thrust bearings 980 are disposed radially at the thrust bearing radius R_{TB} defined in the radial direction R from the longitudinal centerline axis 112 to a radial center 983 of a plurality of rolling elements 982 of the radial thrust bearings 980, as discussed above. The fan actuation system axial length A_{FAS} is an axial length, in the axial direction (e.g., parallel with the longitudinal centerline axis 112), from an axially forward-most surface 915 of the fan actuation system 900 to the pitch axis P of the fan blades 140.

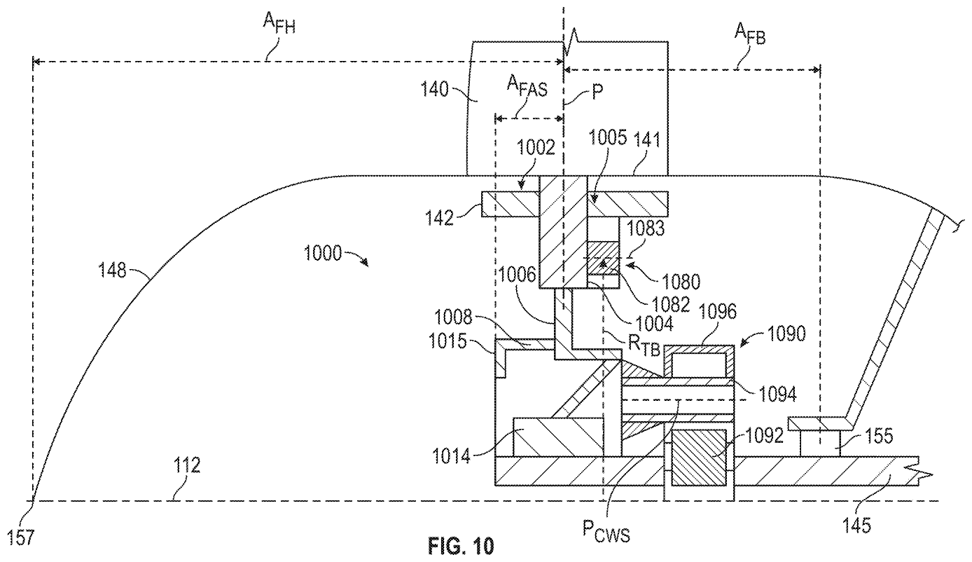

FIG. 10 is a schematic cross-sectional view of a fan actuation system 1000 for the turbofan engine 110, taken along the longitudinal centerline axis 112 of the turbofan engine 110, according to the present disclosure. While the fan actuation system 1000 is described as being utilized in the turbofan engine 110, the fan actuation system 1000 can be utilized in the turbofan engine 210 of FIG. 2. The fan actuation system 1000 is substantially similar to the fan actuation system 500 of FIG. 5. The same or similar reference numerals will be used for components of the fan actuation system 1000 that are the same as or similar to the components of the fan actuation system 500 discussed above. The description of these components above also applies to this aspect, and a detailed description of these components is omitted here.

The fan actuation system 1000 includes a trunnion mechanism 1002, a plurality of trunnions 1004, an opening 1005, one or more trunnion links 1006, a unison ring 1008, one or more actuators 1014, an axially forward-most surface 1015, one or more radial thrust bearings 1080, and a counterweight assembly 1090. The actuators 1014 can include any of the actuators disclosed herein for changing a pitch of the fan blades 140. The one or more trunnion links 1006 and the unison ring 1008 couple the trunnions 1004 to the actuators 1014 such that movement of the actuators 1014 causes the trunnions 1004 to rotate, thus, causing the fan blades 140 to rotate about the pitch axis P. In FIG. 10, the axially forward-most surface 1015 is defined by an axially forward-most surface of the unison ring 1008.

The counterweight assembly 1090 includes one or more counterweights 1092, one or more counterweight shafts 1094, and one or more counterweight support members 1096. The one or more counterweight support members 1096 are coupled to the fan disk 142 via the unison ring 1008 such that the counterweight assembly 1090 rotates about the longitudinal centerline axis 112 with rotation of the fan 138. The counterweights 1092 are positioned axially aft of the fan blades 140, particularly, axially aft of the pitch axis P. For example, the counterweights 1092 are positioned axially between the pitch axis P and the fan bearings 155.

The counterweight support members 1096 act as a carrier for the counterweight shafts 1094. The counterweight shafts 1094 are aligned generally parallel to the longitudinal centerline axis 112 and pass through the counterweight support members 1096. The counterweight shafts 1094 are rotatably connected (e.g., via one or more gears) at a first end to the unison ring 1008. The counterweights 1092 are connected to a second end of the counterweight shafts 1094. The counterweight shafts 1094, and the counterweights 1092, are rotatable relative to the counterweight support members 1096, about a respective counterweight shaft axis PCWs.

All of the counterweight shafts 1094 are meshed via one or more gears with the unison ring 1008. Thus connected, the movement of the fan blades 140, unison ring 1008, and the counterweights 1092 are linked together such that rotary motion of the unison ring 1008, for example, caused by the actuators 1014, will cause a simultaneous change in the pitch angle of all of the fan blades 140, and of the angular orientation of the counterweights 1092. The unison ring 1008 transmits forces between the fan blades 140 and the counterweights 1092. In this way, the counterweight shafts 1094 cause the counterweights 1092 to travel along a partially circular arc radially outward away from the longitudinal centerline axis 112 or radially inward towards the longitudinal centerline axis 112, and axially closer to, or axially further from, the pitch axis P. Thus, the counterweight assembly 1090 counters a centrifugal twisting moment of the fan blades 140 to help rotate the fan blades 140 when the pitch of the fan blades 140 changes.

The one or more radial thrust bearings 1080 are disposed radially at the thrust bearing radius R_{TB} defined in the radial direction R from the longitudinal centerline axis 112 to a radial center 1083 of a plurality of rolling elements 1082 of the radial thrust bearings 1080, as discussed above. The fan actuation system axial length A_{FAS} is an axial length, in the axial direction (e.g., parallel with the longitudinal centerline axis 112), from an axially forward-most surface 1015 of the fan actuation system 1000 to the pitch axis P of the fan blades 140.

As mentioned earlier, the inventors sought to address the problem implementing a variable pitch actuation system within the more limited packaging space available in a turbofan engine and while accounting for the significantly higher loading environment and more numerous blades relative to a turboprop engine. By way of testing various engine architectures the inventors experimented with different configurations of the pitch actuation system, fine and coarse pitch actuators, hydraulic actuators, and bearing placement that could sustain the higher loading associated with more numerous blades, higher disk loading, and Mach speed sufficient to satisfy operational and safety requirements in the event of, e.g., loss of hydraulic pressure. Additionally, while it was possible to arrive at such a system after experiments and testing, there was a challenge to determine how to fit the system within a comparatively more limited space of a turbofan engine.

During the course of evaluating the different embodiments as set forth herein, with the goal of providing the necessary force to pitch the fan blades, taking due account for the number of blades, accounting for loss in fluid pressure or generally lost power conditions, aerodynamic performance, cooling, aeromechanics, and disc loading/fan blade loading, etc., the inventors had discovered there was indeed much less space available for this system to operate as required for the engine's pitch actuation system. After evaluating several different architectures of pitch change mechanisms (with and without counterweight, oil transfer devices, fine and coarse pitch system, torque transfer load path for pitching blades and delivery of shaft power from gearbox, etc.—both for a ducted engine and an open fan engine—it was discovered, unexpectedly, that there is relationships among the number of fan blades, the fan tip diameter D_{FT}, the cruise Mach number, and the thrust bearing radius R_{TB}, and an axial length L_{AXIAL} capable of differentiating an architecture that satisfies operational and packaging requirements from an architecture that does not satisfy these requirements. These relationships, moreover, are capable of uniquely identifying a finite and readily ascertainable number of embodiments suitable for a particular architecture that accounts for the size and the loading requirements needed to pitch the fan blades without overly sacrificing the aerodynamic performance, cooling aeromechanics, and load margins on the fan blades. For example, the cruise Mach number was not expected to be a significant factor, but as discussed further below, the cruise Mach number was found to be a factor and particularly in conjunction with fan diameter at higher Mach numbers. The inventors submit that the relationships enable one to select a size for the fan pitch actuation system that can reduce the size and the weight of the fan pitch actuation system, while accounting for the factors discussed above. The inventors further submit that the relationships can help identify an improved fan efficiency, or penalties to efficiency by choosing one fan pitch actuation system architecture over another. A relationship is referred to as a fan actuation system (FAS) envelope, in relationship (1):

$$FAS envelope = \frac{{N}_{FB} \times {D}_{FT} \times {M}_{cruise}}{( \frac{{R}_{TB}}{{N}_{FB}} )} . \qquad ( 1 )$$

N_{FB} is the number of fan blades of the fan, D_{FT} is the fan tip diameter, M_{cruise} is the Mach number at cruise (mid-level power operation), and R_{TB} is the thrust bearing radius of the radial thrust bearings (any of the radial thrust bearings detailed herein). N_{FB}×D_{FT}×M_{cruise} is referred to as a loading envelope, and R_{TB}/N_{FB} is referred to as a spacing envelope. Accordingly, the FAS envelope is given by the loading envelope divided by the spacing envelope.

A second relationship is referred to as a fan actuation system length (FASL) envelope, in relationship (2):

$$FASL envelope = \frac{{N}_{FB} \times {D}_{FT}}{{L}_{AXIAL} ( \frac{{R}_{TB}}{{N}_{FB}} )} . \qquad ( 2 )$$

N_{FB} is the number of fan blades of the fan, D_{FT} is the fan tip diameter, R_{TB} is the thrust bearing radius of the radial thrust bearings, and L_{AXIAL} is an axial length, along the longitudinal centerline axis 112 from the fan hub tip 157 to the fan bearings 155. In particular, L_{AXIAL} is a summation of the fan hub axial length A_{FH} and the fan bearing axial length A_{FB}. N_{FB}×D_{FT} is referred to as a loading envelope, and L_{AXIAL}×(R_{TB}/N_{FB}) is referred to as a spacing envelope. Accordingly, the FASL envelope is given by the loading envelope divided by the spacing envelope.

As discussed further below, the inventors identified a range for the FAS envelope and the FASL envelope that enables a fan actuation system design for different turbofan engine architectures that accounts for the integrity/reliability of load paths needed to pitch the fan blades within the space constraints imposed by a turbofan engine (vs. a turboprop's space constraints). Fan pitch actuation system architectures that fall within this range are believed to satisfy packaging requirements for a turbofan engine, while those architectures that do not fall within the FAS envelope range or the FASL envelope range are believed to not satisfy the packaging requirements, which indicate that the system would be unacceptably large and not result in an aircraft engine that met aero efficiency and weight requirements (i.e., an undesirable engine architecture). Using these unique relationships, the size of the fan actuation system can be selected to achieve a more compact fan pitch actuation system for a turbofan engine. Using the FAS envelope or the FASL envelope as a guide, a fan pitch actuation system can be developed that takes into account the loading associated with pitching of the fan blades based on the size of the fan blades, the number of fan blades, the size of thrust bearing, the cruise Mach number, or the axial length, which factors were found—as a result of the extensive number of architectures considered for different thrust class engines, some successful and some not successful—to largely define the packaging size needed to accommodate a pitch actuation system capable of handling the fan loading environment.

Table 1 represents exemplary embodiments 1 to 14 and their corresponding FAS envelope and FASL envelope values for various turbofan engines at various cruise Mach numbers. Embodiments 1 to 14 may represent the turbofan engine 110 of FIG. 1 (e.g., ducted engine) or the turbofan engine 210 of FIG. 2 (e.g., unducted fan engine) and can be applied to any of the pitch actuation systems detailed herein. In particular, embodiments 7, 9, and 13 are ducted engines (e.g., such as the turbofan engine 110 of FIG. 1), and embodiments 1 to 6, 8, 10 to 12, and 14 are unducted fan engines (e.g., such as the turbofan engine 210 of FIG. 2). In Table 1, the FAS envelope values were determined based on relationship (1) described above, the FASL envelope values were determined based on relationship (2) described above, and using fan tip diameters D_{FT}, thrust bearing radiuses R_{TB}, and axial lengths L_{AXIAL} in inches.

TABLE 1

| | | | | | | | FAS | FASL |
|---|---|---|---|---|---|---|---|---|
| | | D_{FT} | R_{TB} | A_{FH} | A_{FB} | | Enve- | Enve- |
| Emb. | N_{FB} | (in.) | (in.) | (in.) | (in.) | M_{cruise} | lope | lope |
| 1 | 12 | 156.0 | 26.9 | 60.60 | 21.60 | 0.8 | 668 | 10.2 |
| 2 | 14 | 156.0 | 24.9 | 60.60 | 20.98 | 0.8 | 982 | 15.1 |
| 3 | 14 | 154.0 | 24.7 | 59.82 | 20.92 | 0.8 | 978 | 15.1 |
| 4 | 14 | 153.8 | 24.3 | 59.75 | 20.79 | 0.8 | 992 | 15.4 |
| 5 | 14 | 164.3 | 24.6 | 63.82 | 20.89 | 0.8 | 1047 | 15.5 |
| 6 | 14 | 110.4 | 19.5 | 42.89 | 19.31 | 0.8 | 888 | 17.8 |
| 7 | 12 | 88.7 | 19.0 | 34.46 | 19.15 | 0.9 | 605 | 12.5 |
| 8 | 10 | 120.0 | 14.8 | 46.62 | 17.85 | 0.9 | 730 | 12.6 |
| 9 | 10 | 84.0 | 14.0 | 32.63 | 17.61 | 0.75 | 450 | 11.9 |
| 10 | 18 | 168.0 | 27.0 | 65.26 | 21.63 | 0.9 | 1814 | 23.2 |
| 11 | 10 | 120 | 14.0 | 46.62 | 17.61 | 0.8 | 686 | 13.3 |
| 12 | 14 | 168.0 | 19.0 | 65.26 | 19.15 | 0.88 | 1525 | 20.5 |
| 13 | 10 | 84.0 | 19.0 | 32.63 | 19.15 | 0.8 | 354 | 8.5 |
| 14 | 14 | 120.0 | 27.0 | 46.62 | 21.63 | 0.88 | 767 | 12.8 |
| 15 | 14 | 180.0 | 19.0 | 69.92 | 19.15 | 0.92 | 1708 | 20.8 |

The FAS envelope and the FASL envelope are only valid for an engine with fan blades N_{FB} in a range from ten to eighteen for a ducted engine, and from ten to sixteen for an open fan engine. In some aspects, the number of fan blades N_{FB} is in ten to fourteen for an open fan engine. The number of fan blades N_{FB} affects the volume (e.g., amount of space) circumscribed by the fan blades. Increasing the number of fan blades N_{FB} increases the amount of airflow that the fan can produce for a particular fan tip diameter and fan rotation speed, but a higher N_{FB} also reduces the tangential distance T_{FB} between fan blades at the fan hub, which impacts the available space for pitch actuation of each individual blade, referring to the space needed per blade for pitch levers, gearing, oil transfer devices, related mechanisms for pitching fan blades and size of load bearing parts of the trunnion and related supporting structure capable of carrying the fan blade loads. This space is at a premium because with an increased number of fan blades the loading capability per blade needs to be satisfied within a smaller space compared to an engine with fewer blades (e.g., such as a turboprop engine). The FAS envelope values and the FASL envelope values account for the number of fan blades N_{FB} selected to increase the amount of airflow but without imposing an unrealistically narrow tangential fan blade distance T_{FB} between adjacent fan blades in order to fit within the desired packaging envelope.

The FAS envelope and the FASL envelope are only valid for a fan tip diameter D_{FT} in a range from eighty-four inches to one hundred ninety-two inches (84.0 in. to 192.0 in.). In some aspects, the FAS envelope and the FASL envelope are valid for a fan tip diameter D_{FT} in a range from eighty-four inches to one hundred eighty inches (84.0 in. to 180.0 in.). In some aspects, the FAS envelope and the FASL envelope are valid for a fan tip diameter D_{FT} in a range from eighty-four inches to one hundred sixty-eight inches (84.0 in. to 168.0 in.). The fan tip diameter D_{FT} also affects the volume needed for supporting the fan blades during operation. Increasing the fan tip diameter D_{FT} increases the fan tip speed for a given rotational speed and therefore the load that needs to get reacted at the trunnion, and torque needed in the pitching mechanism for pitching the blade. The radial spacing between blades and within the volume circumscribed by the fan blades (e.g., within the space circumscribed by the radial thrust bearings) decreases, thereby decreasing the volume beneath the fan and providing less space for the load bearing structure that can react the blade loads. Furthermore, as the bearing radius R_{TB} is extended out, the structure supporting the blade at its root needs to be capable of sustaining higher loads because the blade is disposed further from the fan rotation axis. The more robust root results in a larger fan disk, further providing less space underneath the fan for the fan actuation system. In view of these weight and size considerations, as well as the ability to install such fan blades and fans without resulting in unacceptable aero efficiency penalties, the inventors determined that a fan tip diameter D_{FT} should be less than one hundred ninety-two inches (192.0 in.). In some aspects, the fan tip diameter D_{FT} should be less than one hundred eighty inches (180.0 in.). In some aspects, the fan tip diameter D_{FT} should be less than one hundred sixty-eight inches (168.0 in.). The fan tip diameter D_{FT} may therefore be limited as it impacts the space available for a pitch actuation system suitable for carrying fan blade loads. The size of the fan blades in ducted engines is limited by the duct (e.g., the nacelle). In embodiments for a ducted engine (e.g., the turbofan engine 110 of FIG. 1), the fan tip diameter D_{FT} is in a range from eighty-four inches to one hundred twenty inches (84.0 in. to 120.0 in.). In embodiments for an open fan engine (e.g., the turbofan engine 210 of FIG. 2), the fan tip diameter D_{FT} is in a range from one hundred twenty inches to one hundred ninety-two inches (120.0 in. to 192.0 in.). In some aspects for an open fan engine (e.g., the turbofan engine 210 of FIG. 2), the fan tip diameter D_{FT} is in a range from one hundred twenty inches to one hundred eighty inches (120.0 in. to 180.0 in.). In some aspects for an open fan engine (e.g., the turbofan engine 210 of FIG. 2), the fan tip diameter D_{FT} is in a range from one hundred twenty inches to one hundred sixty-eight inches (120.0 in. to 168.0 in.).

The FAS envelope and the FASL envelope are only valid for a thrust bearing radius R_{TB} in a range from ten inches to twenty-seven inches (10 in. to 27 in.). In some aspects, the thrust bearing radius R_{TB} is in a range from twelve inches to twenty-seven inches (12 in. to 27 in.). In some aspects, the thrust bearing radius R_{TB} is in a range from fourteen inches to twenty-seven inches (14 in. to 27 in.). The thrust bearing radius R_{TB} defines the amount of space, or the volume available for the fan actuation system. Increasing the thrust bearing radius R_{TB} provides more space for the fan actuation system but sacrifices aerodynamic performance by making the fan hub radius ratio (i.e., the ratio of the fan hub radius to the fan blade radius) larger. Decreasing the thrust bearing radius R_{TB} reduces the fan hub radius ratio and reduces the size of the turbofan engine but provides less space to carry the loads from the fan blades. The thrust bearing radius R_{TB} reflects the need for adequately accommodating the diameter needed for packaging the fan actuation system but without overly sacrificing aerodynamic performance of the turbofan engine. In embodiments for a ducted engine (e.g., the turbofan engine 110 of FIG. 1), the thrust bearing radius R_{TB} is in a range from twelve inches to nineteen inches (12 in. to 19 in.). In some aspects for a ducted engine, the thrust bearing radius R_{TB} is in a range from fourteen inches to nineteen inches (14 in. to 19 in.). In embodiments for an open fan engine (e.g., the turbofan engine 210 of FIG. 2), the thrust bearing radius R_{TB} is in a range from ten inches to twenty-seven inches (10 in. to 27 in.). In some aspects for an open fan engine (e.g., the turbofan engine 210 of FIG. 2), the thrust bearing radius R_{TB} is in a range from twelve inches to twenty-seven inches (12 in. to 27 in.). In some aspects for an open fan engine, the thrust bearing radius R_{TB} is in a range from nineteen inches to twenty-seven inches (19 in. to 27 in).

The FAS envelope and the FASL envelope are valid for a cruise Mach number M_{cruise} in a range from 0.7 to 0.92. In some aspects, the FAS envelope and the FASL envelope are valid for a cruise Mach number M_{cruise} in a range from 0.7 to 0.9. As mentioned above, turbofan engines operate at higher cruise speeds than turboprop engines. At higher cruise speeds, the aerodynamic loads on fan blades increase, thereby requiring more torque for actuating blades in pitch. This means a larger actuation system is needed to handle the higher reaction loads resulting when a torque is applied in flight to change the blade pitch, to move the blade to a feathered position, or coarse/fine pitch changes. The cruise Mach number M_{cruise} reflects this higher loading environment when pitching fan blades. In some aspects, the cruise Mach number M_{cruise} in a range from 0.75 to 0.9. In some aspects, the cruise Mach number M_{cruise} is in a range from 0.8 to 0.88.

The FAS envelope and the FASL envelope are only valid for a fan hub axial length A_{FH} of twenty-five inches to eighty-five inches (25 in. to 85 in.). In some aspects, the FAS envelope and the FASL envelope are only valid for a fan hub axial length A_{FH} of twenty-five inches to seventy-five inches (25 in. to 75 in.). In some aspects, the FAS envelope and the FASL envelope are only valid for a fan hub axial length A_{FH} of forty inches to eighty-five inches (40 in. to 85 in.). The fan hub axial length A_{FH} defines the amount of axial space, or the volume available for the fan actuation system, forward of the pitch axis P of the fan blades 140. Increasing the fan hub axial length A_{FH} provides more space for the fan actuation system but increases the overall weight of the turbofan engine. Decreasing the fan hub axial length A_{FH} reduces the fan performance and the pressure distribution to the fan due to a smaller axial length for the aerodynamic flow lines into the fan hub but provides less axial space to fit the fan actuation system within the fan hub 148. The fan hub axial length A_{FH} reflects the need for aerodynamic performance for the fan and adequately accommodating the axial length needed for packaging the fan actuation system but without overly sacrificing aerodynamic performance of the turbofan engine and allowing for a more efficient fan actuation system. In embodiments for a ducted engine (e.g., the turbofan engine 110 of FIG. 1), the fan hub axial length A_{FH} is in a range from twenty-five inches to forty inches (25 in. to 40 in.). In some aspects for an open fan engine (e.g., the turbofan engine 210 of FIG. 2), the fan hub axial length A_{FH} is in a range from twenty-five inches to seventy-five inches (25 in. to 75 in). In some aspects for an open fan engine (e.g., the turbofan engine 210 of FIG. 2), the fan hub axial length A_{FH} is in a range from forty inches to eighty-five inches (40 in. to 85 in). In this way, the fan hub axial length A_{FH} is greater for open fan engines as compared to ducted fan engines as more space is needed due to the longer fan blades of the open fan engines as compared to the ducted engines.

The FAS envelope and the FASL envelope are only valid for a fan bearing axial length A_{FB} of ten inches to twenty-three inches (10 in. to 23 in.). In some aspects, the FAS envelope and the FASL envelope are only valid for a fan bearing axial length A_{FB} of sixteen inches to twenty-three inches (16 in. to 23 in.). The fan bearing axial length A_{FB} defines the amount of axial space, or the volume available for the fan actuation system, aft of the pitch axis P of the fan blades 140. Increasing the fan bearing axial length A_{FB} provides more space for the fan actuation system but increases the overall weight of the engine and increases loads on the bearings. Decreasing the fan bearing axial length A_{FB} decreases overall engine weight and reduces loads on the bearings but provides less axial space to fit the fan actuation system within the fan hub 148. The fan bearing axial length A_{FB} reflects the need for adequately accommodating the axial length needed for packaging the fan actuation system while minimizing the fan bearing axial length AFB to reduce loads on the bearings and reduce overall weight of the engine. In embodiments for a ducted engine (e.g., the turbofan engine 110 of FIG. 1), the fan hub axial length A_{FH} is in a range from seventeen inches to twenty inches (17 in. to 20 in.). In embodiments for an open fan engine (e.g., the turbofan engine 210 of FIG. 2), the fan hub axial length A_{FH} is in a range from ten inches to twenty-three inches (10 in. to 23 in). In some aspects for an open fan engine (e.g., the turbofan engine 210 of FIG. 2), the fan hub axial length A_{FH} is in a range from sixteen inches to twenty-three inches (16 in. to 23 in).

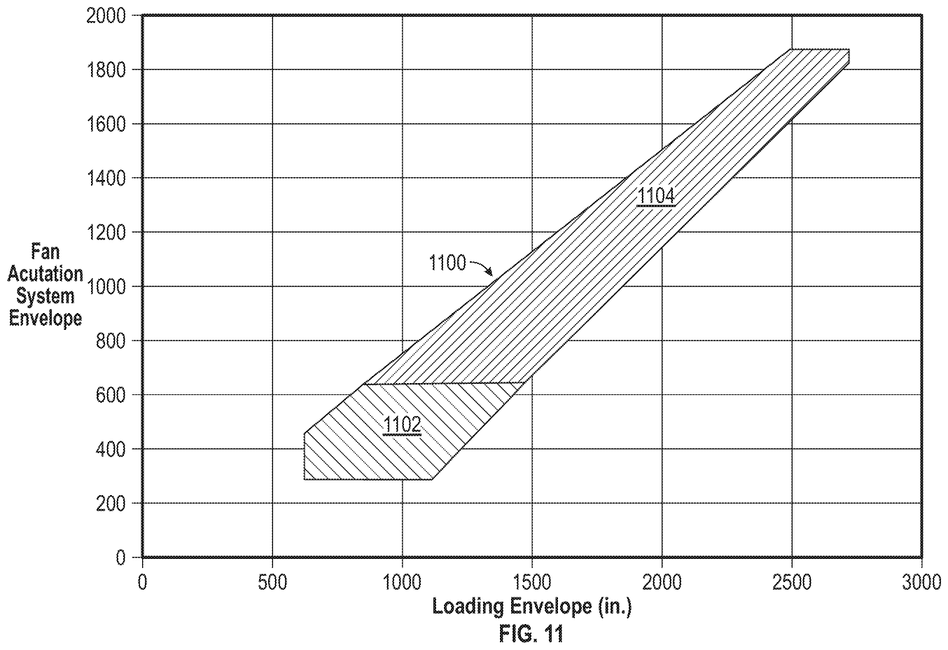

FIG. 11 represents, in graph form, the FAS envelope as a function of the loading envelope (N_{FB}×D_{FT}×M_{cruise}). An area 1100 represents the boundaries of the FAS envelope. The FAS envelope is in a range from three hundred to one thousand eight hundred sixty (300 to 1860) for a loading envelope in a range from five hundred eighty-eight inches to two thousand seven hundred twenty-two inches (588 in. to 2722 in.). Table 1 and FIG. 11 show that the FAS envelope increases as the loading envelope increases. In this way, the FAS envelope increases as the number of fan blades N_{F}B, the fan tip diameter D_{FT}, or the cruise Mach number Mcᵤᵢₛₑ increase. The range of the FAS envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine.

A first area 1102 represents the boundaries of the FAS envelope for ducted engines, such as, for example, the turbofan engine 110 of FIG. 1. A second area 1104 represents the boundaries of the FAS envelope for unducted fan engines, such as, for example, the turbofan engine 210 of FIG. 2. Ducted engines tend to have more limited space for the fan actuation system due to the presence of a fan casing, fan duct, or outer nacelle. On the other hand, the fan actuation system of ducted engines are expected to experience lower loads associated with supporting fan blades and pitching fan blades due to the fan blades having a smaller diameter compared to an open fan engine. The FAS envelope, represented by the first area 1102, is in a range from three hundred to six hundred sixty (300 to 660) for ducted engines. The FAS envelope, represented by the second area 1104, is in a range from six hundred sixty to one thousand eight hundred sixty (660 to 1860) and, preferably, in a range from six hundred sixty to one thousand twenty (660 to 1020) and includes open fan engines.

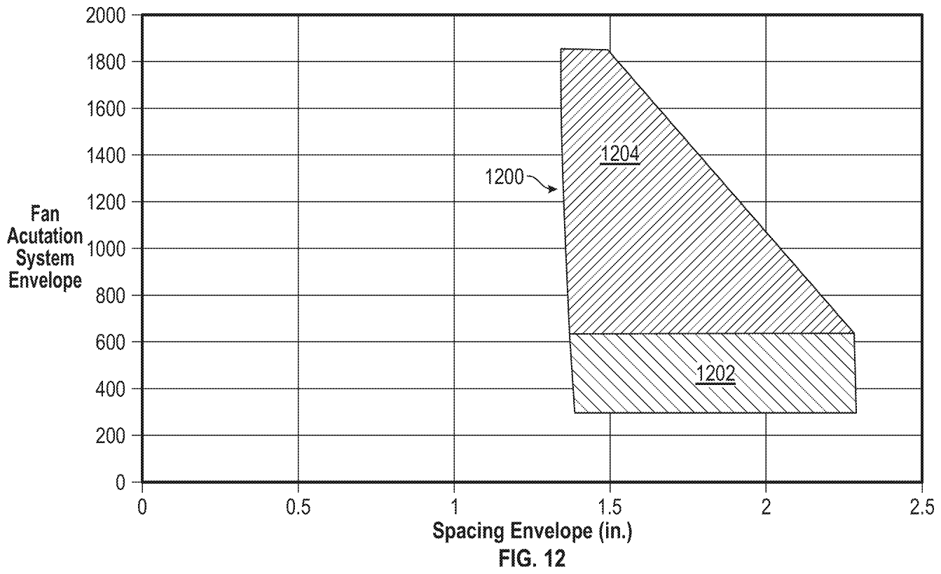

FIG. 12 represents, in graph form, the FAS envelope as a function of the spacing envelope (R_{TB}/N_{FB}). An area 1200 represents the boundaries of the FAS envelope. The FAS envelope is in a range from three hundred to one thousand eight hundred sixty (300 to 1860) for a spacing envelope in a range from one point three five inches to two point two five inches (1.35 in. to 2.25 in.). Table 1 and FIG. 12 show that the FAS envelope decreases as the spacing envelope increases. In this way, the FAS envelope decreases as the thrust bearing radius R_{TB} increases or the number of fan blades N_{FB} decreases. A first area 1202 represents the boundaries of the FAS envelope for ducted engines, and is in a range from three hundred to six hundred sixty (300 to 660) for ducted engines, as detailed above. A second area 1204 represents the boundaries of the FAS envelope for unducted fan engines, and is in a range from six hundred sixty to one thousand eight hundred sixty (660 to 1860) and, preferably, in a range from six hundred sixty to one thousand twenty (660 to 1020), as detailed above.

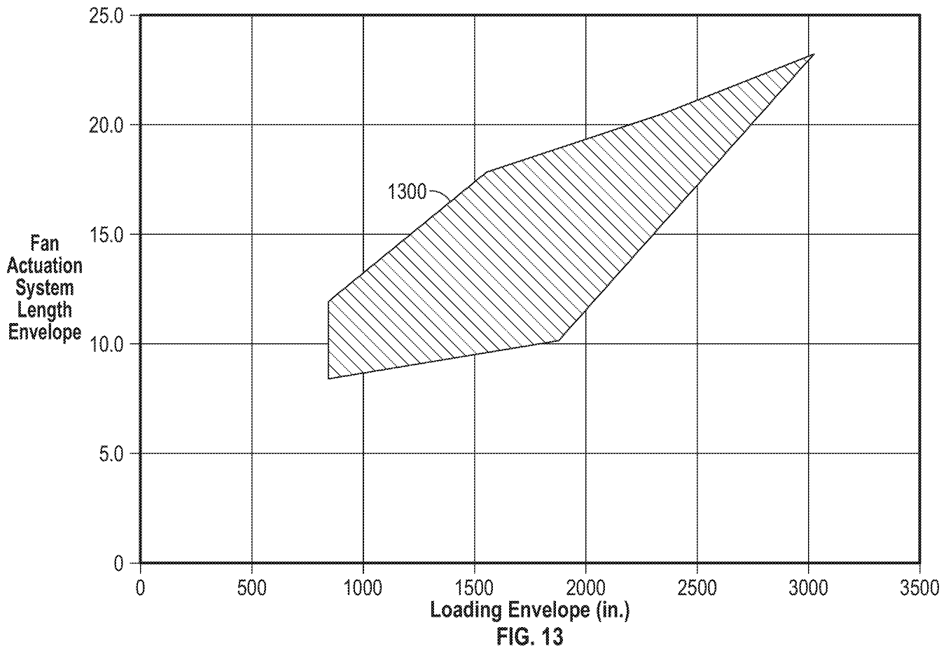

FIG. 13 represents, in graph form, the FASL envelope as a function of the loading envelope (N_{FB}×D_{FT}). An area 1300 represents the boundaries of the FASL envelope. The FASL envelope is in a range from eight point five to twenty-four (8.5 to 24) for a loading envelope in a range from eight hundred forty inches to three thousand twenty-four inches (840 in. to 3,024 in.). Table 1 and FIG. 13 show that the FASL envelope increases as the loading envelope increases. In this way, the FASL envelope increases as the number of fan blades N_{F}B or the fan tip diameter D_{FT} increase. The range of the FASL envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine. As mentioned above, ducted engines tend to have more limited space for the fan actuation system due to the presence of a fan casing, fan duct, or outer nacelle, while experiencing lower loads associated with supporting fan blades and pitching fan blades due to the fan blades having a smaller diameter compared to an open fan engine. For ducted engines, the FASL envelope is in a range from eight point five to thirteen (8.5 to 13).

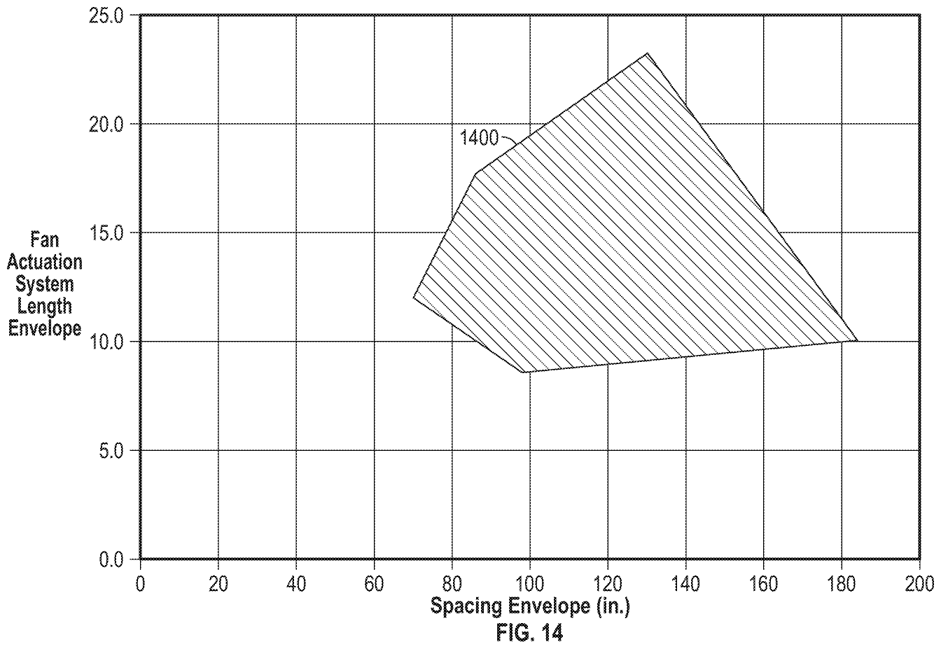

FIG. 14 represents, in graph form, the FASL envelope as a function of the spacing envelope L_{AXIAL}×(R_{TB}/N_{FB}). An area 1400 represents the boundaries of the FASL envelope. The FASL envelope is in a range from eight point five to twenty-four (8.5 to 24) for a spacing envelope in a range from seventy square inches to one hundred eighty-five square inches (70 in.² to 185 in.²). Table 1 and FIG. 14 show that the FASL envelope decreases as the spacing envelope increases. In this way, the FASL envelope decreases as the thrust bearing radius R_{TB} increases, or the number of fan blades N_{FB} or the axial length L_{AXIAL} decreases. As mentioned above, for ducted engines, the FASL envelope is in a range from eight point five to thirteen (8.5 to 13).

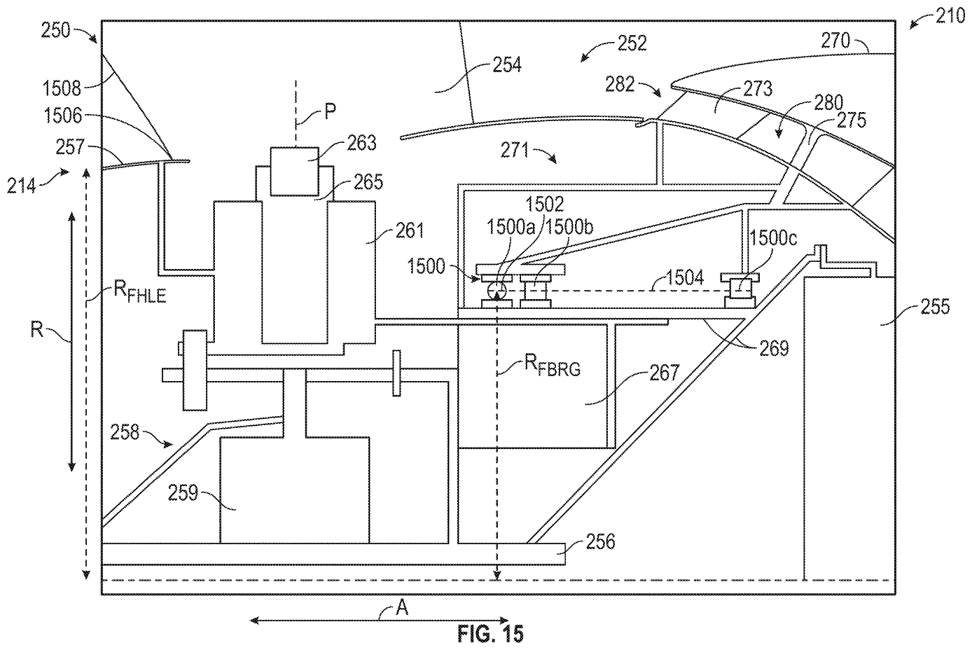

The FAS envelope and the FASL envelope herein provide a fan actuation system a low fan hub radius ratio (a ratio of the hub radius of the blades to the tip radius of the blades of the fan) and a high fan blade count. In one example, a low hub fan radius ratio is in a range from 0.22 to 0.30. This allows the fan diameter to be minimized to meet competing efficiency and installation requirements. To further enable a low fan hub radius ratio, the turbofan engine can include a relatively high fan bearing radius relative to the fan hub radius, as detailed further below with respect to FIGS. 15 to 20. Such a high fan bearing radius allows for a desired packaging of, e.g., the fan actuation system and the fan counterweights. The increased fan bearing radius allows the fan bearings to carry the forward thrust load of the turbofan engine while minimizing, e.g., any moments on the fan bearings in the event of a variation in a distribution of the forward thrust load on the fan bearings. In this way, the high fan bearing radius allows for a variable pitch fan (e.g., the inclusion of a fan actuation system) while maintaining a low fan hub radius ratio and a smaller outer casing, which provides for less drag and a larger frontal area for a given fan blade size.

FIG. 15 is a schematic view of the forward end 214 of the fan assembly 250 of the turbofan engine 210 of FIG. 2. As depicted in FIG. 15, each fan blade 254 defines a base 263 at an inner end along a radial direction R. Each fan blade 254 is coupled at the base 263 to a disk 261 via a trunnion mechanism 265. In FIG. 15, the base 263 is configured as a dovetail received within a correspondingly shaped dovetail slot of the trunnion mechanism 265. In other aspects, the base 263 may be attached to the trunnion mechanism 265 in any other suitable manner. For example, the base 263 may be attached to the trunnion mechanism 265 using a pinned connection, or any other suitable connection. In still other aspects, the base 263 may be formed integrally with the trunnion mechanism 265. Notably, the trunnion mechanism 265 facilitates rotation of a respective fan blade 254 about the pitch axis P of the respective fan blades 254. The fan assembly 250 can also include one or more fan counterweights 267 to balance the fan 252 during operation. Further, the disk 261 is attached to the gearbox assembly 255 through the fan shaft 256, which includes one or more individual structural members 269.

The fan assembly 250 includes a fan frame 271 that is connected to the fan cowl 270 through an inlet vane 273 and a strut 275. In this way, the fan frame 271 is a static or a stationary component that supports static components of the fan assembly 250. While the fan frame 271 is depicted as being connected to the fan cowl 270 through both the inlet vane 273 and the strut 275, the fan frame 271 can be connected to the fan cowl 270 through at least one of the inlet vane 273 or the strut 275.

The fan assembly 250 also includes one or more fan bearings 1500 for supporting rotation of the various rotating components of the fan assembly 250, such as the plurality of fan blades 254 via the fan shaft 256 and the disk 261. More particularly, the various rotating components of the fan assembly 250 rotate with respect to the fan frame 271 via the one or more fan bearings 1500. In FIG. 15, the one or more fan bearings 1500 includes a first fan bearing 1500a, a second fan bearing 1500b, and a third fan bearing 1500c. The first fan bearing 1500a is a ball bearing, the second fan bearing 1500b is a roller bearing, and the third fan bearing 1500c is a roller bearing. The first fan bearing 1500a is positioned forward of the second fan bearing 1500b and the third fan bearing 1500c. The fan bearings 1500 can include any other suitable number or type of bearings for supporting rotation of the plurality of fan blades 254. For example, the one or more fan bearings 1500 can include a pair (two) tapered roller bearings, or any other suitable bearings.

Referring still to FIG. 15, the one or more fan bearings 1500 are located axially aft of the disk 261 and the trunnion mechanisms 265 and radially outward of the one or more actuators 259 along the radial direction R and also outward of the one or more fan counterweights 267 along the radial direction R. In particular, the fan bearings 1500 are located axially between the disk 261 and the gearbox assembly 255. Such a configuration of the fan bearings 1500 allows for the actuators 259 to be axially aligned with the disk 261 and the trunnion mechanisms 265 along the axial direction A and radially inward of the disk 261 and the trunnion mechanisms 265 along the radial direction R. Moreover, such a configuration allows for the one or more fan counterweights 267 to be positioned adjacent to the one or more actuators 259.

As shown in FIG. 15, the one or more fan bearings 1500 define a fan bearing radius R_{FBRG} along the radial direction R. The fan bearing radius R_{FBRG} is defined as a distance along the radial direction R from the longitudinal centerline axis 212 of the turbofan engine 210 to a central axis or a center point of the one or more fan bearings 1500. More particularly, each of the first fan bearing 1500a, the second fan bearing 1500b, and the third fan bearing 1500c are radially aligned such that a center point 1502 of the first fan bearing 1500a and a central axis 1504 of the second fan bearing 1500b and the third fan bearing 1500c are each positioned at the same radial distance from the longitudinal centerline axis 212. In some aspects, one or more of the fan bearings 1500 may be stepped or otherwise positioned at different distances from the longitudinal centerline axis 212 along the radial direction R. In such aspects, the fan bearing radius R_{FBRG} refers to a radius of the innermost fan bearing 1500 along the radial direction R (i.e., a distance of the central point 1502 or the center axis 1504 of the innermost fan bearing 1500 along the radial direction R to the longitudinal centerline axis 212).

The fan hub 257 defines a fan hub leading edge radius R_{FHLE} along the radial direction R. The fan hub leading edge radius R_{FHLE} is defined as a radial distance of an outermost point of the fan hub 257 along the radial direction R to the longitudinal centerline axis 212 of the turbofan engine 210. In particular, the fan hub leading edge radius R_{FHLE} is a distance along the radial direction R from the longitudinal centerline axis 212 to a radially innermost point 1506 of a leading edge 1508 of the fan blades 254 (to the fan root 251 at the leading edge 1508. The fan hub leading edge radius R_{FHLE} is indicative of an overall size of a core portion of the fan assembly 250. Accordingly, the fan assembly 250 defines a fan bearing radius ratio R_{FHLE}:R_{FBRG} (i.e., a ratio of the fan hub leading edge radius R_{FHLE} to the fan bearing radius R_{FBRG}) in a range from 1.0 to 2.75. In some aspects, the fan bearing radius ratio is less than or equal to 2.75, such as less than or equal to 2.5, such as less than or equal to 2.0, such as less than or equal to 1.75. More particularly, the hub radius to fan bearing radius ratio R_{FHLE}:R_{FBRG} is greater than or equal to 1.0 and less than or equal to 1.5.

The plurality of fan blades 254 are rotatable about the axial direction A at a maximum rotational speed during operation of the fan assembly 250. The maximum rotational speed refers to a maximum speed at which the fan blades 254 are configured to rotate during a full power condition of the turbofan engine 210, such as when the turbofan engine 210 is generating a maximum takeoff thrust. The one or more fan bearings 1500 supporting rotation of the plurality of fan blades 254 may define a DN value during operation of the fan assembly 250 and rotation of the plurality of fan blades 254 at the maximum rotational speed of at least about 0.6 million. For example, in certain exemplary embodiments, the one or more fan bearings 1500 supporting rotation of the plurality of fan blades 254 may define a DN value during rotation of the plurality of fan blades 254 of at least 0.7 million, at least 0.8 million, at least 1 million, or at least 1.5 million. As used herein, the term “DN value” refers to a fan bearing speed quantifier calculated by multiplying a bore of the bearing in millimeters by a rotational speed in revolutions per minute (RPM). The bore of the one or more fan bearings 1500 supporting rotation of the plurality of fan blades 254 of the fan assembly 250 refers to a distance from the longitudinal centerline axis 112 to an inner race of the one or more fan bearings 1500.

Accordingly, in order to maintain the DN value of the one or more fan bearings 1500 below one or more of the above stated DN values, the fan assembly 250 may define a relatively low maximum rotational speed during operation. For example, in certain exemplary embodiments, the fan assembly 250 may define a maximum rotational speed in a range from 300 RPM to 8,500 RPM during operation. In some aspects, the maximum rotational speed is less than 8,500 RPM during operation. More specifically, in certain exemplary embodiments, the fan assembly 250 may define a maximum rotational speed of less than 8,000 RPM during operation, less than 7,500 rpm during operation, less than 7,000 RPM during operation, less than 6,500 rpm during operation, or less than 6,000 RPM during operation. In some aspects, the maximum rotational speed is in a range from 300 RPM to 1,100 RPM during operation.

As discussed above, inclusion of a relatively high fan bearing radius relative to a fan hub radius may allow for a desired packaging of, e.g., the fan actuation system and one or more fan counterweights in the fan assembly of the turbofan engine. Moreover, when the turbofan engine is an indirect drive turbofan engine (e.g., including a gearbox connecting a driveshaft and a fan shaft while reducing a rotational speed of the fan shaft relative to the driveshaft) the increased fan bearing radius may additionally provide for a more stable fan during operation. Specifically, with direct drive turbofan engine (e.g., without a gearbox), a forward thrust load generated by the fan during operation may be counteracted by a reverse thrust load generated by the turbine section of the turbofan engine (the turbine section being directly connected to the fan via a shaft in such a configuration). By contrast, within an indirect drive turbofan engine, such as the turbofan engine 110 depicted in FIG. 1 and the turbofan engine 210 in FIG. 2, the forward ball bearing (e.g., the first fan bearing 1500a) is required to carry substantially all of an amount of forward thrust generated by the fan during operation, as the gearbox assembly prevents the LP shaft from offsetting such forward thrust load of the fan with a reverse thrust load of the turbine section. Accordingly, the increased fan bearing radius allows the one or more fan bearings to carry the forward thrust load while minimizing, e.g., any moments on such one or more fan bearings in the event of a variation in a distribution of the forward thrust load on the one or more fan bearings.

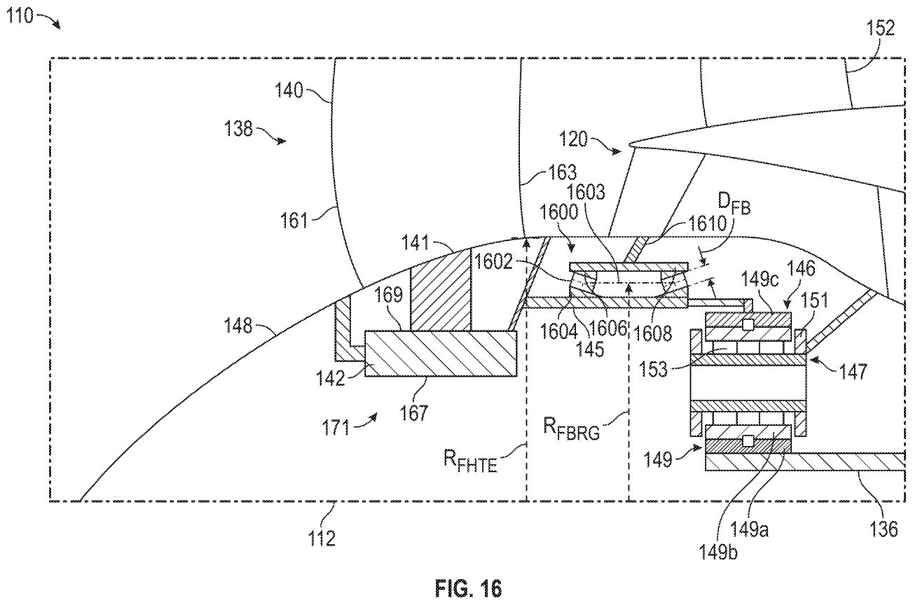

FIG. 16 is an enlarged, schematic, cross-sectional diagram of the turbofan engine 110 of FIG. 1 and having one or more fan bearings 1600, taken along the longitudinal centerline axis 112, according to the present disclosure. While FIG. 16 shows the turbofan engine 110 of FIG. 1, the fan bearings 1600 can also be implemented in the turbofan engine 210 of FIG. 2. FIG. 16 shows one fan blade 140 of the fan 138, the fan disk 142, the core inlet 120, and the gearbox assembly 146. Further, although not shown for clarity, the turbofan engine 110 can include any of the fan actuation systems disclosed herein.

The fan shaft 145 is coupled to the fan disk 142 such that rotation of the fan shaft 145 causes the plurality of fan blades 140 to rotate about the longitudinal centerline axis 112. Each of the fan blades 140 extends from a leading edge 161 and a trailing edge 163. The fan root 141 is at the fan hub 148. The fan disk 142 is defined between an inner surface 167 and an outer surface 169. The inner surface 167 is a radially-most inner surface of the fan disk 142 and the outer surface 169 is a radially-most outer surface of the fan disk 142. The fan disk 142 includes a disk bore 171 defined by the inner surface 167 of the fan disk 142. In particular, the disk bore 171 is defined from the longitudinal centerline axis 112 to the inner surface 167. The fan hub 148 includes a fan hub trailing edge radius R_{FHTE} that is defined in the radial direction from the longitudinal centerline axis 112 to the fan hub 148 at the trailing edge 163 of the fan blades 140.

The turbofan engine 110 also has a fan hub radius ratio that is defined as a ratio of the fan hub trailing edge radius R_{FHTE} to a fan tip radius of the fan blades 140 (e.g., the radius from the longitudinal centerline axis 112 to the fan tip 143 at the trailing edge 163 of the fan blades 140). The fan hub radius ratio is in a range from 0.1 to 0.4. Lower fan hub radius ratios result in lower core engine inlets. A lower fan hub radius and a lower core engine inlet radius result in a core engine with a lesser diameter (e.g., smaller core engine), and, thus, a reduced overall engine weight, as compared to turbofan engines with fan hub radius ratios greater than 0.4. In some aspects, the fan hub radius ratio is in a range from 0.15 to 0.32. In some aspects, the fan hub radius ratio is in a range from 0.2 to 0.35. In some aspects, the fan hub radius ratio is in a range from 0.2 to 0.3. The lower fan hub can also reduce the probability of foreign object damage (FOD), such as, for example, from bird strikes, in the core engine, as the fan tends to push the foreign objects radially outward by the centripetal force imparted to the foreign object by the spinning fan blades. A lower fan hub also improves aerodynamic efficiency of the fan. The lower fan hub radius ratios disclosed herein are enabled by the fan actuation system being characterized by the FASL as detailed above. In particular, the FASL enables a smaller fan actuation system to fit within a tighter packaging underneath the fan while ensuring the fan actuation system can provide an adequate force or torque to pitch the fan blades in the higher loading environment of a turbofan engine (as compared to a turboprop engine). In this way, if the fan actuation system has a FASL that falls within the ranges detailed above, the fan hub radius ratio can be made lower to achieve the improved aerodynamic efficiency of the fan in guiding the incoming airflow into the core inlet.

The fan bearings 1600 are radial thrust (radial shaft load) bearings that transmit a load (e.g., the radial shaft load) from the fan shaft 145 to a static structure of the turbofan engine 110. The fan bearings 1600 each includes one or more rolling elements 1602, an inner race 1604, and an outer race 1606. The fan bearings 1600 support rotation of the fan shaft 145. In FIG. 16, fan bearings 1600 include a forward fan bearing and an aft fan bearing. The rolling elements 1602 are tapered rolling elements that include tapered cylindrical bodies and are disposed between the inner race 1604 and the outer race 1606. In this way, the one or more fan bearings 1600 are roller bearings. The outer race 1606 of each of the fan bearings 1600 is connected to a fan bearing support member 1608. The fan bearing support member 1608 is connected to a fan bearing housing 1610 that is connected to a static component of the turbofan engine 110. The inner race 1604 is connected to the fan shaft 145. In this way, the fan bearings 1600 are connected to the static component and to the fan shaft 145 such that the inner race 1604, and the rolling elements 1602, rotates with respect to the outer race 1606, such that the fan bearings 1600 support rotation of the fan shaft 145.

The fan bearings 1600 are positioned aft, and radially outward, of the fan disk 142. In particular, the fan bearings 1600 are positioned entirely axially aft of the fan disk 142 and entirely radially outward of the fan disk 142 (e.g., radially outward of the outer surface 169 of the fan disk 142). In this way, the fan bearings 1600 are positioned radially outward of the disk bore 171 (e.g., of the inner surface 167) of the fan disk 142. The fan bearings 1600 are positioned axially between the fan disk 142 and the gearbox assembly 146. Further, the fan bearings 1600 are positioned radially outward of the gearbox assembly 146, particularly, radially outward of the third gear 149c.

The fan bearings 1600 have a fan bearing radius R_{FBRG} that is defined in the radial direction from the longitudinal centerline axis 112 to a radial center 1603 of the fan bearings 1600. Particularly, the radial center 1603 of the fan bearings 1600 is the radial center 1603 of the rolling elements 1602. The fan bearings 1600 also have a rolling element diameter D_{FB} of the rolling elements 1602 that is defined as a distance of a straight line passing from side to side of a respective rolling element 1602 through a center (e.g., the radial center 1603) of the respective rolling element 1602.

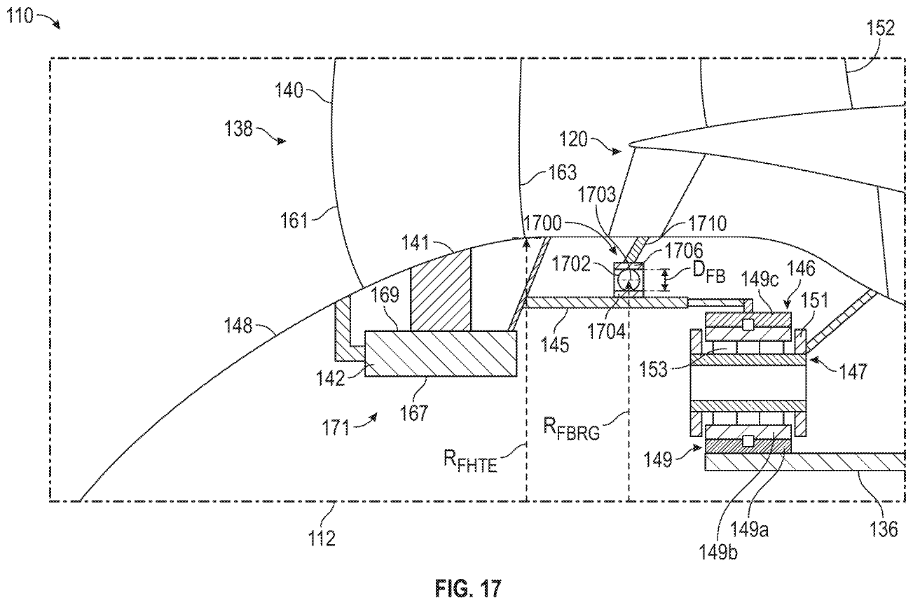

FIG. 17 is an enlarged, schematic, cross-sectional diagram of the turbofan engine 110 and having one or more fan bearings 1700, taken along the longitudinal centerline axis 112, according to another aspect. The fan bearings 1700 are substantially similar to the fan bearings 1600 of FIG. 16. The same reference numerals will be used for components of the fan bearings 1700 that are the same as or similar to the components of the fan bearings 1600 discussed above. The description of these components above also applies to this embodiment, and a detailed description of these components is omitted here.

The fan bearings 1700 each includes one or more rolling elements 1702, an inner race 1704, and an outer race 1706. The fan bearings 1700 support rotation of the fan shaft 145. The rolling elements 1702 are balls that are disposed between the inner race 1704 and the outer race 1706. In this way, the fan bearings 1700 are ball bearings. The turbofan engine 110 also includes a fan bearing housing 1710.

The fan bearings 1700 are positioned aft, and radially outward, of the fan disk 142. In particular, the fan bearings 1700 are positioned entirely axially aft of the fan disk 142 and entirely radially outward of the fan disk 142 (e.g., radially outward of the outer surface 169 of the fan disk 142). In this way, the fan bearings 1700 are positioned radially outward of the disk bore 171 (e.g., of the inner surface 167) of the fan disk 142. The fan bearings 1700 are positioned axially between the fan disk 142 and the gearbox assembly 146. Further, the fan bearings 1700 are positioned radially outward of the gearbox assembly 146, particularly, radially outward of the third gear 149c.

The fan bearings 1700 have a fan bearing radius R_{FBRG} that is defined in the radial direction from the longitudinal centerline axis 112 to a radial center 1703 of the fan bearings 1700 (e.g., of the rolling elements 1702). The fan bearings 1700 also have a rolling element diameter D_{FB} of the rolling elements 1702 that is defined as a distance of a straight line passing from side to side of a respective rolling element 1702 through a center (e.g., the radial center 1703) of the respective rolling element 1702.

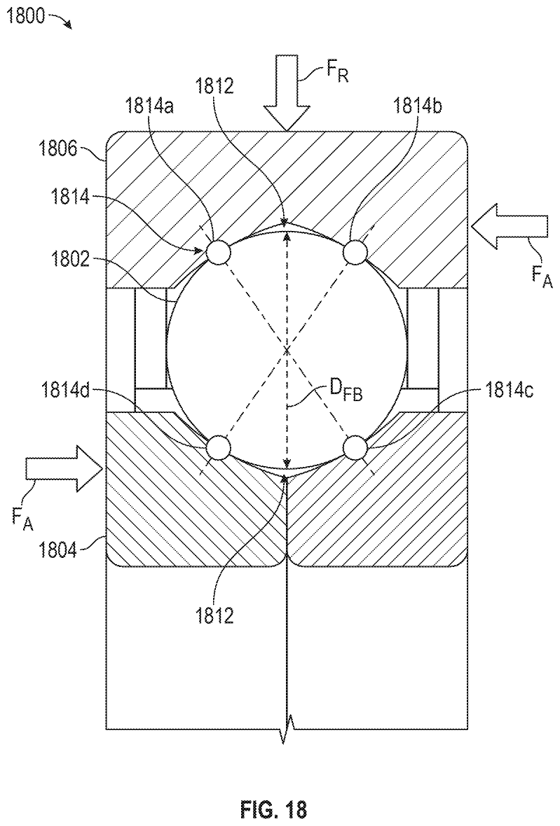

FIG. 18 is a schematic cross-sectional view of a fan bearing 1800 for the turbofan engine 110, according to another aspect. The fan bearing 1800 can be utilized as any of the fan bearings detailed herein. The fan bearing includes one or more rolling elements 1802, an inner race 1804, and an outer race 1806. In some embodiments, the inner race 1804 has a split ring configuration to facilitate easier mounting of the bearing and improved precision. In some embodiments, each of the inner race 1804 and the outer race 1806 defines a concavity having an arch 1812 to allow the rolling element 1802 to have four contact points 1814 with the inner race 1804 and the outer race 1806. In particular, the fan bearing 1800 has two contact points, including a first contact point 1814a and a second contact point 1814b, on the outer race 1806 and two contact points, including a third contact point 1814c and a fourth contact point 1814d, on the inner race 1804. In this way, the fan bearing 1800 is a four-point contact ball bearing. The four-point contact design allows the fan bearing 1800 to handle both radial loads F_{R} and axial loads F_{A} by transmitting the load between the second contact point 1814b and the fourth contact point 1814d, and between the first contact point 1814a and the third contact point 1814c.

In some embodiments, the fan bearing 1800 has a tight bearing configuration, i.e., there is minimal clearance between the rolling elements 1802 and the inner race 1804 and the outer race 1806. In particular, the clearance between the rolling elements 1802 and the inner race 1804 and the outer race 1806 is dimensioned to limit axial movement of the fan shaft 145 (FIG. 1) in relation to the gearbox assembly 146 (FIG. 1) to no greater than 0.010 inches or 10 mil. In some embodiments, the clearance between the rolling elements 1802 and the inner race 1804 and the outer race 1806 is dimensioned to limit axial movement of the fan shaft 145 to no greater than 0.007 inches or 7 mil. The fan bearing 1800 limits axial endplay, i.e., axial movement of the fan shaft 145 in relation to the gearbox assembly 146, thus protecting the gearbox assembly 146 from excessive stress and facilitating a reduction in size and extension of the life of the gearbox assembly 146.

The fan bearing 1800 is designed to withstand extreme conditions including high temperatures, high loads, and high rotational speeds. The materials used to construct the fan bearing 1800 are selected to maximize durability, temperature resistance, and fatigue life. In some embodiments, the fan bearing 1800 can be formed from steel, steel alloys, ceramic materials, cobalt and nickel-based superalloys, or polytetrafluoroethylene (PTFE) and phenolic resins. In addition, the fan bearing 1800 may include coatings, such as, for example, titanium nitride or other anti-friction coatings to further reduce wear and to minimize friction.

The fan bearings of FIGS. 15 to 18 are designed to address the problem of sizing the fan bearings to account for the stresses encountered from the fan shaft, while balancing for minimizing the space under the fan for the fan bearings and other fan components, as well as providing a required amount of thrust for a particular size of the turbofan engine. Additionally, the fan bearings address the challenge in reducing the inner radius of the engine flow path and lowering the fan hub radius ratio, while increasing the fan bearing radius.

Moving the fan bearings aft of the fan disk and increasing the fan bearing radius provide for a reduction in the inner radius of the flow path and the fan hub radius, without overly increasing the heat load on the fan bearings. Further, moving the fan bearings radially outward enables a greater number of rolling elements, which results in a reduced rolling element diameter.

The set of novel embodiments detailed herein include several different architectures of fan bearings and turbofan engines with various sizes and locations. A set of fan bearing designs, producing favorable results, can be characterized by a combination of the fan hub trailing edge radius, the fan bearing radius, the rolling element diameter, and the takeoff thrust, capable of differentiating an architecture that satisfies the operational requirements (e.g., fan bearings capable of handling the stresses from the fan shaft) and the packaging requirements (e.g., lowering the fan hub radius and the inner radius of the flow path) from an architecture that does not satisfy these requirements. As such, a finite and readily ascertainable number of embodiments of the fan bearings account for the operational requirements and the packaging requirements without overly increasing the fan bearing heat load. The novel designs are based on a size of the fan bearings, a size of the rolling elements, and a location of the fan bearings that can reduce the size and the weight of the turbofan engine, while accounting for the factors discussed above. These novel designs can be characterized as a fan bearing envelope (FBE), as set forth in expression (3):

$$FBE = ( \frac{{R}_{FBRG}}{{R}_{FHTE}} ) \times ( \frac{{D}_{FB}}{( \frac{{Thrust}_{TO}}{1000} )} ) . \qquad ( 3 )$$

In expression (3), R_{FBRG} is the fan bearing radius, R_{FHTE} is the fan hub trailing edge radius, D_{FB} is the rolling element diameter, and Thrust_{TO} is the takeoff thrust of the turbofan engine. The takeoff thrust Thrust_{TO} is a high power operation (e.g., greater than 85% of the SLS maximum engine rated thrust) of the turbofan engine during a takeoff condition of the aircraft.

As discussed further below, the fan bearings include fan bearing designs for different turbofan engine architectures that accounts for handling the stresses from the fan shaft during operation, while reducing the fan hub radius, and, thus, providing for an improved specific flow through the fan and reducing the fan diameter required to achieve a certain thrust or reduces the fan pressure ratio and improves propulsive efficiency of the fan. These improved fan bearing designs can be characterized according to a defined range for the FBE.

Table 2 below represents exemplary embodiments 16 to 27 and their corresponding FBE values for various turbofan engines and fan bearings. Embodiments 16 to 27 may represent the turbofan engine 110 of FIG. 1 (e.g., ducted engine) or the turbofan engine 210 of FIG. 2 (e.g., unducted fan engine) and can be applied to any of the fan bearings detailed herein. In Table 2, the FBE values were determined based on expression (3) described above, and using fan hub trailing edge radius, fan bearing radius, fan bearing diameter values in millimeters and takeoff thrust values in kilo-Newtons. In particular, embodiments 16, 17, 22, 24, and 26 are tapered roller bearings (e.g., the fan bearings 1600 of FIG. 16). Embodiments 18 to 21, 23, 25, and 27 are ball bearings (e.g., the fan bearings 1700 of FIG. 17 or the fan bearing 1800 of FIG. 18).

TABLE 2

| | R_{FHTE} | R_{FBRG} | R_{FBRG}/ | D_{FB} | Thrust_{TO} | Fan Bearing |
|---|---|---|---|---|---|---|
| Emb. | (mm) | (mm) | R_{FHTE} | (mm) | (kN) | Envelope (FBE) |
| 16 | 360.934 | 212.09 | 0.588 | 19.05 | 155.688 | 71.901 |
| 17 | 628.396 | 312.42 | 0.497 | 19.05 | 155.688 | 60.834 |
| 18 | 360.934 | 212.09 | 0.588 | 50.80 | 155.688 | 191.735 |
| 19 | 628.396 | 312.42 | 0.497 | 50.80 | 155.688 | 162.224 |
| 20 | 360.934 | 212.09 | 0.588 | 57.15 | 155.688 | 215.702 |
| 21 | 360.934 | 212.09 | 0.588 | 63.50 | 155.688 | 239.669 |
| 22 | 103.124 | 60.60 | 0.588 | 5.00 | 44.482 | 66.050 |
| 23 | 103.124 | 60.60 | 0.588 | 15.00 | 44.482 | 198.151 |
| 24 | 902.335 | 530.23 | 0.588 | 50.80 | 389.220 | 76.694 |
| 25 | 902.335 | 530.23 | 0.588 | 127.00 | 389.220 | 191.735 |
| 26 | 1191.082 | 699.90 | 0.588 | 63.50 | 513.770 | 72.627 |
| 27 | 1191.082 | 699.90 | 0.588 | 170.00 | 513.770 | 194.434 |

The fan bearing designs provide the aforementioned benefits including achieving a lower radius ratio (ratio of hub to fan tip radii) for a rated thrust, or a percentage thereof at takeoff. During the course of creating those designs it was determined what ranges would be suitable to achieve the desired results, while taking into account fan shaft stresses, packaging and accessibility, reliability and lubrication requirements for the engine. The values for terms used to compute an FBE value are strictly limited to certain ranges based on the various designs evaluated where those values had varied. Otherwise, the engine made will not produce the favorable results.

The FBE is only valid for a fan hub trailing edge radius R_{FH} T_{E} in a range from ninety millimeters (90 mm) to one thousand two hundred millimeters (1,200 mm). In some embodiments, the fan hub trailing edge radius R_{FH} T_{E} is in a range from one hundred millimeters (100 mm) to nine hundred millimeters (900 mm). The ranges of the fan hub trailing edge radius R_{FHTE} provide for a fan hub radius ratio that satisfies the operational requirements and the packaging requirements of a particular engine without overly increasing the fan bearing heat load. Values of the fan hub trailing edge radius R_{FH} T_{E} outside of the ranges disclosed herein either have a fan hub radius ratio that is too small such that the fan bearings cannot be packaged under the fan disk or too great such that the aerodynamic efficiency of the fan is reduced.

The FBE is only valid for a fan bearing radius R_{FBRG} in a range from fifty millimeters (50 mm) to seven hundred millimeters (700 mm). In some embodiments, the fan bearing radius R_{FBRG} is in a range from sixty millimeters (60 mm) to five hundred fifty millimeters (550 mm). The ranges of the fan bearing radius R_{FBRG} provide for a lower fan hub radius ratio that satisfies the operational requirements and the packaging requirements of a particular engine without overly increasing the fan bearing heat load. Values of the fan bearing radius R_{FBRG} outside of the ranges disclosed herein either have a fan hub radius ratio that is too small such that the fan bearings cannot be packaged under the fan disk or too great such that the aerodynamic efficiency of the fan is reduced and the heat load on the fan bearings is increased so much that the fan bearings require a great amount of lubricant to cool the fan bearings. Thus, fan bearings having a fan bearing radius R_{FBRG} greater than seven hundred millimeters (700 mm) also result in a greater sized lubrication system, and, thus, results in a heavier turbofan engine.

The FBE is only valid for a radius ratio of the fan bearing radius to the fan hub trailing edge radius (R_{FBRG}/R_{FHTE}) in a range from 0.4 to 1.0. The range of R_{FBRG}/R_{FHTE} provides satisfies the operational requirements and the packaging requirements of a particular engine without overly increasing the fan bearing heat load. Values of the R_{FBRG}/R_{FHTE} outside of the ranges disclosed herein either have a fan hub radius ratio that is too small such that the fan bearings cannot be packaged under the fan disk or too great such that the aerodynamic efficiency of the fan is reduced. In particular, values of R_{FBRG}/R_{FHT}E greater than 1.0 provide for the fan bearings to be radially outward of the fan hub trailing edge, and, thus, reduce the radius of the core engine inlet. Values of R_{FBRG}/R_{FHTE} less than 0.4 provide for fan bearings that require larger rolling elements to account for the stresses, while also increasing the fan hub radius and the inner radius of the flow path.

The FBE is only valid for a rolling element diameter D_{FB} in a range from three millimeters (3 mm) to one hundred fifty millimeters (150 mm). In some embodiments, the rolling element diameter D_{FB} is in a range from five millimeters (5 mm) to one hundred twenty-seven millimeters (127 mm).

The FBE is only valid for a takeoff thrust Thrust_{TO} in a range from forty kilo-Newtons (40 kN) to five hundred twenty-five kilo-Newtons (525 kN). In some embodiments, the takeoff thrust Thrust_{TO} is in a range from forty-four kilo-Newtons (44 kN) to four hundred fifty kilo-Newtons (450 kN).

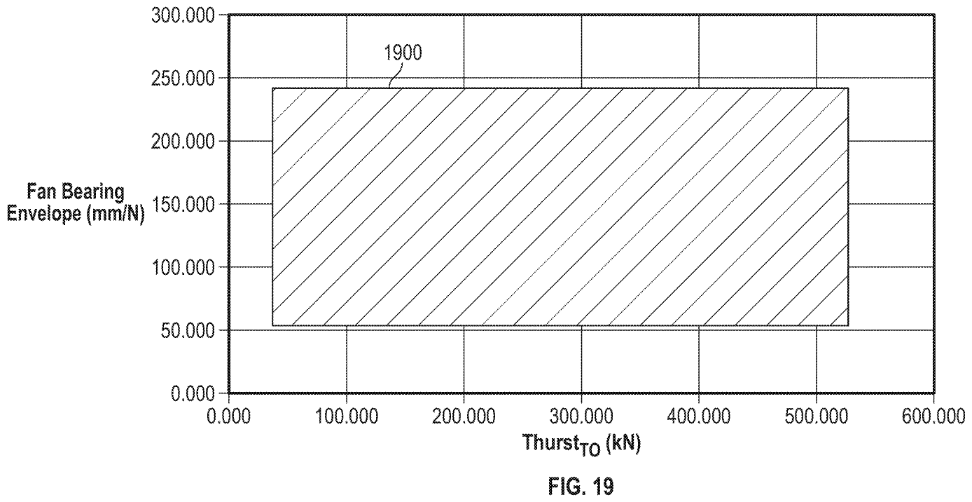

FIG. 19 represents, in graph form, the FBE as a function of the Thrust_{TO} of the turbofan engine, according to the present disclosure. An area 1900 represents the boundaries of the FBE. The FBE is in a range from fifty-four millimeters per Newton (54 mm/N) to two hundred forty millimeters per Newton (240 mm/N) for a takeoff thrust Thrust_{TO} in a range from forty kilo-Newtons (40 kN) to five hundred twenty-five kilo-Newtons (525 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 1900, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 1900, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 1900 provides for an improved fan bearing architecture that is capable of handling the stresses from the fan shaft, while accounting for the fan hub radius to improve propulsive efficiency and specific flow for achieving a certain thrust.

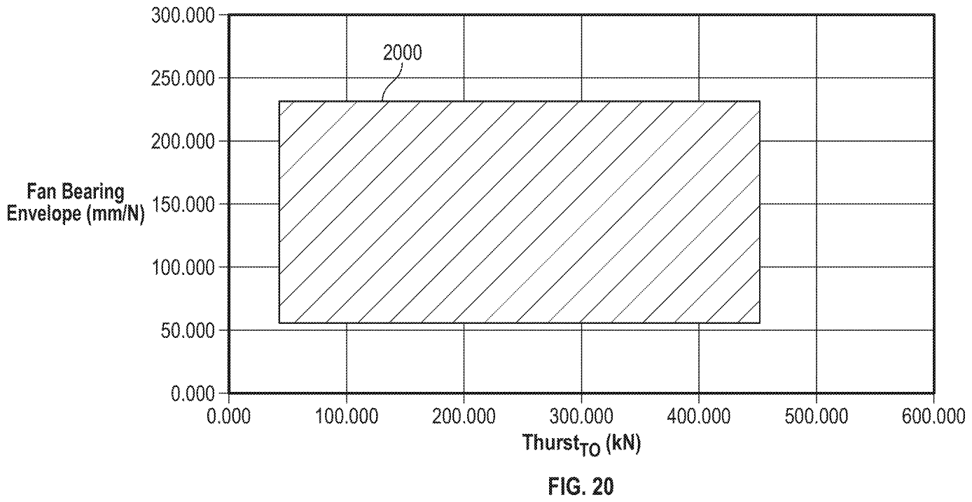

FIG. 20 represents, in graph form, the FBE as a function of the Thrust_{TO}, according to another aspect. An area 2000 represents the boundaries of the FBE. The FBE is in a range from fifty-eight millimeters per Newton (58 mm/N) to two hundred thirty millimeters per Newton (230 mm/N) for a takeoff thrust Thrust_{TO} in a range from forty-four kilo-Newtons (44 kN) to four hundred fifty kilo-Newtons (450 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 2000, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 2000, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 2000 provides for an improved fan bearing architecture that is capable of handling the stresses from the fan shaft, while accounting for the fan hub radius to improve propulsive efficiency and specific flow for achieving a certain thrust.

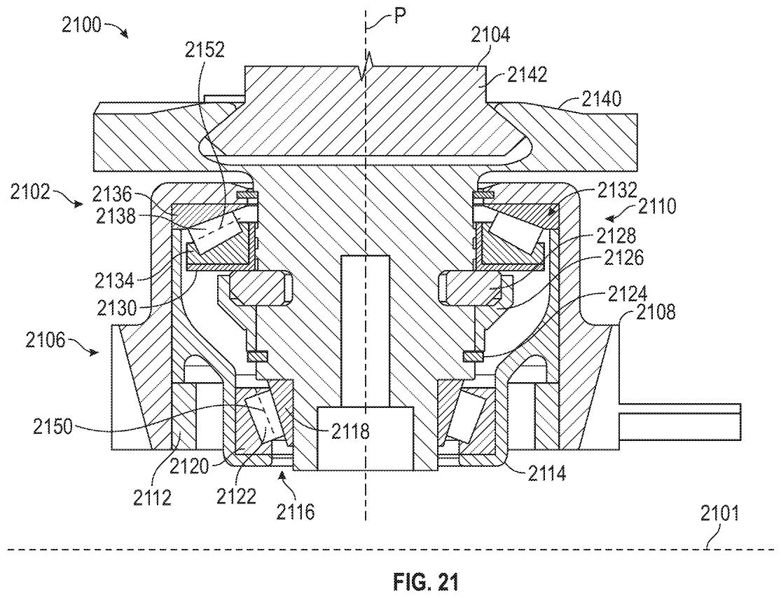

FIG. 21 is an enlarged schematic, cross-sectional view of a segment of a fan 2100 having a fan actuation system 2102, taken along a longitudinal centerline axis 2101 of the fan 2100, according to the present disclosure. The fan 2100 can be utilized as the fan 138 of FIG. 1 or as the fan 252 of FIG. 2. The fan 2100 includes a plurality of fan blades 2104 that is coupled to a disk 2106 and is spaced circumferentially about the longitudinal centerline axis 2101 of the fan 2100.

The disk 2106 includes a plurality of disk segments 2108 (only one shown in FIG. 21) that is rigidly coupled together or integrally molded together in a generally annular shape. One fan blade 2104 is coupled to each disk segment 2108 at a trunnion mechanism 2110 of the fan actuation system 2102. The trunnion mechanism 2110 facilitates retaining the respective fan blade 2104 on the disk 2106 during rotation of the disk 2106, while still rendering the respective fan blade 2104 rotatable relative to the disk 2106 about a pitch axis P of the fan blade 104. The trunnion mechanism 2110 includes a plurality of bearings disposed within the disk segment 2108 that allows the fan blade 2104 to rotate about the pitch axis P, as detailed above and below.

The trunnion mechanism 2110 extends through a respective disk segment 2108 and includes a coupling nut 2112, a lower bearing support 2114, a first radial thrust bearing 2116 (having, for example, an inner race 2118, an outer race 2120, and a plurality of rolling elements 2122), a snap ring 2124, a key hoop retainer 2126, a segmented key 2128, a bearing support 2130, a second radial thrust bearing 2132 (having, for example, an inner race 2134, an outer race 2136, and a plurality of rolling elements 2138), a trunnion 2140, and a base 2142 (e.g., a dovetail). The first radial thrust bearing 2116 and the second radial thrust bearing 2132 can include any type of roller bearings, including, for example, cylindrical roller radial thrust bearings, tapered roller radial thrust bearings, spherical roller radial thrust bearings (e.g., ball bearings), needle roller radial thrust bearings, or tapered roller needle radial thrust bearings. The coupling nut 2112 is threadedly engaged with the disk segment 2108 so as to sandwich the remaining components of the trunnion mechanism 2110 between the coupling nut 2112 and the disk segment 2108, thus, retaining the trunnion mechanism 2110 attached to the disk segment 2108.

The first radial thrust bearing 2116 is oriented at a different angle than the second radial thrust bearing 2132 (as measured from a rolling element longitudinal centerline axis 2150 of the plurality of rolling elements 2122 relative to the pitch axis P, and from a rolling element longitudinal centerline axis 2152 of the plurality of rolling elements 2138 relative to the pitch axis P). More specifically, the first radial thrust bearing 2116 and the second radial thrust bearing 2132 are preloaded against one another in a face-to-face (or duplex) arrangement, in which the rolling element longitudinal centerline axes 2150, 2152 are oriented substantially perpendicular to one another, as opposed to being arranged in tandem so as to be oriented substantially parallel to one another.

The centrifugal loads experienced closer to the pitch axis P are larger than the centrifugal loads experienced further away from the pitch axis P. As such, to facilitate making the trunnion mechanism 2110 more compact, the bearings of the trunnion mechanism 2110 are positioned closer to the pitch axis P. Such a configuration enables a greater number of trunnion mechanisms 2110 to be assembled on the disk 2106 and, thus, more fan blades 2104 to be coupled to the disk 2106 for a given diameter of the disk 2106. The trunnion mechanism 2110 herein is made more compact due to the first radial thrust bearing 2116 and the second radial thrust bearing 2132 being line contact bearings as compared to trunnion mechanisms that utilize angular point contact ball bearings. In this way, the trunnion mechanism 2110 is made more compact while being better able to withstand larger centrifugal loads associated with such a bearing placement without fracturing or plastically deforming. In particular, the first radial thrust bearing 2116 and the second radial thrust bearing 2132 being line contact bearings provide for larger contact surfaces, and, thus, can withstand larger centrifugal loads as compared to angular point contact ball bearings. Thus, line contact bearings (e.g., the first radial thrust bearing 2116 and the second radial thrust bearing 2132) can be spaced closer to the pitch axis P than angular point contact ball bearings.

In one aspect, the first radial thrust bearing 2116 and the second radial thrust bearing 2132 are a tapered roller bearings in which the rolling elements 2122 and the rolling elements 2138 are tapered. In one example, the first radial thrust bearing 2116 is fabricated from a steel material and has twenty rolling elements 2122 arranged at a 20° contact angle and a 3.6 inch pitch diameter, with each rolling element 2122 being 0.6 inches long and having a 0.525 inch minor diameter, a 0.585 inch major diameter, and a 6° taper angle. In the same example, the second radial thrust bearing 2132 is fabricated from a steel material and has 36 rolling elements 2138 arranged at a 65° contact angle and a 6 inch pitch diameter, with each rolling element 2138 being 0.8 inches long and having a 0.45 inch minor diameter, a 0.6 inch major diameter, and a 9° taper angle. In other aspects, the first radial thrust bearing 2116 and the second radial thrust bearing 2132 can be configured in any suitable manner that facilitates enabling the first radial thrust bearing 2116 and the second radial thrust bearing 2132 to function as described herein.

The first radial thrust bearing 2116 and the second radial thrust bearing 2132 facilitate providing a turbofan engine with a smaller variable pitch fan that can generate larger amounts of thrust. Particularly, the first radial thrust bearing 2116 and the second radial thrust bearing 2132 facilitate providing a turbofan engine with a variable pitch fan having a higher blade count and a lower blade length, while also providing the turbofan engine with a lower fan hub radius ratio. The first radial thrust bearing 2116 and the second radial thrust bearing 2132 further facilitate providing a trunnion mechanism that is more compact and is better able to withstand the higher centrifugal loads associated with higher blade counts, given that higher blade counts tend to yield a higher tip velocity and, therefore, a higher centrifugal loading. The first radial thrust bearing 2116 and the second radial thrust bearing 2132 further facilitate providing a smaller diameter disk for a variable pitch fan by providing the variable pitch fan with a fan counterweight device for the fan blades.

As discussed above, variable pitch fan blades enable a pitch (e.g., angle) of the blades relative to the incoming airflow to be changed during operation of the engine. For example, passive systems such as the fan actuation systems 500 of FIG. 5 can cause the fan blades 140 to move to the feather position via the pressurized pneumatic chamber 570. Also, fan actuation systems 700, 800, 900, 1000 of FIGS. 7-10 can bias the fan blades 140 via the counterweights 792, 892, 992, 1092. The example fan actuation systems of FIGS. 5-10 provide for pitch control in the event of failure of the hydraulic system or shutdown of the turbofan engine. Further, as discussed above, the disclosed fan actuation systems of FIGS. 5-10 provide force to adjust pitch of the fan blades while reducing size and weight of the fan actuation systems in view of packaging space in turbofan engines.

Also disclosed herein are example active pitch control protection systems including a protection valve controller (e.g., programmable circuitry) configured to cause adjustments to blade pitch when, for example, blade fan speed is too high, while also addressing the packaging considerations with respect to turbofan engines. The disclosed active pitch control protection systems can be implemented with compact packaging as compared to known pitch control protect systems. The disclosed active pitch control protection systems complement the size considerations of the disclosed fan actuation systems of, for example FIGS. 5-10 that provide for passive blade pitch control via pressurized pneumatic chambers and/or counterweights in the event of failure of hydraulic fluid systems and/or shutdown of the turbofan engine. Thus, examples disclosed herein provide for active and passive pitch protection control systems that address space considerations within turbofan engines.

Traditional active pitch control protection systems include a complex system of multiple valves (e.g., 9 valves) to implement pitch control protection. However, such systems increase cost, space, weight, and the risk of failure. Examples disclosed herein provide active pitch control protection with fewer valves (e.g., 3 valves). Accordingly, examples disclosed herein result in a cheaper, smaller, lighter, less complex, and more reliable active pitch control protection system than previous techniques. Example active pitch control systems disclosed herein include a pressure relief valve, a primary control valve, and a protection valve. The pressure relief valve releases pressure from a pump. The primary control valve is in communication with a primary controller and the protection valve is in communication with the protection valve controller. The primary control valve controls the pitch of the blades by directing hydraulic fluid from a hydraulic pump into a first or second chamber of a piston assembly via a hydraulic actuator based on user and/or system instructions received via the primary controller. The protection valve is structured to allow the primary valve to pump hydraulic fluid into the first or second chamber of the piston assembly. However, in some situations (e.g., loss of power, error in the main controller, fan speed too high, blade pitch not matching instructions, etc.), the protection valve controller supplements the pitch control by instructing the protection valve to override the primary control valve (e.g., block the fluid output by the primary control valve). For example, the protection valve controller can instruct the protection valve adjust the hydraulic fluid flow to halt pitch changes to the pitch of the blade or adjust the pitch of the blade to provide, for example, auto-feathering for overspeed protection with respect to blade speed.

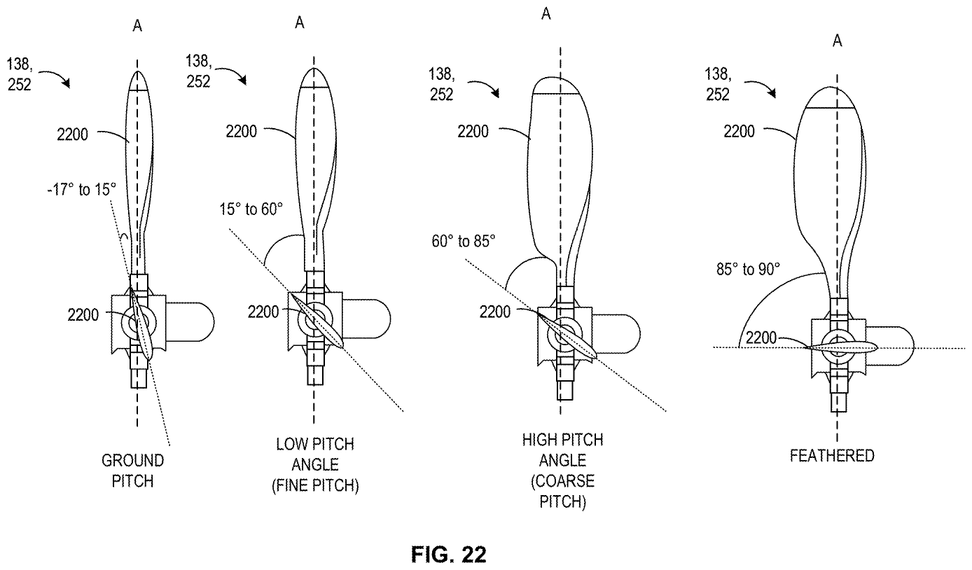

The active pitch control systems disclosed herein (e.g., FIGS. 22-48) can serve as primary pitch control systems that generate instructions to control the valve positions and hydraulic flow therethrough to adjust blade pitch. Thus, when an active pitch control system is in a first control system state, which corresponds to expected or normal engine operation, the active pitch control system controls angles of the respective fan blades about the corresponding pitch axes. For example, in the first control system state, the protection valve controller can generate instructions (e.g., control signals) to provide for overspeed protection by controlling valve states in connection with flow of the hydraulic fluid to the hydraulic actuator. The passive control systems disclosed herein (e.g., FIGS. 5-10) can serve as secondary or back-up pitch control systems. In the event of failure of the active pitch control system (e.g., due to engine failure), the active pitch control systems enter a second control system state, which can correspond to a failure state of one or more components of the active control system, power loss etc. The failure of the active pitch control system can be due to, for example, power loss at the engine that prevents controller(s) of the active pitch control system receiving instructing signals from, for example, a full authority digital engine control (FADEC) or other controller(s) associated the engine and/or prevents the active pitch control system from generating control signals to, for example, regulate the flow of hydraulic fluid through valves to control blade pitch. In response to the active pitch control system being in a second control system state (e.g., a failure state), fan blade pitch is controlled by the passive fan actuator systems of FIGS. 5-10. For example, in view of failure conditions at the engine (such that the active pitch control systems are in the second control system state), the disclosed passive control systems can cause the blades to move to a feathered position to minimize drag. For example, the pressurized pneumatic chamber 570 of the fan actuation systems 500 of FIG. 5 biases the fan blades 140 to the feather position in the absence of control signals from the active pitch control systems (e.g., from the protection valve controller) due to the active pitch control systems being in the second control system state. The counterweights (e.g., the counterweights 792, 892, 992, 1092) of the fan actuation systems of FIGS. 7-10 can cause the blades to move to the feathered position when the active pitch control systems are in the second control system state. Thus, rather than adding controller-based architectures as additional layers to the active pitch control system to address failure conditions or states, which may be ineffective in certain failure states, examples disclosed herein implement less complex passive systems to address failure of the active pitch control systems by causing the blades to feather to reduce drag.

FIG. 22 includes side views of blades 2200 (e.g., the blade 140 of the fan 138 of the turbofan engine 110 of FIG. 1, the blade 254 of the fan 252 of the turbofan engine 210 of FIG. 2) in four different pitch angles and/or positions (e.g., a ground pitch, fine pitch, coarse pitch, and feathered). In the example of FIG. 22, a ground angle of the blades 2200, also referred to as ground pitch, is an angle that is less than a first threshold angle (e.g., less than 15 degrees) to the plane of rotation (e.g., corresponding to line A). In some examples, the ground angle is a negative angle (e.g., a reverse position). A low pitch angle of the blades 2200, also referred to as fine pitch, is an angle that is less than a second threshold (e.g., between 15 and 60 degrees) to the plane of rotation (e.g., corresponding to line A). The pitch with the low pitch angle corresponds to a first amount of drag (e.g., high drag). A high pitch angle of the blades 220, also referred to as coarse pitch, is an angle that is greater than the second threshold but less than a third threshold (e.g., between 60 and 85 degrees) to the plane of rotation. The pitch with the high pitch angle corresponds to a second amount of drag (e.g., medium drag). The feathered angle of the blades 2200, also referred to as feathered pitch, is an angle that is above a threshold (e.g., 85-90 degrees to the plane of rotation). The pitch with the feathered angle corresponds to a third amount of drag (e.g., low drag). As described herein, a pitch control protection system can, based on a trigger, adjust the pitch to any angle. The amount of pitch control and/or speed of pitch control may be based on user/manufacturer preference and/or based on characteristics of the flight and/or turbofan engine 110. FIG. 22 illustrates example angles for different pitches corresponding to the blades 2200 of turbofan engine 110, 210. However, the angles may be different for different turbo engines. Additionally, the angles may be different for blades with different radius size.

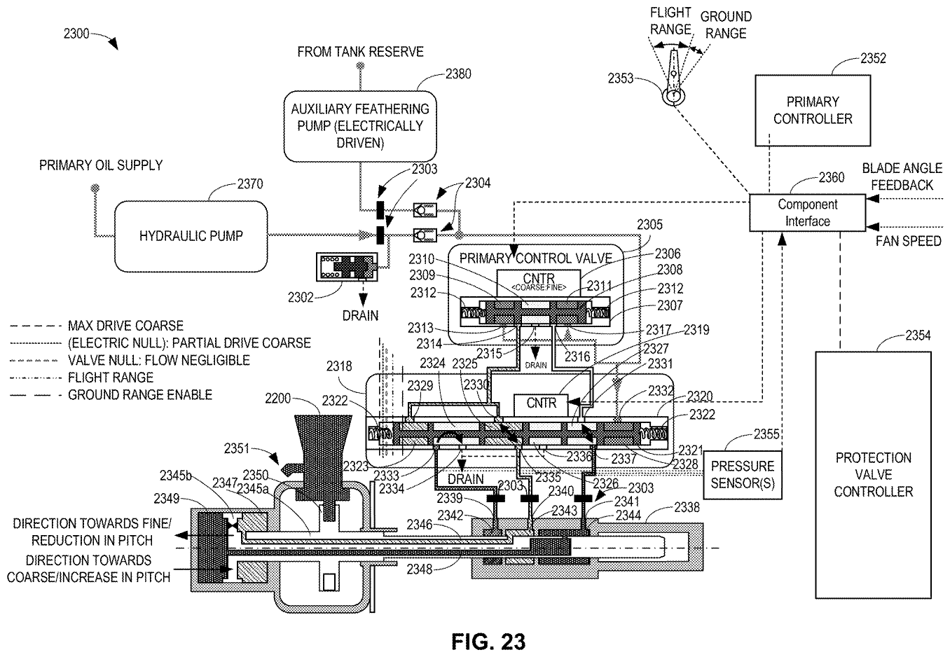

FIG. 23 illustrates an example implementation of a first pitch control protection system 2300. The pitch control protection system 2300 includes a hydraulic pump 2370, an auxiliary hydraulic pump 2380, a pressure relief valve 2302, strainers 2303, no return valves 2304, and a primary control valve assembly 2305 (also referred to as a servo valve or an electro hydraulic servo valve (EHSV)). The primary control valve assembly 2305 includes a valve spool position controller 2306; a primary sleeve 2307; a valve spool 2308; passages 2309, 2310, 2311 (also referred to a first passage 2309, a second passage 2310, and a third passage 2311); springs 2312; inputs 2313, 2317 (also referred to as a first input 2313 and a second input 2317); and outputs 2314, 2315, 2316 (also referred to as a first output 2314, a second output 2315, and a third output 2316). The pitch control protection system 2300 further includes a protection valve assembly 2318 (also referred to as a servo valve or an electrohydraulic servo valve (EHSV)). The protection valve assembly 2318 includes a valve spool position controller 2319; a sleeve 2320; a valve spool 2321; springs 2322; passages 2323, 2324, 2325, 2326, 2327, 2328 (also referred to as a first passage 2323, a second passage 2324, a third passage 2325, a fourth passage 2326, a fifth passage 2327, and a sixth passage 2328); ports (e.g., inputs and/or outputs) 2329, 2330, 2331, 2333, 2335, 2337 (also referred to as a first port 2329, a second port 2330, a third port 2331, a fourth port 2333, a fifth port 2335, and a sixth port 2337); an input 2332; and outputs 2334, 2336 (also referred to as a first output 2334 and a second output 2336). The pitch control protection system 2300 further includes a hydraulic fluid transfer unit 2338. The hydraulic fluid transfer unit 2338 is a dual acting hydraulic pitch actuator. The hydraulic fluid transfer unit 2338 includes ports (e.g., inputs and/or outputs) 2339, 2340, 2341 (also referred to as a first port 2339, a second port 2340, and a third port 2341); galleries 2342, 2343, 2344 (also referred to as a first gallery 2342, a second gallery 2343, and a third gallery 2344); an example beta tube 2345a, which includes a piston 2345b and connections 2346, 2348 (also referred to as a fine pitch chamber connection 2346 and a coarse pitch chamber connection 2348); chambers 2347, 2349 of the pitch change actuator either side of the piston 2345b (also referred to as a fine pitch chamber 2347 and a coarse pitch chamber 2349); a crosshead 2350; a counterweight 2351; a primary controller 2352; a protection valve controller 2354; and one or more pressure sensors 2355. As used herein, inputs may be referred to as ports, inputs, inlets, input connections, inlet connection, input terminals, inlet terminals, etc. As used herein, outputs may be referred to as ports, outputs, outlets, output connections, outlet connection, output terminals, outlet terminals, etc. Components that are connected via a solid line are connected via a connection, a tube, a hose, a pipe, and/or other device that can transport hydraulic fluid. Components that are connected via a dashed line are connected via an electrical connection (e.g., a wired connection, such as a wire, an etch, etc. or a wireless connection). In FIG. 23, the valves 2302, 2305, 2318 and the hydraulic fluid transfer unit 2338 are illustrated as cross sections of the respective components. 2200 The example pitch control protection system 2300 of FIG. 23 can be implemented with the blade 140 of the turbofan engine 110 of FIG. 1, the blade 254 of the turbofan engine 210 of FIG. 2, or with other types of turbo engine assemblies, hybrid engine assemblies, electric propulsion assemblies, etc. As used herein, a hybrid assembly is an assembly with a fan driven by an electric motor in a conventional gas turbine engine.

The hydraulic pump 2370 of FIG. 23 is a conveyer of hydraulic power that pumps a hydraulic fluid. The hydraulic pump 2370 acts as a pressure vessel to cause hydraulic fluid to flow (e.g., to be pumped) into the primary control valve assembly 2305 and/or the protection valve assembly 2318. The hydraulic fluid may be an oil-based fluid, a silicone-based fluid, a synthetic hydrocarbon-based fluid, and/or other type of hydraulic fluid.

The auxiliary hydraulic pump 2380 of FIG. 23 is a conveyer of hydraulic power that pumps a hydraulic fluid when the hydraulic fluid from the hydraulic pump 2370 is insufficient (e.g., due to a loss of primary oil supply). One or both of the hydraulic pumps 2370, 2380 cause(s) hydraulic fluid to flow (e.g., to be pumped) into the primary control valve assembly 2305 and/or the protection valve assembly 2318. The hydraulic fluid may be an oil-based fluid, a silicone-based fluid, a synthetic hydrocarbon-based fluid, and/or another type of hydraulic fluid.

The pressure relief valve 2302 of FIG. 23 keeps the pressure of the hydraulic fluid from the hydraulic pump 2370 below a threshold level (e.g., 1100 pounds per square inch (psi), etc.) by draining some of the hydraulic fluid toward a drain when the hydraulic fluid is above the threshold level. The pressure relief valve 2302 reduces the pressure of the hydraulic fluid to prevent pressure-induced damage when causing the fluid to flow into other components of the pitch control protection system 2300. In some examples, the pressure relief valve 2302 is implemented within the hydraulic pump 2370.

The strainers 2303 of FIG. 23 strain the hydraulic fluid to block contaminants in the hydraulic fluid that may damage or jam the valves 2304, 2305, 2318. Although FIG. 23 has five strainers 2303, there may be any number of strainers. The no return valves (NRVs) 2304 are valves that prevent hydraulic fluid from returning back to the hydraulic pumps 2370, 2380.

The primary control valve assembly 2305 of FIG. 23 allows or prevents hydraulic fluid from the hydraulic pumps 2370, 2380 into the coarse pitch chamber 2349 and the fine pitch chamber 2347 via one or more of the connections 2346, 2348 of the beta tube 2345a based on a position of the valve spool 2308. The primary control valve assembly 2305 includes the valve spool position controller 2306. The valve spool position controller 2306 obtains an electrical signal (e.g., a current) from the primary controller 2352. The valve spool position controller 2306 moves the valve spool 2308 based on the electrical signal (e.g., based on the amount of current). For example, the valve spool position controller 2306 moves the valve spool 2308 to a first position based on obtaining a first current and moves the valve spool 2308 to a second position based on a second current. In some examples, the valve spool position controller 2306 may be a direct drive valve (also referred to as a proportional valve). In such examples, the valve spool 2308 is moved by an electric means (e.g., a linear motor, a stepper type motor, etc. through a gear drive with electronic feedback). As further described below, the primary controller 2352 generates the signal based on instructions from a pilot and/or based on instructions from one or more of a full authority digital engine control (FADEC), a separate controller (e.g., a fan electronic controller), a separate control box, etc.

The primary sleeve 2307 of FIG. 23 is a cylindrical valve that includes the valve spool 2308. The valve spool 2308 is a cylindrical valve spool that fits within the primary sleeve 2307 and includes solid portions and open portions (also referred to as open areas). The open portions of the valve spool 2308 make up the passages 2309, 2310, 2311. The passages 2309, 2310, 2311 are separated so that any hydraulic fluid in one passage cannot directly flow into another passage within the primary sleeve 2307. The valve spool 2308 can move within a cavity of the primary sleeve 2307 between the springs 2312. In some positions (e.g., locations), one or more solid portions of the valve spool 2308 can block or plug one or more of the inputs 2313, 2317 or outputs 2314, 2315, 2316. In other positions, one or more of the solid portions of the valve spool 2308 do not block or plug one or more of the inputs 2313, 2317 or outputs 2314, 2315, 2316, allowing the hydraulic fluid to flow into and/or out of one or more of the passages 2309, 2310, 2311.

The first input 2313 of the primary sleeve 2307 is connected to the hydraulic pumps 2370, 2380 (e.g., via the strainers 2303 and the NRVs 2304), the second input 2317, and the input 2332 of the sleeve 2320 of the protection valve assembly 2318. The first output 2314 is connected to the first port 2329 and the second port 2330 of the sleeve 2320. The second output 2315 is connected to a drain. The third output 2316 is connected to the third port 2331 of the sleeve 2320. The second input 2317 is connected to the hydraulic pumps 2370, 2380 (e.g., via the strainers 2303 and the NRVs 2304), the first input 2313, and the input 2332 of the sleeve 2320.

When the valve spool 2308 is in the position of FIG. 23, the first and third outputs 2314, 2316 are blocked by the valve spool 2308. Accordingly, the primary sleeve 2307 does not output hydraulic fluid to either the fine pitch chamber 2347 or the coarse pitch chamber 2349.

When the valve spool 2308 is moved forward in the orientation of FIG. 23, the first output 2314 of the primary sleeve 2307 opens into the second passage 2310 and the second passage 2310 opens to a drain via the second output 2315 of the primary sleeve 2307. Thus, no hydraulic fluid is pumped from the first output 2314 to the sleeve 2320. As described above, the term “forward” refers to a direction along the centerline axis 108 in the direction of movement of the turbo engine assembly 100, such as to the left in FIG. 23, while the term “rearward” refers to a direction along the centerline axis 108 in the opposite direction, such as to the right in FIG. 23. Additionally, when the valve spool 2308 is moved forward in the orientation of FIG. 23, the second input 2317 of the primary sleeve 2307 opens into the third passage 2311 and the third passage 2311 opens into the third port 2331 of the sleeve 2320 via the third output 2316 of the sleeve 2320. Thus, the hydraulic fluid from the hydraulic pump(s) 2370, 2380 is pumped into the third port 2331 of the sleeve 2320 via the second input 2317 of the primary sleeve 2307 and the third passage 2311.

When the valve spool 2308 is moved rearward in the orientation of FIG. 23, the third output 2316 of the primary sleeve 2307 opens into the second passage 2310 and the second passage 2310 opens to a drain via the third output 2316 of the primary sleeve 2307. Thus, no hydraulic fluid is pumped from the third output 2316 to the sleeve 2320. Additionally, when the valve spool 2308 is moved rearward in the orientation of FIG. 23, the first input 2313 of the primary sleeve 2307 opens into the first passage 2309 and the first passage 2309 opens into the first and second ports 2329, 2330 of the sleeve 2320 via the first output 2314 of the primary sleeve 2307. Thus, the hydraulic fluid from the hydraulic pump(s) 2370, 2380 is pumped into the first and second ports 2329, 2330 of the sleeve 2320 via the first passage 2309.

The springs 2312 of FIG. 23 are structured to position the valve spool 2308 in a particular position when the valve spool position controller 2306 does not obtain a signal. In this manner, when there is a loss of signal or power, the springs 2312 cause the valve spool 2308 to move to a pre-selected position. In the example of FIG. 23, the springs 2312 are structured to move the valve spool 2308 to the position illustrated in FIG. 23, where the valve spool 2308 plugs the first and third outputs 2314, 2316. In some examples, one or more of the springs 2312 may be removed. For example, the spring on the left (with regards to the orientation of FIG. 23) of the sleeve 2320 may be removed. Removing the spring 2312 on the left provides greater chip-shearing capability in the desired direction. If there is no oil pressure in the first stage of the valve assembly 2318, the spring 2312 on the right (with regards to the orientation of FIG. 23) of the sleeve 2320 ensures the spool 2321 moves to connect fine pitch oil connected to drain, thereby allowing the counterweights 2351 to drive the blade 2200 coarse, as a failsafe.

The protection valve assembly 2318 of FIG. 23 allows or prevents hydraulic fluid from the primary sleeve 2307 and/or the hydraulic pumps 2370, 2380 into the coarse pitch chamber 2349 and the fine pitch chamber 2347 of the beta tube 2345a based on a position of the valve spool 2321. The primary control valve assembly 2305 includes the valve spool position controller 2319 to obtain an electrical signal (e.g., a current) from the protection valve controller 2354 via component interface 2360. The valve spool position controller 2319 moves the valve spool 2321 based on the electrical signal (e.g., based on the amount of current). For example, the valve spool position controller 2319 moves the valve spool 2321 to a first position based on obtaining a first current, moves the valve spool 2321 to a second position based on a second current, etc. In some examples, the valve spool position controller 2319 may be a direct drive valve (also referred to as a proportional valve). In such examples, the valve spool 2321 is moved by an electric means (e.g., a linear motor, a stepper type motor, etc. through a gear drive with electronic feedback). As further described below, the protection valve controller 2354 generates the signal based on various data (e.g., fan speed, pressure sensor data, blade angle feedback, information from the primary controller 2352, etc.).

The valve spool 2321 of FIG. 23 is a cylindrical valve spool that fits within the cylindrical sleeve 2320 and includes solid portions and open portions. The open portions of the valve spool 2321 define (e.g., make up, correspond to, etc.) the passages 2323, 2324, 2325, 2326, 2327, 2328. The passages 2323, 2324, 2325, 2326, 2327, 2328 are separated so that any fluid in one passage cannot directly flow into another passage within the sleeve 2320. The valve spool 2321 can move within a cavity of the sleeve 2320 between the springs 2322. In some positions (e.g., locations), one or more solid portions of the valve spool 2321 can block or plug one or more of the ports 2329, 2330, 2331, 2333, 2335, 2337, the input 2332, or the outputs 2334, 2336. In other positions, one or more of the solid portions of the valve spool 2321 do not block or plug one or more of the ports 2329, 2330, 2331, 2333, 2335, 2337, the input 2332, or the outputs 2334, 2336, allowing the hydraulic fluid to flow into and/or out of one or more of the passages 2323, 2324, 2325, 2326, 2327, 2328. In some examples, one or more of the ports 2329 2330, 2331, 2335, 2337 can be bi-directional (e.g., to allow hydraulic fluid to pass through the protection valve assembly 2318 in either direction).

The first port 2329 of FIG. 23 of the sleeve 2320 is connected to the second port 2330 of the sleeve 2320 and the first output 2314 of the primary sleeve 2307. The second port 2330 of the sleeve 2320 is connected to the first port 2329 of the sleeve 2320 and the first output 2314 of the primary sleeve 2307. The third port 2331 is connected to the third output 2316 of the primary sleeve 2307. The input 2332 is connected to the hydraulic pumps 2370, 2380 (e.g., via the strainers 2303, and the NRV 2304 and the first input 2313 and the second input 2317 of the primary sleeve 2307. The fourth port 2333 is connected to the first port 2339 of the hydraulic fluid transfer unit 2338. The first output 2334 is connected to a drain. The fifth port 2335 is connected to the second port 2340 of the hydraulic fluid transfer unit 2338. The second output 2336 is connected to the drain. The sixth port 2337 is connected to the third port 2341 of the hydraulic fluid transfer unit 2338.

The valve spool position controller 2319 of FIG. 23 can move the valve spool 2321 into at least five different positions that correspond to five different actions based on a signal from the protection valve controller 2354 via the component interface 2360. For example, the valve spool 2321 can be moved to a maximum drive coarse position, a partial drive coarse position, a valve null position, a flight range position, and a ground range enabled position. The maximum drive coarse position corresponds to an automatic flow of hydraulic fluid at full pressure to the coarse pitch chamber 2349 of the valve spool assembly to cause the blade 2200 to move to a coarse and/or feathered pitch angle at a maximum rate. The partial drive coarse position corresponds to an automatic flow of hydraulic fluid at partial pressure to the coarse pitch chamber 2349 of the valve spool assembly to cause the blade 2200 to move to a coarse and/or feathered pitch angle at a rate less than maximum. The valve null position corresponds to preventing hydraulic fluid from flowing to either the coarse pitch chamber 2349 or the fine pitch chamber 2347, maintaining the pitch of the blade 2200. The flight range position corresponds to control of the pitch angle based on the hydraulic fluid output by the primary sleeve 2307. The ground range enabled position corresponds to pumping hydraulic fluid into the fine pitch chamber 2347 to cause the blade 2200 to move to a ground pitch angle. The example of FIG. 23 is described in conjunction with the flight range position. However, each position is illustrated in one of FIGS. 23-27.

In FIG. 23, the valve spool 2321 is in the flight range position. In the flight range position, the first port 2329 opens into the first passage 2323 (which does not open to an output). The second port 2330 opens to the third passage 2325 and the third passage opens to the fifth port 2335. Thus, hydraulic fluid from the second port 2330 is pumped out of the fifth port 2335. The third port 2331 opens to the fifth passage 2327 and the fifth passage 2327 opens to the sixth port 2337. Thus, hydraulic fluid from the third port 2331 is pumped out of the sixth port 2337. The input 2332 opens to the sixth passage 2328 (which does not open to an output). The second passage 2324 opens to the fourth port 2333 and the first output 2334 and the first output 2334 opens to a drain. Thus, any fluid in the second passage 2324 and/or from the fourth port 2333 is drained to the drain. The fourth passage 2326 opens to the second output 2336 and the second output 2336 opens to the drain. Thus, any fluid in the fourth passage 2326 is drained to the drain. Accordingly, in the flight range position, hydraulic fluid from either the first and/or second outputs 2314, 2316 of the primary sleeve 2307 is pumped into the hydraulic fluid transfer unit 2338.

The springs 2322 of FIG. 23 are structured to position the valve spool 2321 in the partial drive coarse position when the valve spool position controller 2319 does not obtain a signal. In this manner, when there is a loss of signal or power, the springs 2322 cause the valve spool 2321 to move to the partial drive coarse position. Because a coarse pitch angle is safer than a fine pitch angle in flight, the springs 2322 can be structured to position the valve spool 2321 into the partial drive coarse position. In some examples, one or more of the springs 2322 may be removed. For example, the spring on the left (with regards to the orientation of FIG. 23) of the sleeve 2320 may be removed. Removing the spring 2322 on the left provides greater chip-shearing capability in the desired direction. If there is no oil pressure in the first stage of the valve assembly 2318, the spring 2322 on the right (with regards to the orientation of FIG. 23) of the sleeve 2320 ensures the spool 2321 moves to connect fine pitch oil connected to drain, thereby allowing the counterweights 2351 to drive the blade 2200 coarse, as a failsafe.

Although the example of FIGS. 23-27 provide a particular structure for implementing the valve assembly 2318, there may be other ways to implement the valve assembly 2318 to perform the same and/or substantially similar functionality.

The hydraulic fluid transfer unit 2338 of FIG. 23 houses the beta tube 2345a and components structured to move the beta tube 2345a into different positions. In some examples, the hydraulic fluid transfer unit 2338 may be combined with and/or directly attached to one or more components of the pitch control protection system 2300. As further described below, as the beta tube 2345a moves, the pitch angle of the blade 2200 changes. The hydraulic fluid transfer unit 2338 includes the first port 2339, the second port 2340, and the third port 2341. The first port 2339 is connected to the fourth port 2333 of the sleeve 2320 and the first gallery 2342. The second port 2340 is connected to the fifth port 2335 of the sleeve 2320 and the second gallery 2343. The third port 2341 is connected to the sixth port 2337 of the sleeve 2320 and the third gallery 2344. The galleries 2342, 2343, 2344 may be a 360-degree open space that connects the ports 2339, 2340, 2341 to the chambers 2347, 2349 via one or more of the fine pitch chamber connection 2346 or the coarse pitch chamber connection 2348. Accordingly, the galleries 2342, 2343, 2344 convey hydraulic fluid from one location to another. For example, hydraulic fluid pumped into the first gallery 2342 can be pumped into the fine pitch chamber 2347 when the beta tube 2345a is in a position where the first gallery 2342 opens to the fine pitch chamber connection 2346 (via the first port 2329, the first passage 2323, the fourth port 2333, and the first gallery 2342 to the fine pitch chamber 2347). Additionally, hydraulic fluid pumped into the second gallery 2343 can be pumped into the fine pitch chamber 2347 when the beta tube 2345a is in a position where the second gallery 2343 opens to the fine pitch chamber connection 2346 (via the second port 2330, the third passage 2325, the fifth port 2335, and the second gallery 2343 to the fine pitch chamber 2347). Additionally, hydraulic fluid pumped into the third gallery 2344 can be pumped into the coarse pitch chamber 2349 when the beta tube 2345a is in a position where the third gallery 2344 opens to the coarse pitch chamber connection 2348. When the beta tube 2345a rotates, hydraulic fluid can still be pumped in, because regardless of the orientation of the connections 2346, 2348, the 360-degree galleries 2342, 2343, 2344 can always open up to the connections 2346, 2348.

The connections 2346, 2348 of FIG. 23 are tubes, pipes, hoses, and/or openings within the beta tube 2345a that can pump obtained hydraulic fluid from the sleeve 2320 into one or more of the fine pitch chamber 2347 and the coarse pitch chamber 2349. When hydraulic fluid is pumped into the coarse pitch chamber 2349, the beta tube 2345a moves rearward in the orientation of FIG. 23, causing the blade 2200 to move to a coarse pitch angle. When the hydraulic fluid is pumped into the fine pitch chamber 2347, the beta tube 2345a moves forward in the orientation of FIG. 23, causing the blade 2200 to move to a fine pitch angle. The coarse pitch chamber 2349 and the fine pitch chamber 2347 may include a piston bleed structure to bleed out hydraulic fluid that has been pumped into the respective chambers 2347, 2349. The beta tube 2345a includes the piston 2345b to separate the chambers 2347, 2349. When hydraulic fluid is pumped into the fine pitch chamber 2347, the piston 2345b is moved forward and hydraulic fluid in the coarse pitch chamber 2349 is pumped out of one or more of the drain outputs 2315, 2336 via the primary control valve 2305 and/or the protection valve 2318 (e.g., depending on the positions of the valve spools 2308, 2321). When hydraulic fluid is pumped into the coarse pitch chamber 2349, the piston 2345b is moved rearward and hydraulic fluid in the fine pitch chamber 2347 is pumped out of one or more of the drain outputs 2315, 2336 via the primary control valve 2305 and/or the protection valve 2318 (e.g., depending on the positions of the valve spools 2308, 2321).

The beta tube 2345a of FIG. 23 includes a crosshead 2350 that transfers the lateral movement (e.g., forward and rearward in the orientation of FIG. 23) into rotational movement to adjust the pitch of the blade 2200. The yoke arrangement of the crosshead 2350 locates the operating pin on the base of each blade 2200. The pin may be offset from the centerline of the blade 2200 such that axial movement of the pitch beta tube 2345a results in rotation of the blade 2200.

The blade 2200 of FIG. 23 includes the counterweight 2351. The counterweight 2351 causes the blade 2200 to naturally reduce pitch when a load is present on the blade 2200. The counterweight 2351 causes the blade 2200 to naturally position to a higher blade angle. As further described below, one or more of the pressure sensor(s) 2355 can measure pressure at the one or more of the port 2333, 2335, 2337 so that the protection valve controller 2354 can determine, based on the pressure measurement, when there is any friction in the blade 2200 that prevents the counterweight 2351 from naturally reducing pitch of the blade 2200 and/or determine that the counterweight 2351 has been compromised.

The primary controller 2352 of FIG. 23 is a pitch controller that outputs a control signal to the valve spool position controller 2306 via the component interface 2360 based on instructions from a pilot and/or autopilot instructions. For example, when a pilot engages the power lever 2353, the primary controller 2352 can determine a pitch angle that corresponds to the control of the power lever 2353 and adjust the pitch of the blade 2200 by sending a signal (e.g., a current) to the valve spool position controller 2306 via the component interface 2360. The primary controller 2352 can execute control algorithm(s) to determine an amount to change the pitch angle at a given time. For example, in flight, the primary controller 2352 varies pitch to maintain fan speed. Varying the pitch in flight changes the fan torque absorbed. If the fan torque is greater than the engine torque, the fan speed will be reduced. If the fan torque is less than the engine torque, the fan speed will increase. The control algorithm(s) executed by the primary controller 2352 provide for stability with respect to the fan speed. When the fan is in the ground range, the control algorithm sets the pitch as a function of the position of the power lever 2353 while the engine maintains speed. As described above, the valve spool position controller 2306 controls the position of the valve spool 2308 in the primary sleeve 2307 based on the signal, which causes hydraulic fluid to be pumped into one of the fine pitch chamber 2347 or the coarse pitch chamber 2349 to adjust the pitch of the blade 2200. The primary controller 2352 may output the desired pitch position, flight mode (e.g., grounded, take-off, landing, cruise altitude, etc.), and/or other information to the protection valve controller 2354 via the component interface 2360. In some examples, the primary controller 2352 may be in communication with and/or implemented within a FADEC.

The protection valve controller 2354 of FIG. 23 outputs control signals to the protection valve assembly 2318 via the component interface 2360 to facilitate and/or override operation of the primary sleeve 2307. For example, during default (e.g., normal) operation, the protection valve controller 2354 outputs a signal to the valve spool position controller 2319 via the component interface 2360 to cause the valve spool 2321 of the sleeve 2320 to be positioned in the flight range location. As described above, when the valve spool 2321 is in the flight range location, the position of the valve spool 2308 of the primary sleeve 2307 controls the position of the beta tube 2345a by pumping hydraulic fluid into the fine pitch chamber 2347 and/or the coarse pitch chamber 2349. The protection valve controller 2354 also monitors the fan speed, blade angle feedback, pressure information, and/or information from the primary controller 2352 to determine whether to override the control of the primary control valve assembly 2305 and/or otherwise control the pitch of the blade 2200. For example, when the fan speed is above one or more thresholds, the protection valve controller 2354 can adjust the position of the valve spool 2321 to cause the blade 2200 to adjust the tilt to decrease the pitch angle to a coarser pitch angle by pumping hydraulic fluid into the coarse pitch chamber 2349. Additionally, when blade pitch angle feedback indicates that the blade 2200 is not approaching the intended pitch angle, the protection valve controller 2354 can adjust the position of the valve spool 2321 to attempt to move the blade 2200 to the intended pitch angle. Additionally, the protection valve controller 2354 can prevent the blade 2200 from reaching a pitch angle below a threshold (e.g., a ground pitch) unless the aircraft is grounded.

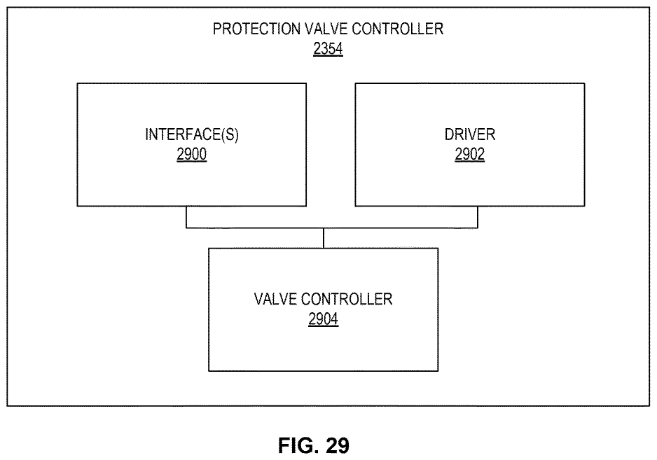

In some examples, the protection valve controller 2354 determines and/or alerts, via the component interface 2360, the pilot or another component to an issue associated with the pressure measured by the pressure sensor(s) 2355. In some examples, the pressure sensor(s) 2355 can measure a pressure at the fourth port 2333 that can be used to determine a valve failure, excess friction at the crosshead 2350, and/or an issue with the counterweight 2351. In some examples, the pressure sensor(s) 2355 can measure pressure at the fifth and sixth ports 2335, 2337. In such examples, the protection valve controller 2354 can determine a delta (e.g., difference) between the pressure at the fifth port 2335 and the pressure at the sixth port 2337. The protection valve controller 2354 can determine in flight system friction based on the delta and take appropriate action based on the flight system friction. The protection valve controller 2354 may monitor the pressure as the pitch of the blade 2200 is reduced to determine an amount of pressure needed to overcome friction. When the amount of pressure needed to overcome friction changes, the protection valve controller 2354 can flag, via the component interface 2360, the potential issue to the pilot, a mechanic, etc. For example, because the pressure at the fourth port 2333 is supposed to be zero when the aircraft is in flight, the protection valve controller 2354 can generate an alert when the pressure at the fourth port 2333 of the sleeve 2320 is not zero at any time during flight. The protection valve controller 2354 is further described below in conjunction with FIG. 29.

The component interface 2360 of FIG. 23 may include one or more interfaces to transmit and/or obtain electrical signal to/from one or more of the controllers 2306, 2319, 2352, 2354, the power lever 2353, the sensors 2355, and/or any other aircraft components have can provide or obtain an electrical signal. The component interface 2360 allows independent control functionality between the primary controller 2352 and the protection valve controller 2354. Accordingly, if a failure occurs at one of the primary controller 2352 or the protection valve controller 2354, the other controller can continue operation.

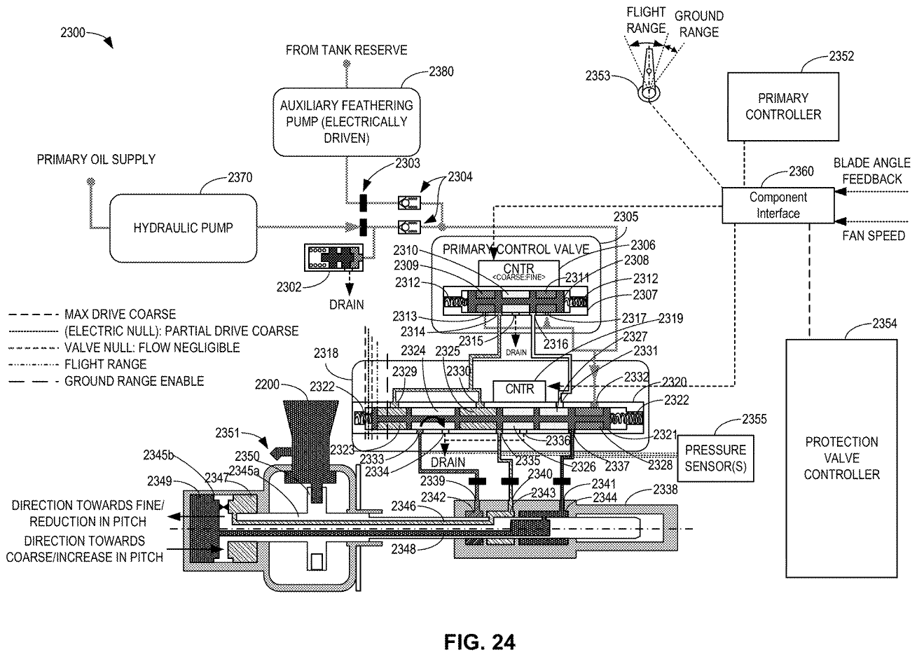

FIG. 24 illustrates an example implementation of the pitch control protection system 2300 of FIG. 23 when the valve spool 2321 of the sleeve 2320 is in a valve null position.

In the valve null position of FIG. 24, the first port 2329 opens into the first passage 2323 (which does not open to an output). The second port 2330 opens to the third passage 2325 (which does not open to an output). The third port 2331 opens to the fifth passage 2327 (which does not open to an output). The input 2332 opens to the sixth passage 2328 (which does not open to an output). The second passage 2324 opens to the fourth port 2333 and the first output 2334 and the first output 2334 opens to a drain. Thus, any fluid in the second passage 2324 and/or from the fourth port 2333 is drained to the drain. The fourth passage 2326 opens to the fifth port 2335 and the fifth port 2335 opens to the drain. Thus, any fluid in the fourth passage 2326 is drained to the drain. Additionally, in the valve null position, the fifth port 2335 and the sixth port 2337 are plugged and/or blocked by the valve spool 2321. Accordingly, no hydraulic fluid from the sleeve 2320 flows into the hydraulic fluid transfer unit 2338. For example, the sleeve 2320 blocks the fluid output of the primary sleeve 2307 from the hydraulic fluid transfer unit 2338. Thus, in the valve null position, hydraulic fluid is not used to adjust the pitch of the blade 2200 (e.g., pitch angle is maintained and/or controlled by the counterweight 2351).

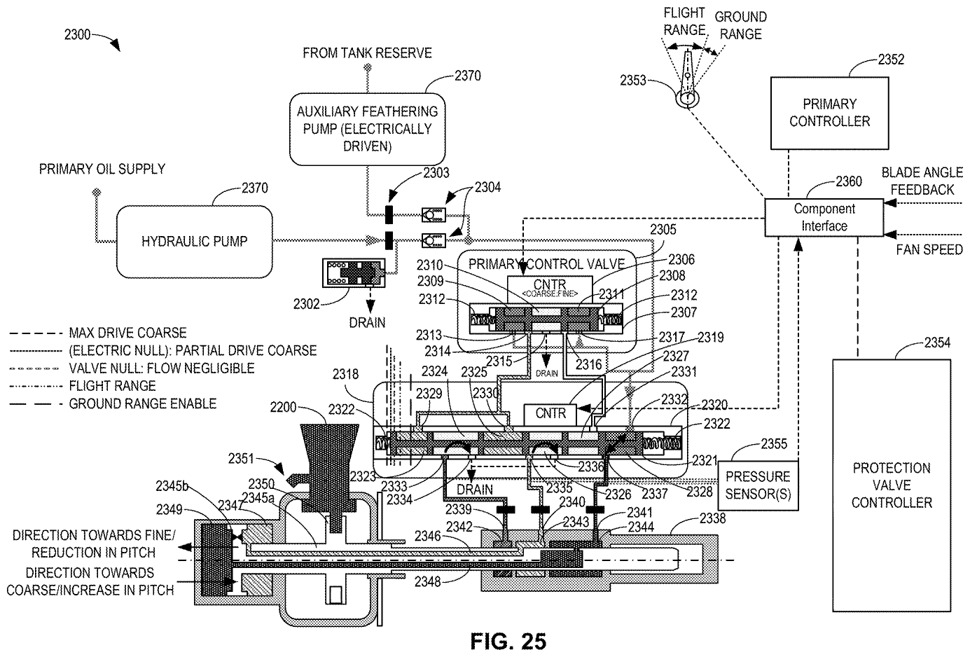

FIG. 25 illustrates an example implementation of the pitch control protection system 2300 of FIG. 23 when the valve spool 2321 of the sleeve 2320 is in a partial drive coarse position.

In the partial drive coarse position of FIG. 25, the first port 2329 opens into the first passage 2323 (which does not open to an output). The second port 2330 opens to the third passage 2325 (which does not open to an output). The third port 2331 opens to the fifth passage 2327 (which does not open to an output). The input 2332 opens to the sixth passage 2328 and the sixth passage 2328 partially opens to the sixth port 2337. For example, the valve spool 2321 partially blocks the sixth port 2337, limiting the amount of hydraulic fluid that is pumped into the hydraulic fluid transfer unit 2338. The hydraulic fluid from at least one of the hydraulic pumps 2370, 2380 is pumped into the third gallery 2344 of the hydraulic fluid transfer unit 2338 via the third port 2341 without going through the primary sleeve 2307. Accordingly, in the partial drive coarse position of FIG. 25, the protection valve assembly 2318 overrides the pitch control of the primary control valve assembly 2305 by blocking the fluid output of the primary sleeve 2307. Additionally, in the partial drive coarse position of FIG. 25, the second passage 2324 opens to the fourth port 2333 and the first output 2334 and the first output 2334 opens to a drain. Thus, any fluid in the second passage 2324 and/or from the fourth port 2333 is drained to the drain. The fourth passage 2326 partially opens to the fifth port 2335 and the fifth port 2335 opens to the drain. Thus, any fluid in the fourth passage 2326 is drained to the drain.

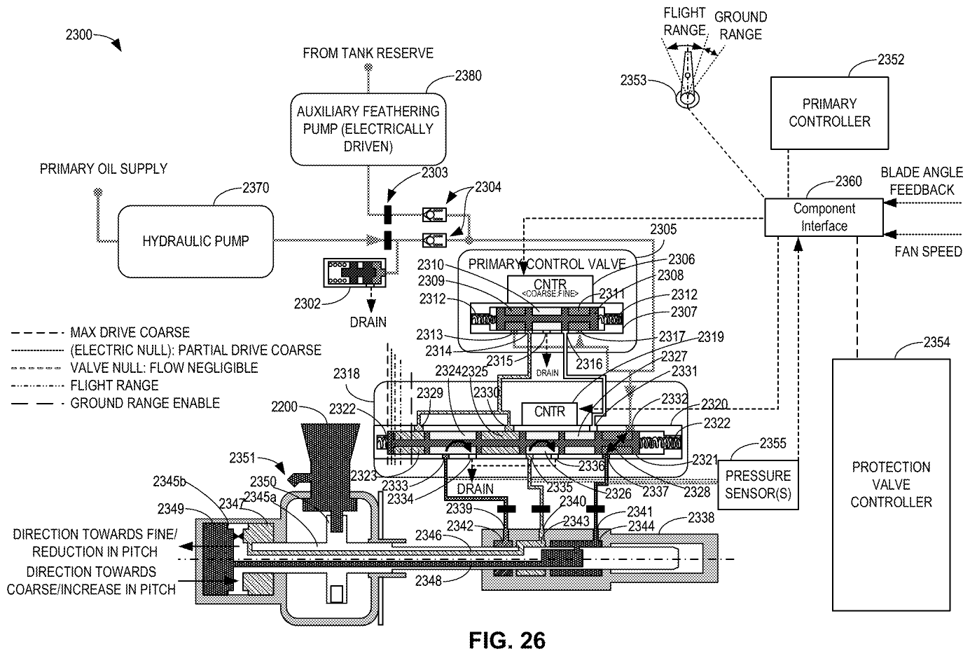

FIG. 26 illustrates an example implementation of the pitch control protection system 2300 of FIG. 23 when the valve spool 2321 of the sleeve 2320 is in a maximum drive coarse position.

In the maximum drive coarse position of FIG. 26, the first port 2329 opens into the first passage 2323 (which does not open to an output). The second port 2330 opens to the third passage 2325 (which does not open to an output). The third port 2331 opens to the fifth passage 2327 (which does not open to an output). The input 2332 opens to the sixth passage 2328 and the sixth passage 2328 fully opens to the sixth port 2337. For example, the valve spool 2321 does not block the sixth port 2337, allowing maximum hydraulic flow into the hydraulic fluid transfer unit 2338. The hydraulic fluid from at least one of the hydraulic pumps 2370, 2380 is pumped into the third gallery 2344 of the hydraulic fluid transfer unit 2338 via the third port 2341 without going through the primary sleeve 2307. Accordingly, in the maximum drive coarse position of FIG. 26, the protection valve assembly 2318 overrides the pitch control of the primary control valve assembly 2305 by blocking the fluid output of the primary sleeve 2307. Additionally, in the maximum drive coarse position of FIG. 26, the second passage 2324 opens to the fourth port 2333 and the first output 2334 and the first output 2334 opens to a drain. Thus, any fluid in the second passage 2324 and/or from the fourth port 2333 is drained to the drain. The fourth passage 2326 opens to the fifth port 2335 and the fifth port 2335 opens to the drain. Thus, any fluid in the fourth passage 2326 is drained to the drain.

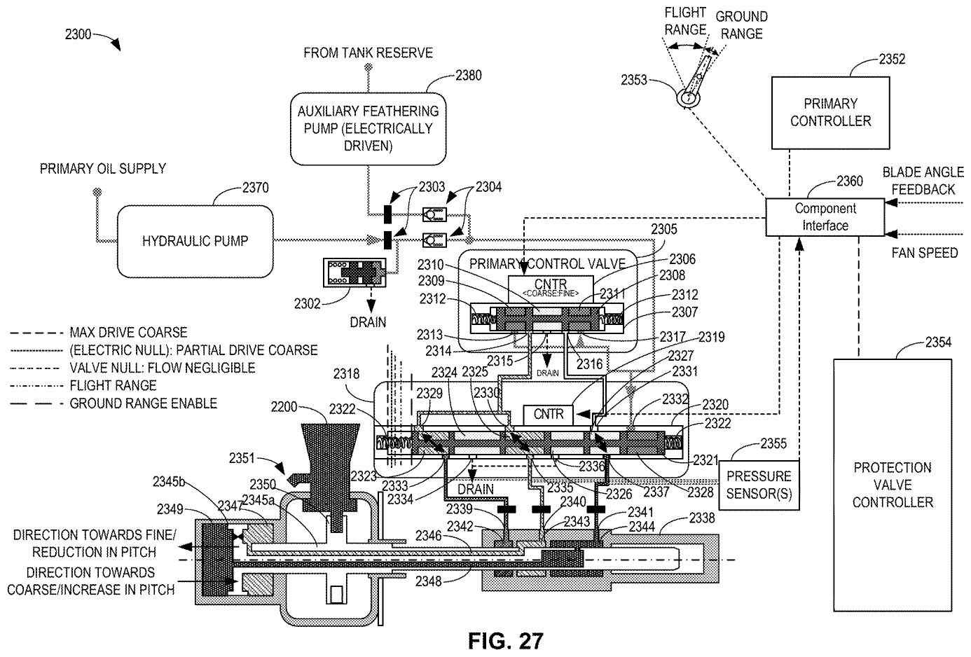

FIG. 27 illustrates an example implementation of the pitch control protection system 2300 of FIG. 23 when the valve spool 2321 of the sleeve 2320 is in a ground range enable position.

In the ground range enable position of FIG. 27, the first port 2329 opens into the first passage 2323 and the first passage 2323 opens to the fourth port 2333, thereby allowing hydraulic fluid to flow into the first gallery 2342 of the hydraulic fluid transfer unit 2338. The second port 2330 opens to the third passage 2325 and the third passage 2325 opens to the fifth port 2335. The third port 2331 opens to the fifth passage 2327 and the fifth passage 2327 opens to the sixth port 2337. The input 2332 opens to the sixth passage 2328 which does not open to any output. The second passage 2324 and the third passage 2325 open to a drain. Accordingly, in the ground range enable position, the sleeve 2320 can pump hydraulic fluid into the fine pitch chamber 2347 via the second gallery 2343 and further pump hydraulic fluid into the fine pitch chamber 2347 via the first gallery 2342 to further move the beta tube 2345a into a ground pitch angle.

In the disclosed examples, the valve spool 2308 of the primary control valve assembly 2305 can move to cause hydraulic fluid to be output via the first and third outputs 2314, 2316 to enable adjustments to blade pitch. In some examples, the valve spool 2308 and the valve spool 2321 of the protection valve assembly 2318 can move at the same time or substantially the same time. For example, while the primary control valve assembly 2305 operates to control pitch, the protection valve controller 2354 can override the actions of the primary control valve assembly 2305 if the protection valve controller 2354 detects, for example, a primary system malfunction.

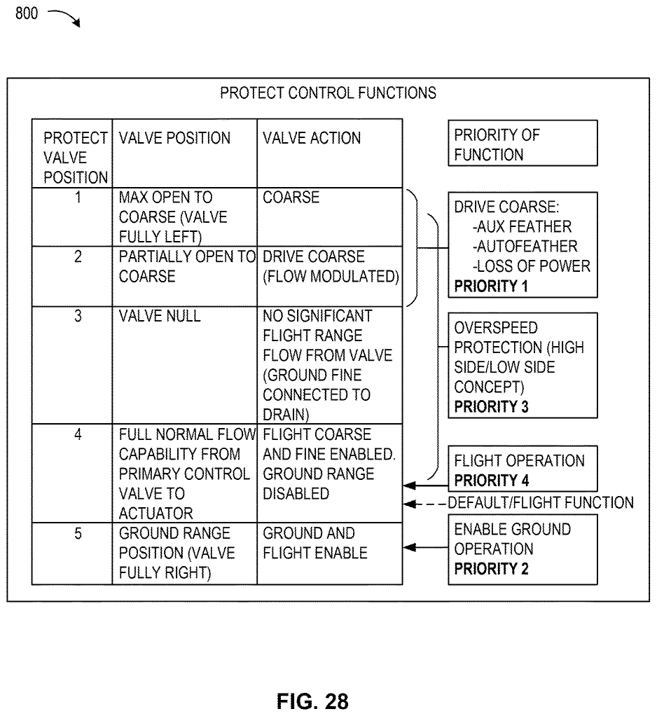

FIG. 28 illustrates the example protect control functions 2800 that can be implemented by the protection valve controller 2354 to control the position of the valve spool 2321 in the protection valve assembly 2318. FIG. 28 includes five functions 2800 that correspond to the five valve spool positions of FIGS. 23-27, namely, a maximum drive coarse position, a partial drive coarse position, a valve null position, a flight range position, and a ground range enabled position. For example, protect valve position 1 corresponds to placing the valve spool 2321 of the sleeve 2320 into the maximum drive coarse position illustrated in FIG. 26. Protect valve position 2 corresponds to placing the valve spool 2321 of the sleeve 2320 into the partial drive coarse position illustrated in FIG. 25. Protect valve position 3 corresponds to placing the valve spool 2321 of the sleeve 2320 into the valve null position illustrated in FIG. 24. Protect valve position 4 corresponds to placing the valve spool 2321 of the sleeve 2320 into the flight range position illustrated in FIG. 23. Protect valve position 5 corresponds to placing the valve spool 2321 of the sleeve 2320 into the ground range enable position illustrated in FIG. 27.

The protection valve controller 2354 outputs a different signal (e.g., a different amount of current) to the valve spool position controller 2319 via the component interface 2360 to cause the valve spool 2321 to move to one of the five valve positions. As described above, the protection valve controller 2354 moves the valve spool 2321 to the first position to cause the blade 2200 to move to a coarse pitch angle. The protection valve controller 2354 moves the valve spool 2321 to the second position to cause the blade 2200 to move to a coarse pitch angle at a slower pace than the pace associated with the maximum drive coarse position. The protection valve controller 2354 moves the valve spool 2321 to the third position to cause the blade 2200 to not move or to be controlled by the counterweight 2351. The protection valve controller 2354 moves the valve spool 2321 to the fourth position to cause the blade 2200 to move to a pitch angle based on the fluid output from the primary sleeve 2307. The protection valve controller 2354 moves the valve spool 2321 to a fifth position to cause the blade 2200 to move to a ground pitch angle.

By default, the protection valve controller 2354 outputs a signal to the valve spool position controller 2319 of the sleeve 2320 to cause the valve spool 2321 to move to the fourth position, the flight range position (e.g., where the pitch angle of the blade 2200 is controlled by the primary sleeve 2307). When the protection valve controller 2354 determines that the fan speed is too high (e.g., relative to an overspeed limit) or the pitch of the blade 2200 is lower than intended (e.g., relative to a pitch threshold), the protection valve controller 2354 changes the signal to cause the valve spool 2321 to move to the third position (e.g., the valve null position). When the protection valve controller 2354 determines that the fan speed has lowered (e.g., relative to an overspeed limit) or the pitch of the blade is higher (e.g., relative to a pitch threshold), the protection valve controller 2354 may change the signal back to move the valve spool 2321 back the default (e.g., normal) flow/flight range position. When the protection valve controller 2354 determines that the fan speed is still too high (e.g., relative to an overspeed limit) or the pitch of the blade is still too low (e.g., relative to a pitch threshold), the protection valve controller 2354 changes the signal to the partial drive coarse position (e.g., position 2). When the protection valve controller 2354 determines that the fan speed has lowered (e.g., relative to an overspeed limit) or the pitch of the blade is higher (e.g., relative to a pitch threshold), the protection valve controller 2354 may change the signal back to move the valve spool 2321 back to the valve null position. When the protection valve controller 2354 determines that the fan speed is still too high (e.g., relative to an overspeed limit) or the pitch of the blade is still too low (e.g., relative to a pitch threshold), the protection valve controller 2354 changes the signal to a signal corresponding to the maximum drive coarse position (e.g., position 1). The protection valve controller 2354 maintains the signal corresponding to the maximum drive coarse position until the fan speed slows by a particular amount or the pitch of the blade increases by a particular amount. The protection valve controller 2354 executes control algorithm(s) that output signal demand(s) to, for example, the protection valve assembly 2318, for position(s) between the default (e.g., normal) flow/flight range position and the fully drive coarse position. The control algorithm(s) can include a Proportional-Integral-Derivative (PID) algorithm that calculates a control error from desired outputs and a valve position request. For example, if a speed increase exceeds an overspeed limit, the PID algorithm determines an amount to open the valve 2318 as a function of how fast the fan is accelerating and the amount the fan has accelerated. The control algorithm(s) executed by the protection valve controller 2354 continue to modulate the valve position to stabilize speed at a speed set point.

If there are contradictory instructions or feedback obtained via the component interface 2360, the protection valve controller 2354 utilizes a priority of positions to determine a position of the valve spool 2321. The highest priority (e.g., priority 1) corresponds to driving coarse due for auxiliary feathering (e.g., feathering caused by an electrically driven pump from a reserve oil supply), auto-feathering, and/or loss of power, the second highest priority (e.g., priority 2) corresponds to enable ground operation, the third highest priority (e.g., priority 3) corresponds to overspeed protection, and the lowest priority (e.g., priority 4) corresponds to default (e.g., normal) flight operation. For example, when the aircraft is operating in flight operation (e.g., priority 4), the protection valve controller 2354 outputs a signal via the component interface 2360 to move the valve spool 2321 via the component interface 2360 when a higher priority functionality is triggered. When the aircraft is operating in overspeed protection mode (e.g., priority 3) because the protection valve controller 2354 has determined that the fan speed is too high, as described above, the overspeed protection mode takes priority over a pilot selected flight operation mode. Thus, the protection valve controller 2354 may override the primary control valve assembly 2305 using one of the protect valve positions 1-4 to reduce fan speed. In the overspeed protection mode, the amount of opening of the protection valve 2318 (e.g., a proportional servo valve) is a function of fan overspeed at a point in time as computed by the protection valve controller 2354 (e.g., proportional valve position versus input signal). Thus, the amount of opening of the protection valve 2318 can be anywhere between protect valve positions 1-4. When ground mode is enabled (e.g., priority 2), then the protection valve controller 2354 outputs a signal via the component interface 2360 to move the valve spool 2321 into the ground range enable position unless auxiliary feathering, auto-feathering, or loss of power occurs. When drive coarse is enabled, the protection valve controller 2354 outputs a signal to move the valve spool 2321 to the maximum drive coarse position or the partial drive coarse position regardless of instructions from a pilot or the system.

FIG. 29 is a block diagram of an example implementation of the protection valve controller 2354. The protection valve controller 2354 includes example interface(s) 2900, an example driver 2902, and an example valve controller 2904.

In connection with the example pitch control system 2300 of FIGS. 23-27, the interface(s) 2900 of FIG. 29 obtain(s) information from the primary controller 2352 (e.g., pilot instructions, flight modes, autopilot instructions, etc.). Additionally, the interface(s) 2900 obtain(s) feedback information from one or more sensors that relates to the blade 2200 via the component interface 2360. For example, the interface(s) 2900 can obtain fan speed, pitch angles measurements of the blade 2200 via the component interface 2360, and/or sensor readings from the pressure sensor(s) 2355. The interface(s) 2900 may include one interface to obtain all signals, or multiple interface(s) 2900 to obtain the multiple signals.

Also, in connection with the example pitch control system 2300 of FIGS. 23-27, the driver 2902 of FIG. 29 drives the valve spool position controller 2319 to move the valve spool 2321 to one or more particular positions. For example, the driver 2902 is capable of outputting different amounts of current, each amount of current corresponding to moving the valve spool 2321 to a different position. The driver 2902 is controlled by the valve controller 2904.

In connection with the example pitch control system 2300 of FIGS. 23-27, the valve controller 2904 determines a position for the valve spool 2321 based on flight mode, pilot instructions, system instructions, autopilot instructions, feedback information, etc. By default, the valve controller 2904 determines the position for the valve spool 2321 to be the flight range position of FIG. 23. However, when the valve controller 2904 determines that overspeed protection is needed, the valve controller 2904 determines a different position for the valve spool (e.g., corresponding to FIGS. 24-26), as further described above. When the valve controller 2904 obtains an indication that ground operation has been enabled (e.g., the aircraft is grounded), the valve controller 2904 determines the position for the valve spool 2321 to be the ground range enable position of FIG. 27. When the valve controller 2904 obtains an indication to drive coarse (e.g., due to loss of power, auto-feathering instructions, auxiliary feathering instructions, etc.), the valve controller 2904 determines the position for the valve spool 2321 to be the maximum drive coarse position of FIG. 26 or the partial drive coarse position of FIG. 25. Additionally, the valve controller 2904 may determine that there is a friction issue, a valve issue, or an issue with the counterweight 2351, based on one or more pressure measurements from the pressure sensor(s) 2355, as further described above. The valve controller 2904 can trigger alerts based on the determined issue(s). The valve controller 2904 controls the driver 2902 based on the determined valve spool position.

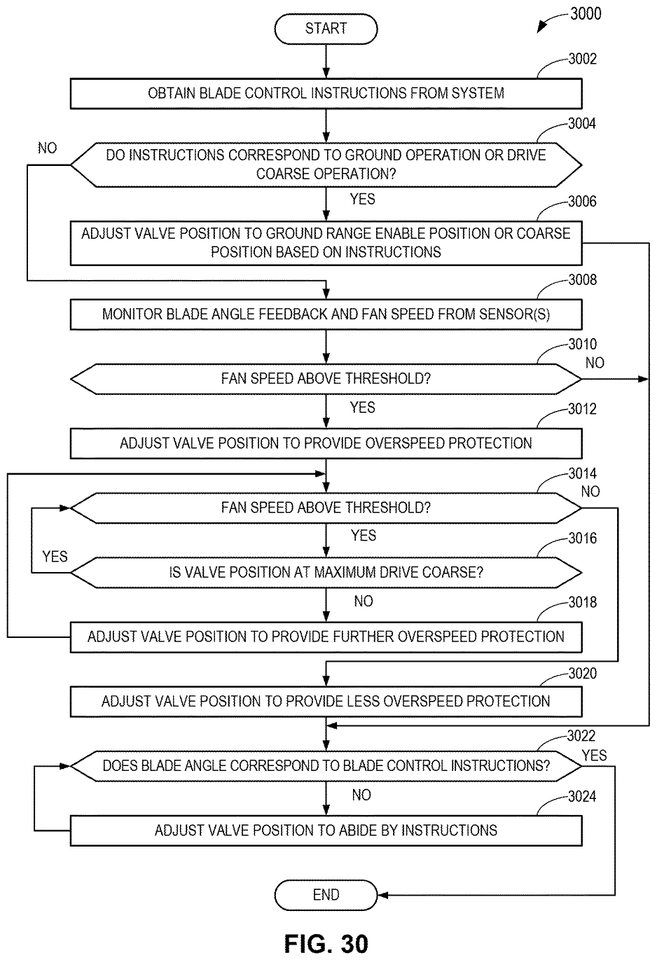

FIG. 30 is a flowchart representative of example machine-readable instructions and/or example operations 3000 that may be executed, instantiated, and/or performed by programmable circuitry (e.g., the protection valve controller 2354 of FIG. 29) to control the pitch control protection system 2300 of FIGS. 23-27. The example machine-readable instructions and/or the example operations 3000 of FIG. 30 begin at block 3002, at which the interface(s) 2900 obtains blade control instructions from the system (e.g., from the primary controller 2352). The blade control instructions may identify whether the aircraft is in flight or grounded, the operation mode of the aircraft (e.g., takeoff, autopilot, landing, etc.), instructions and/or triggers (e.g., auto-feathering instruction, power loss instructions, pilot instructions, etc.), etc.

At block 3004, the valve controller 2904 determines whether the instructions correspond to ground enable operation or drive coarse operation. As described above, ground enable operation is enabled when the aircraft is grounded and coarse operation may be based on a trigger (e.g., power loss, auto-feathering, auxiliary feathering, etc.). When the valve controller 2904 determines that the instructions do not correspond to ground operation of drive coarse operation (block 3004: NO), control continues to block 3008, as further described below. When the valve controller 2904 determines that the instructions correspond to ground operation or drive coarse operation (block 3004: YES), the valve controller 2904 causes the driver 2902 to output a control signal to the valve spool position controller 2319 of the protection valve assembly 2318 to adjust the position of the valve spool 2321 to the ground range enable position of FIG. 27 (e.g., when the instructions correspond to ground operation) or the maximum drive coarse or partial drive coarse position of FIG. 25 or 26 (e.g., when the instructions correspond to drive coarse operation) (block 3006). As described above, drive coarse operation is based on a power loss event, an auto-feathering event, an auxiliary feathering event, etc. and ground operation corresponds to when the aircraft is grounded or not inflight.

At block 3008, the valve controller 2904 monitors the blade angle feedback information and/or fan speed from one or more sensor(s) (e.g., obtained via the interface(s) 2900). At block 3010, the valve controller 2904 determines whether the fan speed is above a threshold (e.g., between 102%-105% of the takeoff fan speed, where the fan speed may be 850 to 200 revolutions per minute, depending on fan diameter)). When the valve controller 2904 determines that the fan speed is not above a threshold (block 3010: NO), control continues to block 3022, as further described below. When the valve controller 2904 determines that the fan speed is above a threshold (block 3010: YES), the valve controller 2904 causes the driver 2902 to output a signal to the valve spool position controller 2319 of the protection valve assembly 2318 to adjust the position of the valve spool 2321 to provide overspeed protection (block 3012). For example, the valve controller 2904 can cause the valve spool 2321 of the protection valve assembly 2318 to move (a) from the flight range position of FIG. 23 to the valve null position of FIG. 24, (b) from the valve null position of FIG. 24 to the partial drive coarse position of FIG. 25, or (c) from the partial drive coarse position of FIG. 25 to the maximum drive coarse position of FIG. 26, causing the blade to either stop adjusting pitch angle or increasing the pitch angle to a coarser pitch angle.

At block 3014, the valve controller 2904 determines whether the fan speed is still above the threshold. When the valve controller 2904 determines that the fan speed is no longer above the threshold (block 3014: NO), the valve controller 2904 causes the driver 2902 to output a control signal to the valve spool position controller 2319 of the protection valve assembly 2318 to cause the valve spool 2321 to provide less overspeed protection (block 3020) and control continues to block 3022, as further described below. For example, the valve controller 2904 can output a control signal to cause the valve spool 2321 to move to the flight range position of FIG. 23. When the valve controller 2904 determines that the fan speed is still above the threshold (block 3014: YES), the valve controller 2904 determines the current position of the valve spool 2321 is at the maximum drive coarse position of FIG. 26 (block 3016). When the valve spool position is not at maximum drive coarse position, the valve spool 2321 can be moved to provide additional overspeed protection (i.e., because the valve spool position has not yet reached the maximum drive coarse position). If the valve controller 2904 determines that the current position of the valve spool 2321 is at the maximum drive coarse position of FIG. 26 (block 3016: YES), control returns to block 3014 for continued monitoring of whether the fan speed is still above the threshold. Control proceeds to block 3020 when the valve controller 2904 determines that the fan speed is no longer above the threshold, at which time the valve spool 2321 can be moved to provide less overspeed protection.

At block 3022, the valve controller 2904 determines whether the blade angle corresponds to the blade control instructions. The valve controller 2904 may process the blade control instructions and determine whether the blade pitch angle projected to a pitch angle that corresponds to the blade control instructions. For example, when the blade control instructions correspond to adjusting the pitch angle of the blade 2200 to a coarse pitch but the blade pitch is moving toward a fine pitch angle, the valve controller 2904 determines that the blade angle does not correspond to the blade control instructions. In another example, when the blade control instructions correspond to adjusting the pitch angle of the blade 2200 to a coarse pitch but the blade pitch is adjusting at a rate below a threshold rate, the valve controller 2904 determines that the blade angle does not correspond to the blade control instructions. When the valve controller 2904 determines that the blade angle corresponds to the blade control instructions (block 3022: YES), the instructions 3000 end. When the valve controller 2904 determines that the blade angle does not correspond to the blade control instructions (block 3022: NO), the valve controller 2904 causes the driver 2902 to output a control signal to the valve spool position controller 2319 to adjust the position of the valve spool 2321 in the sleeve 2320 to abide by the instructions (block 3024). The instructions 3000 end when the valve controller 2904 determines that the blade angle corresponds to the blade control instructions (block 3022: YES).

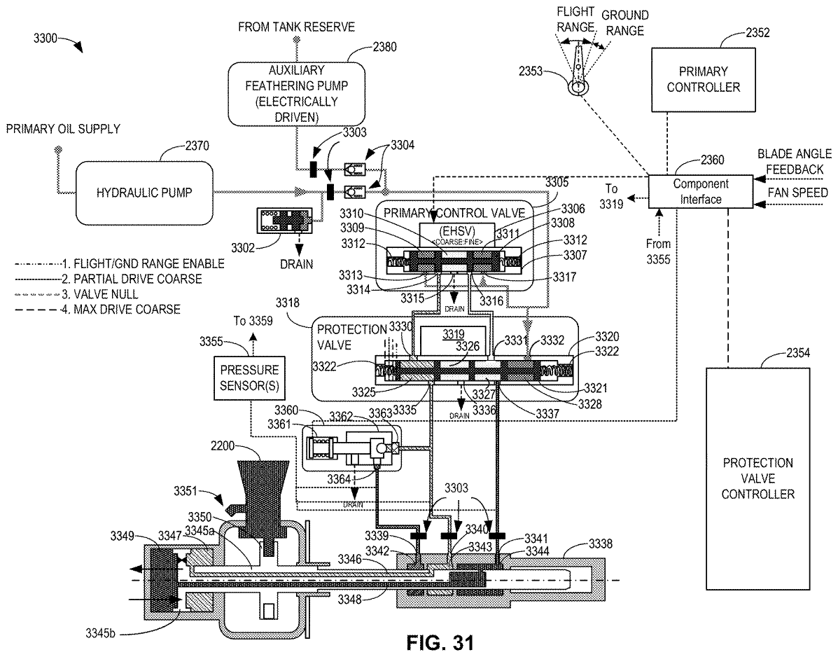

FIG. 31 illustrates an example implementation of a second pitch control protection system 3300. The pitch control protection system 3300 includes the hydraulic pump 2370, the auxiliary hydraulic pump 2380, a pressure relief valve 3302, strainers 3303, no return valves 3304, and a primary control valve assembly 3305 (also referred to as a servo valve or an electro-hydraulic servo valve (EHSV)). The primary control valve assembly 3305 includes a valve spool position controller 3306; a primary sleeve 3307; a valve spool 3308; passages 3309, 3310, 3311 (also referred to as a first passage 3309, a second passage 3310, and a third passage 3311); springs 3312; inputs 3313, 3317 (also referred to as a first input 3313 and a second input 3317); and outputs 3314, 3315, 3316 (also referred to as a first output 3314, a second output 3315, and a third output 3316). The pitch control protection system 3300 further includes a protection valve assembly 3318 (also referred to as a servo valve or an electro-hydraulic servo valve (EHSV)). The protection valve assembly 3318 includes a valve spool position controller 3319; a sleeve 3320; a valve spool 321; springs 3322; passages 3325, 3326, 3327, 3328 (also referred to as a first passage 3325, a second passage 3326, a third passage 3327, and a fourth passage 3328); ports (e.g., inputs and/or outputs) 3330, 3331, 3335, 3337 (also referred to as a first port 3330, a second port 3331, a third port 3335, and a fourth port 3337); an input 332; and an output 336. The pitch control protection system 3300 further includes a hydraulic fluid transfer unit 338. The hydraulic fluid transfer unit 3338 is a dual acting hydraulic pitch actuator. The hydraulic fluid transfer unit 3338 includes ports (e.g., inputs and/or outputs) 3339, 3340, 3341 (also referred to as a first port 3339, a second port 3340, and a third port 3341); galleries 3342, 3343, 3344 (also referred to as a first gallery 3342, a second gallery 3343, and a third gallery 3344); an example beta tube 3345a, which includes a piston 3345b and connections 3346, 3348 (also referred to as a fine pitch chamber connection 3346 and a coarse pitch chamber connection 3348); chambers 3347, 3349 of the pitch change actuator on either side of the piston 3345b (also referred to as a fine pitch chamber 3347 and a coarse pitch chamber 3349); a crosshead 3350; a counterweight 3351; the primary controller 2352; the protection valve controller 2354 of FIG. 29; one or more pressure sensors 3355; and the component interface 2360. The pitch control protection system 3300 further includes a ground valve assembly 3360, which includes a ground valve position controller 3361, a solenoid valve 3362, an input 3363, and an output 3364. As used herein, inputs may be referred to as inputs, inlets, ports, input connections, inlet connections, input terminals, inlet terminals, etc. As used herein, outputs may be referred to as ports, outputs, outlets, output connections, outlet connections, output terminals, outlet terminals, etc. Components that are connected via a solid line are connected via a connection, a tube, a hose, a pipe, and/or other device that can transport fluid. Components that are connected via a dashed line are connected via an electrical connection (e.g., a wired connection, such as a wire, an etch, etc. or a wireless connection). In FIG. 31, the valves/valve assemblies 3302, 3305, 3318, the ground valve assembly 3360, and the hydraulic fluid transfer unit 3338 are illustrated as cross sections of the respective components. As used herein, an input refers to an input connection, inlet, or inlet connection and an output refers to an output connection, outlet, or output connection. The example second pitch control protection system 3300 of FIG. 31 can be implemented with the blade 140 of the turbofan engine 110 of FIG. 1, the blade 254 of the turbofan engine 210 of FIG. 2, or with other types of turbo engine assemblies, hybrid engine assemblies, electric propulsion assemblies, etc.

The hydraulic pump 2370 of FIG. 31 is a conveyer of hydraulic power that pumps a hydraulic fluid. The hydraulic pump 2370 acts as a pressure vessel to cause hydraulic fluid to flow (e.g., to be pumped) into the primary control valve assembly 3305 and/or the protection valve assembly 3318. The hydraulic fluid may be an oil-based fluid, a silicone-based fluid, a synthetic hydrocarbon-based fluid, and/or another type of hydraulic fluid.

The auxiliary hydraulic pump 2380 of FIG. 31 is a conveyer of hydraulic power that pumps a hydraulic fluid when the hydraulic fluid from the hydraulic pump 2370 is insufficient (e.g., due to a loss of primary oil supply). One or both of the hydraulic pumps 2370, 2380 cause(s) hydraulic fluid to flow (e.g., to be pumped) into the primary control valve assembly 3305 and/or the protection valve assembly 3318. The hydraulic fluid may be an oil-based fluid, a silicone-based fluid, a synthetic hydrocarbon-based fluid, and/or another type of hydraulic fluid.

The pressure relief valve 3302 of FIG. 31 keeps the pressure of the hydraulic fluid from the hydraulic pump 2370 below a threshold level (e.g., 1100 pounds per square inch (psi), etc.) by draining some of the hydraulic fluid toward a drain when the hydraulic fluid is above the threshold level. The pressure relief valve 3302 reduces the pressure of the hydraulic fluid to prevent pressure-induced damage when causing the hydraulic fluid to flow into other components of the pitch control protection system 3300. In some examples, the pressure relief valve 3302 is implemented within the hydraulic pump 2370.

The strainers 3303 of FIG. 31 strain the hydraulic fluid to block contaminants in the hydraulic fluid that may damage or jam the valves 3304, 3305, 3318. Although FIG. 31 has five strainers 3303, there may be any number of strainers. The no return valves (NRVs) 3304 are valves that prevent hydraulic fluid from returning back to the hydraulic pumps 2370, 2380.

The primary control valve assembly 3305 of FIG. 31 allows or prevents hydraulic fluid from the hydraulic pumps 2370, 2380 into the coarse pitch chamber 3349 and the fine pitch chamber 3347 via one or more of the connections 3346, 3348 of the beta tube 3345a based on a position of the valve spool 3308. The primary control valve assembly 3305 includes the valve spool position controller 3306. The valve spool position controller 3306 obtains an electrical signal (e.g., a current) from the primary controller 2352. The valve spool position controller 3306 moves the valve spool 3308 based on the electrical signal (e.g., based on the amount of current). For example, the valve spool position controller 3306 moves the valve spool 3308 to a first position based on obtaining a first current and moves the valve spool 3308 to a second position based on a second current. In some examples, the valve spool position controller 3306 may be a direct drive valve (also referred to as a proportional valve). In such examples, the valve spool 3308 is moved by an electric means (e.g., a linear motor, a stepper type motor, etc. through a gear drive with electronic feedback). As further described below, the primary controller 2352 generates the signal based on instructions from a pilot and/or based on instructions from one or more of a FADEC, a separate controller (e.g., a fan electronic controller), a separate control box, etc.

The primary sleeve 3307 of FIG. 31 is a cylindrical valve that includes the valve spool 3308. The valve spool 3308 is a cylindrical valve spool that fits within the primary sleeve 3307 and includes solid portions and open portions (also referred to as open areas). The open portions of the valve spool 3308 make up the passages 3309, 3310, 3311. The passages 3309, 3310, 3311 are separated so that any fluid in one passage cannot directly flow into another passage within the primary sleeve 3307. The valve spool 3308 can move within a cavity of the primary sleeve 3307 between the springs 3312. In some positions (e.g., locations), one or more solid portions of the valve spool 3308 can block or plug one or more of the inputs 3313, 3317 or the outputs 3314, 3315, 3316. In other positions, one or more of the solid portions of the valve spool 3308 do not block or plug one or more of the inputs 3313, 3317 or the outputs 3314, 3315, 3316, allowing the hydraulic fluid to flow into and/or out of one or more of the passages 3309, 3310, 3311.

The first input 3313 of the primary sleeve 3307 is connected to the hydraulic pumps 2370, 2380 (e.g., via the strainers 3303 and the NRVs 3304), the second input 3317, and the input 3332 of the sleeve 3320 of the protection valve assembly 3318. The first output 3314 is connected to the first port 3330 of the sleeve 3320. The second output 3315 is connected to a drain. The third output 3316 is connected to the second port 3331 of the sleeve 3320. The second input 3317 is connected to the hydraulic pumps 2370, 2380 (e.g., via the strainers 3303 and the NRVs 3304), the first input 3313, and the input 3332 of the sleeve 3320.

When the valve spool 3308 is in the position of FIG. 31, the first and third outputs 3314, 3316 are blocked by the valve spool 3308. Accordingly, the primary sleeve 3307 does not output hydraulic fluid to either the fine pitch chamber 3347 or the coarse pitch chamber 3349.

When the valve spool 3308 is moved forward in the orientation of FIG. 31, the first output 3314 of the primary sleeve 3307 opens into the second passage 3310 and the second passage 3310 opens to a drain via the second output 3315 of the primary sleeve 3307. Thus, no hydraulic fluid is pumped from the first output 3314 to the sleeve 3320. As described above, the term “forward” refers to a direction along the centerline axis 108 in the direction of movement of the turbo engine assembly 100, such as to the left in FIG. 31, while the term “rearward” refers to a direction along the centerline axis 108 in the opposite direction, such as to the right in FIG. 31. Additionally, when the valve spool 3308 is moved forward in the orientation of FIG. 31, the second input 3317 of the primary sleeve 3307 opens into the third passage 3311 and the third passage 3311 opens into the second port 3331 of the sleeve 3320 via the third output 3316 of the sleeve 3320. Thus, the hydraulic fluid from the hydraulic pump(s) 2370, 2380 is pumped into the second port 3331 of the sleeve 3320 via the second input 3317 of the primary sleeve 3307 and the third passage 3311.

When the valve spool 3308 is moved rearward in the orientation of FIG. 31, the third output 3316 of the primary sleeve 3307 opens into the second passage 3310 and the second passage 3310 opens to a drain via the third output 3316 of the primary sleeve 3307. Thus, no hydraulic fluid is pumped from the third output 3316 to the sleeve 3320. Additionally, when the valve spool 3308 is moved rearward in the orientation of FIG. 31, the first input 3313 of the primary sleeve 3307 opens into the first passage 3309 and the first passage 3309 opens into the first port 3330 of the sleeve 3320 via the first output 3314 of the primary sleeve 3307. Thus, the hydraulic fluid from the hydraulic pump(s) 2370, 2380 is pumped into the first port 3330 of the sleeve 3320 via the first input 3313 of the primary sleeve 3307 and the first passage 3309.

The springs 3312 of FIG. 31 are structured to position the valve spool 3308 in a particular position when the valve spool position controller 3306 does not obtain a signal. In this manner, when there is a loss of signal or power, the springs 3312 cause the valve spool 3308 to move to a pre-selected position. In the example of FIG. 31, the springs 3312 are structured to move the valve spool 3308 to the position illustrated in FIG. 31, where the valve spool 3308 plugs the first and third outputs 3314, 3316. In some examples, one or more of the springs 3312 may be removed. For example, the spring 3312 on the left (with regards to the orientation of FIG. 31) of the sleeve 3320 may be removed. Removing the spring 3312 on the left provides greater chip-shearing capability in the desired direction. If there is no oil pressure in the first stage of the valve assembly 3318, the spring 3312 on the right (with regards to the orientation of FIG. 31) of the sleeve 3320 ensures the spool 3321 moves to connect fine pitch oil connected to drain, thereby allowing the counterweights 3351 to drive the blade 2200 coarse, as a failsafe.

The protection valve assembly 3318 of FIG. 31 allows or prevents hydraulic fluid from the primary sleeve 3307 and/or the hydraulic pumps 2370, 2380 into the coarse pitch chamber 3349 and the fine pitch chambers 3347 of the beta tube 3345a based on a position of the valve spool 321. The primary control valve assembly 3305 includes the valve spool position controller 3319 to obtain an electrical signal (e.g., a current) from the protection valve controller 2354 via component interface 2360. The valve spool position controller 3319 moves the valve spool 3321 based on the electrical signal (e.g., based on the amount of current). For example, the valve spool position controller 3319 moves the valve spool 3321 to a first position based on obtaining a first current, moves the valve spool 3321 to a second position based on a second current, etc. In some examples, the valve spool position controller 3319 may be a direct drive valve (also referred to as a proportional valve). In such examples, the valve spool 3321 is moved by an electric means (e.g., a linear motor, a stepper type motor, etc. through a gear drive with electronic feedback). As further described below, the protection valve controller 2354 generates the signal based on various data (e.g., fan speed, pressure sensor data, blade angle feedback, information from the primary controller 2352, etc.).

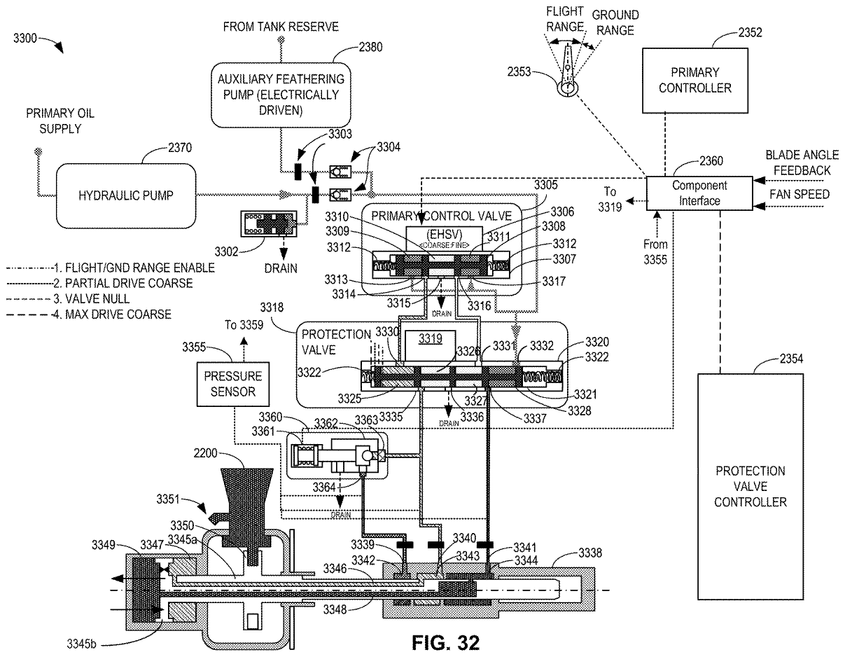

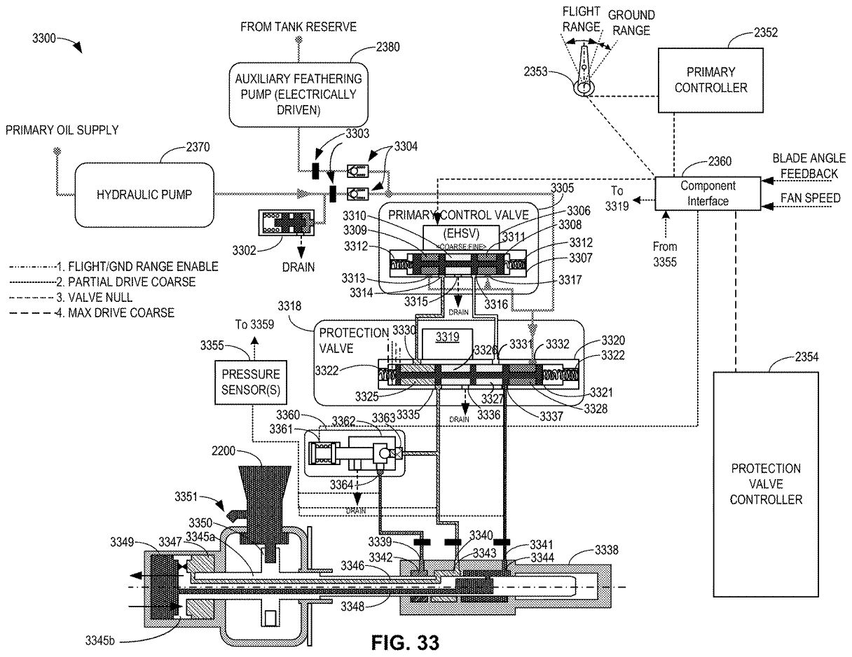

The valve spool 3321 of FIG. 31 is a cylindrical valve spool that fits within the cylindrical sleeve 3320 and includes solid portions and open portions. The open portions of the valve spool 3321 define (e.g., make up, correspond to, etc.) the passages 3325, 3326, 3327, 3328. The passages 3325, 3326, 3327, 3328 are separated so that any fluid in one passage cannot directly flow into another passage within the sleeve 3320. The valve spool 3321 can move within a cavity of the sleeve 3320 between the springs 3322. In some positions (e.g., locations), one or more solid portions of the valve spool 3321 can block or plug one or more of the ports (e.g., inputs) 3330, 3331, 3332 or ports (e.g., outputs) 3335, 3336, 3337. In other positions, one or more of the solid portions of the valve spool 3321 do not block or plug one or more of the ports 3330, 3331, 3335, 3337, the input 3332, or the output 3336 allowing the hydraulic fluid to flow into and/or out of one or more of the passages 3325, 3326, 3327, 3328. In some examples, one or more of the ports 3330, 3331, 3335, 3337 can be bi-directional (e.g., to allow hydraulic fluid to pass through the protection valve assembly 3318 in either direction). For example, based on the position of the valve spool 321, the third port 3335 provides for bidirectional flow in the examples of FIGS. 31, 35, 36, and 37, provides for single direction flow in the examples of FIGS. 32, 34, and 38, and does not provide flow in the example of FIG. 33.

The first port 3330 of FIG. 31 of the sleeve 3320 is connected to the first output 3314 of the primary sleeve 3307. The second port 3331 is connected to the third output 3316 of the primary sleeve 3307. The input 3332 is connected to the hydraulic pumps 2370, 2380 (e.g., via the strainers 3303, and the NRV 3304 and the first input 3313 and the second input 3317 of the primary sleeve 3307. The third port 3335 is connected to the second port 3340 of the hydraulic fluid transfer unit 338. The output 3336 is connected to the drain. The fourth port 3337 is connected to the third port 3341 of the hydraulic fluid transfer unit 338.

The valve spool position controller 3319 of FIG. 31 can move the valve spool 3321 into at least five different positions that correspond to five different actions based on a signal from the protection valve controller 2354 via the component interface 2360. For example, the valve spool 3321 can be moved to a maximum drive coarse position, a partial drive coarse position, a valve null position, a flight range position, and a ground range enabled position. The maximum drive coarse position corresponds to an automatic flow of hydraulic fluid at full pressure to the coarse pitch chamber 3349 of the valve spool assembly to cause the blade 2200 to move to a coarse and/or feathered pitch angle at a maximum rate. The partial drive coarse position corresponds to an automatic flow of hydraulic fluid at partial pressure to the coarse pitch chamber 3349 of the valve spool assembly to cause the blade 2200 to move to a coarse and/or feathered pitch angle at a rate less than maximum. The valve null position corresponds to preventing hydraulic fluid from flowing to either the coarse pitch chamber 3349 or the fine pitch chamber 3347, maintaining the pitch of the blade 2200. The flight/ground range position corresponds to control of the pitch angle based on the fluid output by the primary sleeve 3307 and/or control of the pitch angle to the ground range (e.g., when the ground valve assembly 3360 is open). The ground range enabled position corresponds to pumping hydraulic fluid into the fine pitch chamber 3347 to cause the blade 2200 to move to a ground pitch angle. The example of FIG. 31 is described in conjunction with the flight/ground range position. However, each position is illustrated in one of FIGS. 31-34.

In FIG. 31, the valve spool 3321 is in the flight/ground range position. In the flight/ground range position, the first port 3330 opens to the first passage 3325 and the third passage opens to the third port 335. Thus, hydraulic fluid from the first port 3330 is pumped out of the third port 335. The second port 3331 opens to the third passage 3327 and the third passage 3327 opens to the fourth port 337. Thus, hydraulic fluid from the second port 3331 is pumped out of the fourth port 337. The input 3332 opens to the fourth passage 3328 (which does not open to an output). The second passage 3326 opens to the output 3336 and the output 3336 opens to the drain. Thus, any fluid in the second passage 3326 is drained to the drain (e.g., hydraulic fluid from the fine pitch chamber 3347 if the piston 3345b is forced rearward or hydraulic fluid from the coarse pitch chamber 3349 if the piston 3345b is forced forward). Accordingly, in the flight/ground range position, hydraulic fluid from either the first output 3314 and/or third output 3316 of the primary sleeve 3307 is pumped into the hydraulic fluid transfer unit 338.

The springs 3322 of FIG. 31 are structured to position the valve spool 3321 in the partial drive coarse position when the valve spool position controller 3319 does not obtain a signal. In this manner, when there is a loss of signal or power, the springs 3322 cause the valve spool 3321 to move to the partial drive coarse position. Because a coarse pitch angle is safer than a fine pitch angle in flight, the springs 3322 can be structured to position the valve spool 3321 into the partial drive coarse position. In some examples, one or more of the springs 3322 may be removed. For example, the spring 3322 on the left (with regards to the orientation of FIG. 3) of the sleeve 3320 may be removed. Removing the spring 3322 on the left provides greater chip-shearing capability in the desired direction. If there is no oil pressure in the first stage of the valve assembly 3318, the spring 3322 on the right (with regards to the orientation of FIG. 3) of the sleeve 3320 ensures the spool 3321 moves to connect fine pitch oil connected to drain, thereby allowing the counterweights 3351 to drive the blade 2200 coarse, as a failsafe.

Although the example of FIGS. 31-36 provide a particular structure for implementing the valve assembly 3318, there may be other ways to implement the valve assembly 3318 to perform the same and/or substantially similar functionality.

The hydraulic fluid transfer unit 3338 of FIG. 31 houses the beta tube 3345a and components structured to move the beta tube 345a into different positions. In some examples, the hydraulic fluid transfer unit 3338 may be combined with and/or directly attached to one or more components of the pitch control protection system 3300. As further described below, as the beta tube 3345a moves, the pitch angle of the blade 2200 changes. The hydraulic fluid transfer unit 3338 includes the ports 3339, 3340, 3341. The first port 3339 is connected to the output 3364 of the ground valve assembly 3360 and the first gallery 3242. The second port 3340 is connected to the third port 3335 of the sleeve 3320 and the second gallery 3343 and the input 3363 of the ground valve assembly 3360. The third port 3341 is connected to the fourth port 3337 of the sleeve 3320 and the third gallery 3344. The galleries 3342, 3343, 3344 may be a 360-degree open space that connects the ports 3339, 3340, 3341 to the chambers 3347, 3349 via one or more of the fine pitch chamber connection 3346 or the coarse pitch chamber connection 3348. Accordingly, the galleries 3342, 3343, 3344 convey hydraulic fluid from one location to another. For example, hydraulic fluid pumped into the first gallery 3342 can be pumped into the fine pitch chamber 3247 when the beta tube 3345a is in a position where the first gallery 3242 opens to the fine pitch chamber connection 3346. Additionally, hydraulic fluid pumped into the second gallery 3343 can be pumped into the fine pitch chamber 3347 when the beta tube 3345a is in a position where the second gallery 3343 opens to the fine pitch chamber connection 3346. Additionally, hydraulic fluid pumped into the third gallery 3344 can be pumped into the coarse pitch chamber 3349 when the beta tube 3345a is in a position where the third gallery 3344 opens to the coarse pitch chamber connection 3248. When the beta tube 3345a rotates, hydraulic fluid can still be pumped in, because regardless of the orientation of the connections 3246, 3248, the 360-degree galleries 3342, 3343, 3344 can open up to the connections 3246, 3348.

The connections 3346, 3348 of FIG. 31 are tubes, pipes, hoses, and/or openings within the beta tube 3345a that can pump obtained hydraulic fluid from the sleeve 3320 into one or more of the fine pitch chamber 3347 and the coarse pitch chamber 3349. When hydraulic fluid is pumped into the coarse pitch chamber 3349, the beta tube 3345a moves rearward in the orientation of FIG. 3, causing the blade 2200 to move to a coarse pitch angle. When the hydraulic fluid is pumped into the fine pitch chamber 3347, the beta tube 3345a moves forward in the orientation of FIG. 31, causing the blade 2200 to move to a fine pitch angle. The coarse pitch chamber 3349 and the fine pitch chamber 3347 may include a piston bleed structure to bleed out hydraulic fluid that has been pumped into the respective chambers 3347, 3349. The beta tube 3345a includes the piston 3345b to separate the chambers 3347, 3349. When hydraulic fluid is pumped into the fine pitch chamber 3347, the piston 3345b is moved forward and hydraulic fluid in the coarse pitch chamber 3349 is pumped out of one or more of the drain outputs 3315, 3336 via the primary control valve 3305 and/or the protection valve 3318 (e.g., depending on the positions of the valve spools 3308, 321). When hydraulic fluid is pumped into the coarse pitch chamber 3349, the piston 3345b is moved rearward and hydraulic fluid in the fine pitch chamber 3347 is pumped out of one or more of the drain outputs 3315, 3336 via the primary control valve 3305 and/or the protection valve 3318 (e.g., depending on the positions of the valve spools 3308, 321).

The beta tube 3345a of FIG. 31 includes a crosshead 3350 that transfers the lateral movement (e.g., forward and rearward in the orientation of FIG. 3) into rotational movement to adjust the pitch of the blade 2200. The yoke arrangement of the crosshead 3350 locates the operating pin on the base of each blade 2200. The pin may be offset from the centerline of the blade 2200 such that axial movement of the pitch beta tube 3345a results in rotation of the blade 2200.

The blade 2200 of FIG. 31 includes the counterweight 3351. The counterweight 351 causes the blade 2200 to naturally reduce pitch when a load is present on the blade 2200. The counterweight 3351 causes the blade 2200 to naturally position to a higher blade angle. As further described below, one or more of the pressure sensor(s) 3355 can measure pressure at the ports 3364, 3335, 3337 so that the protection valve controller 2354 can determine, based on the pressure measurement, when there is any friction in the blade 2200 that prevents the counterweight 3351 from naturally reducing pitch of the blade 2200 and/or determine that the counterweight 3351 has been compromised.

The primary controller 2352 is a pitch controller that outputs a control signal to the valve spool position controller 3306 via the component interface 2360 based on instructions from a pilot and/or autopilot instructions. For example, when a pilot engages the power lever 2353, the primary controller 2352 can determine a pitch angle that corresponds to the control of the power lever 2353 and adjust the pitch of the blade 2200 by sending a signal (e.g., a current) to the valve spool position controller 3306 via the component interface 2360. The primary controller 2352 can execute control algorithm(s) to determine an amount to change the pitch angle at a given time. For example, in flight, the primary controller 2352 varies pitch to maintain fan speed. Varying the pitch in flight changes the fan torque absorbed. If the fan torque is greater than the engine torque, the fan speed will be reduced. If the fan torque is less than the engine torque, the fan speed will increase. The control algorithm(s) executed by the primary controller 2352 provide for stability with respect to the fan speed. When the fan is in the ground range, the control algorithm sets the pitch as a function of the position of the power lever 2353 while the engine maintains speed. As described above, the valve spool position controller 3306 controls the position of the valve spool 3308 in the primary sleeve 3307 based on the signal, which causes hydraulic fluid to be pumped into one of the fine pitch chamber 3347 or the coarse pitch chamber 3349 to adjust the pitch of the blade 2200. The primary controller 2352 may output the desired pitch position, flight mode (e.g., grounded, take-off, landing, cruise altitude, etc.), and/or other information to the protection valve controller 2354 via the component interface 2360. In some examples, the primary controller 2352 may be in communication with and/or implemented within a FADEC.

The protection valve controller 2354 outputs control signals to the protection valve assembly 3318 via the component interface 2360 to facilitate and/or override operation of the primary sleeve 3307. For example, during default operation, the protection valve controller 2354 outputs a signal to the valve spool position controller 3319 via the component interface 2360 to cause the valve spool 3321 of the sleeve 3320 to be positioned in the flight range location. As described above, when the valve spool 3321 is in the flight range location, the position of the valve spool 3308 of the primary sleeve 3307 controls the position of the beta tube 3345a by pumping hydraulic fluid into the fine pitch chamber 3347 and/or the coarse pitch chamber 3349. The protection valve controller 2354 also monitors the fan speed, blade angle feedback, pressure information, and/or information from the primary controller 2352 to determine whether to override the control of the primary control valve assembly 3305 and/or otherwise control the pitch of the blade 2200. For example, when the fan speed is above one or more thresholds, the protection valve controller 2354 can adjust the position of the valve spool 3321 to cause the blade 2200 to adjust the tilt to decrease the pitch angle to a coarser pitch angle by pumping hydraulic fluid into the coarse pitch chamber 3349. Additionally, when blade pitch angle feedback indicates that the blade 2200 is not approaching the intended pitch angle, the protection valve controller 2354 can adjust the position of the valve spool 3321 to attempt to move the blade 2200 to the intended pitch angle. Additionally, the protection valve controller 2354 can prevent the blade 2200 from reaching a pitch angle below a threshold (e.g., a ground pitch) unless the aircraft is grounded.

In some examples, the protection valve controller 2354 determines and/or alerts, via the component interface 2360, the pilot or another component to an issue associated with the pressure measured by the pressure sensor 3355. In some examples, the pressure sensor 3355 can measure a pressure at the output 3364 that can be used to determine a valve failure, excess friction at the crosshead 3350, and/or an issue with the counterweight 3351. In some examples, the pressure sensor(s) 3355 can measure a pressure at the third and fourth ports 3335, 3337. In such examples, the protection valve controller 2354 can determine a delta (e.g., difference) between the pressure at the third port 3335 and the pressure at the fourth port 337. The protection valve controller 2354 can determine in flight system friction based on the delta and take appropriate action based on the flight system friction. The protection valve controller 2354 may monitor the pressure as the pitch of the blade 2200 is reduced to determine an amount of pressure needed to overcome friction. When the amount of pressure needed to overcome friction changes, the protection valve controller 2354 can flag, via the component interface 2360, the potential issue to the pilot, a mechanic, etc. For example, because the pressure at the output 3364 is supposed to be zero when the aircraft is in flight, the protection valve controller 2354 can generate an alert when the pressure at the output 3364 is not zero at any time during flight.

The ground valve assembly 3360 of FIG. 31, when opened/enabled, pumps hydraulic fluid into the fine pitch chamber 3347 via the first gallery 3342 to control the position of a valve spool of the solenoid valve 3362 (also referred to as a ground beta enabled (GBE solenoid)) to cause the blade 2200 to move to the ground pitch angle. The ground valve assembly 3360 includes the ground valve position controller 3361 to control the solenoid valve 3362 to pump out hydraulic fluid from the output 3364 when open or block hydraulic fluid from being pumped from the output 3364 when closed. The ground valve position controller 3361 obtains a control signal from the protection valve controller 2354 via the component interface 2360. The control signal may be a first or second amount of current. For example, if no current is applied to the ground valve position controller 3361, the ground valve position controller 3361 disables/closes the solenoid valve 3362 of the ground valve assembly 3360 to close, thereby blocking any hydraulic fluid from being output at the output 364. When a threshold amount of current is applied to the ground valve position controller 3361, the ground valve position controller 3361 moves a valve spool of the solenoid valve 3362 to an open position (e.g., enable the solenoid valve 3362), pumping the hydraulic fluid from the input 3363 toward the output 3364 and into the first gallery 3342. The protection valve controller 2354 only causes the ground valve assembly 3360 to open when the aircraft is grounded. Accordingly, when in flight, the protection valve controller 2354 closes (e.g., disables) the ground valve assembly 3360 to prevent hydraulic fluid from entering the first gallery 3342. Thus, the beta tube 3345a is structurally disabled from moving the blade 2200 into a ground pitch angle. However, when grounded, the protection valve controller 2354 can cause the solenoid valve 3362 to pump hydraulic fluid into the fine pitch chamber 3347 via the first gallery 3342 to further move the beta tube 3345a into a ground pitch angle.

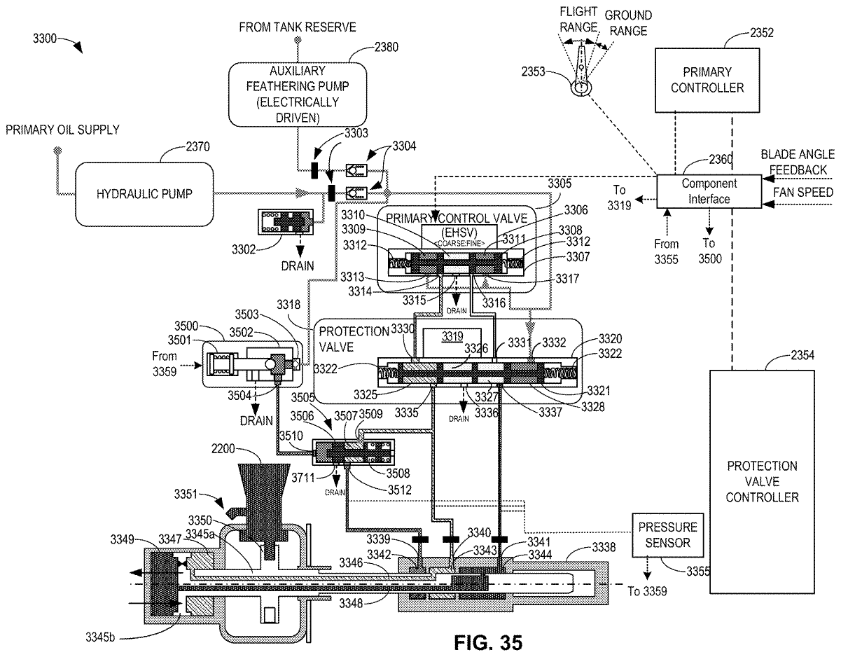

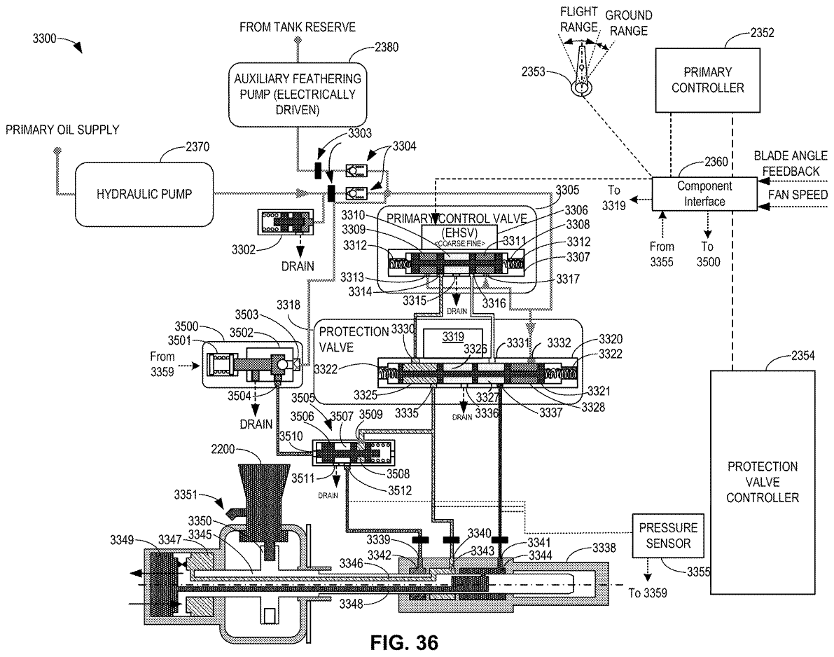

Although the ground valve assembly 3360 opens or closes to enable or disable the ability to move the blade 2200 to a ground pitch based on instructions from the protection valve controller 2354 via the component interface 2360, in some systems, the pressure and/or amount of hydraulic fluid flow through the solenoid-based ground valve assembly 3360 may not be high enough to move the beta tube 3345a (or move the beta tube 3345a within a threshold amount of time) to a position corresponding to a ground pitch angle. Thus, a two-valve implementation may be used where a solenoid-based valve controls a second valve that is capable of pumping hydraulic fluid with more pressure and/or flow. An example of a two-valve implementation is further described below in conjunction with FIGS. 35 and 36.

FIG. 32 illustrates an example implementation of the pitch control protection system 3300 of FIG. 31 when the valve spool 3321 of the sleeve 3320 is in a partial drive coarse position.

In the partial drive coarse position of FIG. 32, the first port 3330 opens to the first passage 3325 (which does not open to an output). The second port 3331 opens to the third passage 3327 (which does not open to an output). The input 3332 opens to the fourth passage 3328 and the fourth passage 3328 partially opens to the fourth port 337. For example, the valve spool 3321 partially blocks the fourth port 3337, limiting the amount of hydraulic fluid that is pumped into the hydraulic fluid transfer unit 3338. The hydraulic fluid from at least one of the hydraulic pumps 2370, 2380 is pumped into the third gallery 3344 of the hydraulic fluid transfer unit 3338 via the third port 3341 without going through the primary sleeve 3307. Accordingly, in the partial drive coarse position of FIG. 32, the protection valve assembly 3318 overrides the pitch control of the primary control valve assembly 3305 by blocking the first and third outputs 3314, 3316 of the primary sleeve 3307. The second passage 3326 opens to the third port 3335 and the second output 336. Thus, any fluid in the second passage 3326 is drained to the drain. For example, as hydraulic fluid is pumped into the coarse pitch chamber 3349, causing the piston 3345b to move rearward, the hydraulic fluid in the fine pitch chamber 3347 is forced into the drain output 3336 of the second passage 3326 (e.g., via the fine pitch connection chamber 3346, the second gallery 3343, and the ports 3340, 3335).

FIG. 33 illustrates an example implementation of the pitch control protection system 3300 of FIG. 31 when the valve spool 3321 of the sleeve 3320 is in a valve null position.

In the valve null position of FIG. 33, the first port 3330 opens to the first passage 3325 (which does not open to an output). The second port 3331 opens to the third passage 3327 (which does not open to an output). The input 3332 opens to the fourth passage 3328 (which does not open to an output). The second passage 3326 opens to the output 3336 and the output 3336 opens to the drain. Additionally, in the valve null position, the third port 3335 and the fourth port 3337 are plugged and/or blocked by the valve spool 321. Accordingly, no hydraulic fluid from the sleeve 3320 flows into the hydraulic fluid transfer unit 338. For example, the sleeve 3320 blocks the fluid output by the primary sleeve 3307 from the hydraulic fluid transfer unit 338. Thus, in the valve null position, hydraulic fluid is not used to adjust the pitch of the blade 2200 (e.g., pitch angle is maintained and/or controlled by the counterweight 3351).

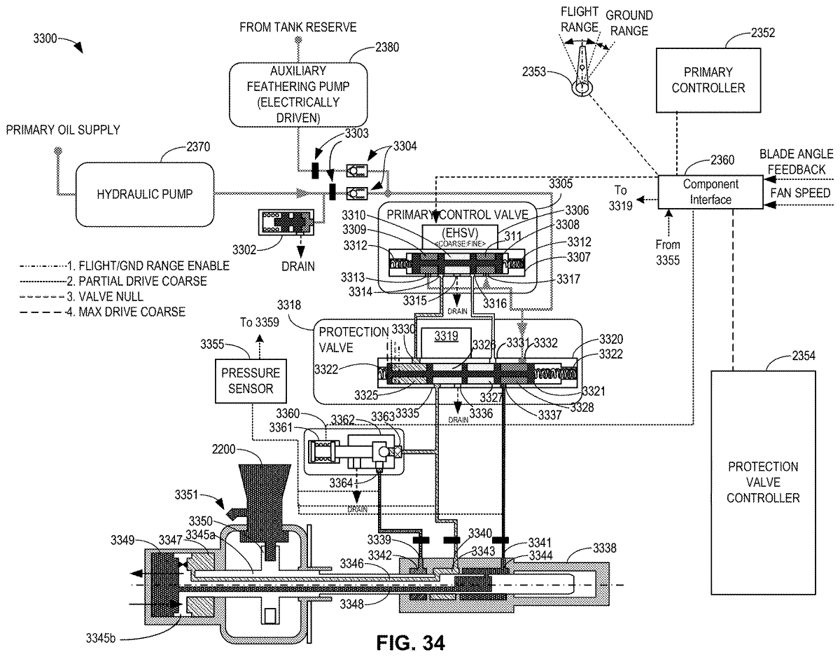

FIG. 34 illustrates an example implementation of the pitch control protection system 3300 of FIG. 31 when the valve spool 3321 of the sleeve 3320 is in a maximum drive coarse position.

In the maximum drive coarse position of FIG. 34, the first port 3330 opens to the first passage 3325 (which does not open to an output). The second port 3331 opens to the third passage 3327 (which does not open to an output). The input 3332 opens to the fourth passage 3328 and the fourth passage 3328 fully opens to the fourth port 337. For example, the valve spool 3321 does not block the fourth port 3337, allowing maximum hydraulic flow into the hydraulic fluid transfer unit 338. The hydraulic fluid from at least one of the hydraulic pumps 2370, 2380 is pumped into the third gallery 3344 of the hydraulic fluid transfer unit 3338 via the third port 3341 without going through the primary sleeve 3307. Accordingly, in the maximum drive coarse position of FIG. 34, the protection valve assembly 3318 overrides the pitch control of the primary control valve assembly 3305 by blocking the hydraulic fluid output by the primary sleeve 3307. Additionally, in the maximum drive coarse position of FIG. 34, the second passage 3326 opens to the third port 3335 and the output 3336 and the output 3336 opens to the drain. For example, as hydraulic fluid is pumped into the coarse pitch chamber 3349, causing the piston 3345b to move rearward, the hydraulic fluid in the fine pitch chamber 3347 is forced into the drain output 3336 of the second passage 3326 (e.g., via the fine pitch connection chamber 3346, the second gallery 3343, and the ports 3340, 3335).

FIG. 35 illustrates an alternative example implementation of the pitch control protection system 3300 of FIG. 31. FIG. 35 replaces the single solenoid-based ground valve assembly 3360 of FIGS. 31-34 with an example first ground valve assembly 3500 and a second ground valve assembly 3505. The first ground valve assembly 3500 includes an example valve position controller 3501, an example solenoid valve 3502, an example input 3503, and an example output 3504. The second ground valve assembly 3505 includes an example valve spool 3506; example passages 3507, 3508 (also referred to as a first passage 3507 and a second passage 3508); example inputs 3509, 3510 (also referred to as a first input 3509 and a second input 3510); and example outputs 3511, 3512 (also referred to as a s first output 3511 and a second output 3512).

The first ground valve assembly 3500 of FIG. 35 includes the input 3503 connected to the hydraulic pumps 2370, 2380 via the strainers 3303 and the NRVs 3304. The first ground valve assembly 3500 further includes the output 3504 connected to the second input 3510 of the second ground valve assembly 3505. Additionally, the ground valve position controller 3501 is connected to the protection valve controller 2354 via the component interface 2360 (e.g., through a wired or wireless network connection).

The first ground valve assembly 3500 of FIG. 35, when opened, pumps hydraulic fluid from the outputs of one or more of the NRVs 3304 into the second input 3510 of the second ground valve assembly 3505 to control the position of the valve spool 3506 of the second ground valve assembly 3505. The first ground valve assembly 3500 includes the ground valve position controller 3501 to control the solenoid valve 3502 to pump out hydraulic fluid from the output 3504 or blocked hydraulic fluid from being pumped from the output 3504. The ground valve position controller 3501 obtains a control signal from the protection valve controller 2354 via the component interface 2360. The control signal may be a first or second amount of current. For example, if no current is applied to the ground valve position controller 3501, the ground valve position controller 3501 controls the solenoid valve 3502 (also referred to as a GBE solenoid) of the first ground valve assembly 3500 to block any hydraulic fluid from being output at the output 3504. When a threshold amount of current is applied to the ground valve position controller 3501, the ground valve position controller 3501 moves a valve spool of the solenoid valve 3502 to pump the hydraulic fluid from the input 3503 toward the output 3504 and into the second input 3510 of the second ground valve assembly 3505. The protection valve controller 2354 only opens the first ground valve assembly 3500 when the aircraft is grounded. Accordingly, when in flight, the protection valve controller 2354 causes the first ground valve assembly 3500 to close to prevent hydraulic fluid from entering the first gallery 3342. Thus, the beta tube 3345a is structurally disabled from moving the blade 2200 into a ground pitch angle, as further described below in conjunction with FIG. 36. However, when grounded, the protection valve controller 2354 can cause the solenoid valve 3502 to pump hydraulic fluid into the second input 3510 of the second ground valve assembly 3505 to further move the beta tube 3345a into a ground pitch angle.

The second ground valve assembly 3505 of FIG. 35 is a cylindrical valve assembly that includes the first input 3509 connected to the third port 3335 of the sleeve 3320. The second ground valve assembly 3505 further includes the second input 3510 connected to the output 3504 of the first ground valve assembly 3500. The second ground valve assembly 3505 further includes the first output 3511 connected to a drain and the second output 3512 connected to the first gallery 3342 via the first port 3339 of the hydraulic fluid transfer unit 338.

The second ground valve assembly 3505 of FIG. 35 includes the valve spool 3506 structured to move from a first position to a second position. For example, when hydraulic fluid from the first ground valve assembly 3500 is being pumped into the second input 3510, the hydraulic fluid causes the valve spool 3506 to move rearward in the orientation of FIG. 35. When fluid from the first ground valve assembly 3500 is not pumped into the second input 3510, the hydraulic fluid is drained via the first output 3511, causing the valve spool 3506 to move forward in the orientation of FIG. 35. The valve spool 3506 is a cylindrical valve spool that includes solid portions and open portions (also referred to as open areas). The open portions of the valve spool 3506 make up the passages 3507, 3508. The passages 3507, 3508 are separated so that any hydraulic fluid in one passage cannot directly flow into another passage within the second ground valve assembly 3505. In some positions (e.g., locations), one or more solid portions of the valve spool 3506 can block or plug one or more of the inputs 3509, 3510 or the outputs 3511, 3512. In other positions, one or more of the solid portions of the valve spool 3506 do not block or plug one or more of the inputs 3509, 3510 or the outputs 3511, 3512, allowing the hydraulic fluid to flow into and/or out of one or more of the passages 3507, 3508.

When the valve spool 3506 of FIG. 35 is in the position of FIG. 35 (e.g., with hydraulic fluid being pumped into the second input 3510 because the protection valve controller 2354 causes the first ground valve assembly 3500 to open), the first input 3509 opens the first passage 3507 and the second passage 3508 opens to the second output 3512. Thus, any hydraulic fluid in the second passage 3508 is pumped into the first gallery 3342. Thus, when the valve spool 3506 is in the position of FIG. 35, the beta tube 3345a is allowed to move the blade 2200 into the ground pitch angle through hydraulic fluid being pumped into the fine pitch chamber 3347 via the connections 3346 and the gallery 3342. When the first ground valve assembly 3500 is closed, the first ground valve assembly 3500 does not pump hydraulic fluid into the second input 3510 of the second ground valve assembly 3505 to cause the valve spool 3506 to move to a second position, as further described below in conjunction with FIG. 36.

FIG. 36 illustrates the valve spool 3506 in a second position corresponding to enabling the beta tube 3345a from moving to a position corresponding to an in-flight pitch angle.

When the protection valve controller 2354 determines that the aircraft is in flight and locks the ability for the blade 2200 to move to the ground pitch angle, the protection valve controller 2354 outputs a control signal to the valve spool position controller 3319 via the component interface 2360 to cause the valve spool 3321 of the sleeve 3320 to move to the flight/ground range enable position. Additionally, the protection valve controller 2354 outputs a control signal to the ground valve position controller 3501 of the first ground valve assembly 3500 via the component interface 2360 to prevent the solenoid valve 3502 from pumping hydraulic fluid at the input 3503 to the second input of the second ground valve assembly 3505 via the output 3504.

As described above, when hydraulic fluid is not pumped into the second input 3510 of the second ground valve assembly 3505, the valve spool 3506 moves to the position of FIG. 36 (e.g., forward). In the position of FIG. 36, the first input 3509 opens up to the second passage 3508 and the second passage 3508 does not open to the second output 3512. Accordingly, even when the sleeve 3320 is pumping hydraulic fluid out from the third port 335, the hydraulic fluid will not be able to enter the first gallery 3342, thereby preventing the blade 2200 from reaching a ground pitch angle.

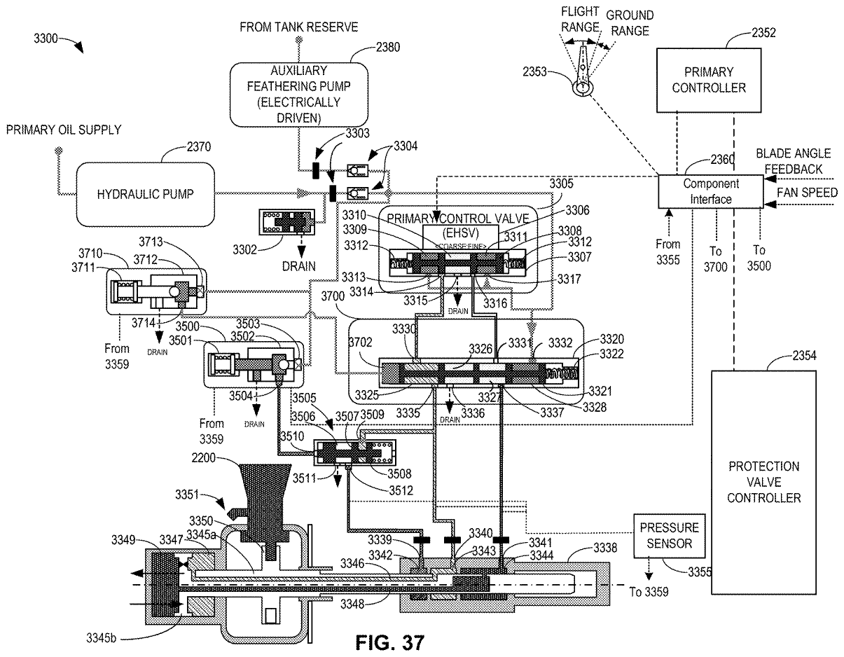

FIG. 37 illustrates an alternative example implementation of the pitch control protection system 3300 of FIG. 31. In FIG. 37, the protection valve assembly 3318 of FIG. 31 is replaced with an alternative protection valve assembly 3700 (also referred to as a spool valve) including a chamber 3702. The protection valve assembly 3700 does not include the spool valve position controller 3319. Rather, the position/location of the valve spool 3321 depends on the single spring 3322 or the output of a spool position valve assembly 3710. The spool position valve assembly 3710, includes an example valve position controller 3711, an example solenoid valve 3712, an example input 3713, and an example port 3714.

The spool position valve assembly 3710 of FIG. 37 includes the input 3713 connected to the hydraulic pumps 2370, 2380 via the strainers 3303 and the NRVs 3304. The spool position valve assembly 3710 further includes the port 3714 connected to the chamber 3702 of the protection valve assembly 3700. Additionally, the spool position valve controller 3711 is connected to the protection valve controller 2354 via the component interface 2360 (e.g., through a wired or wireless network connection).

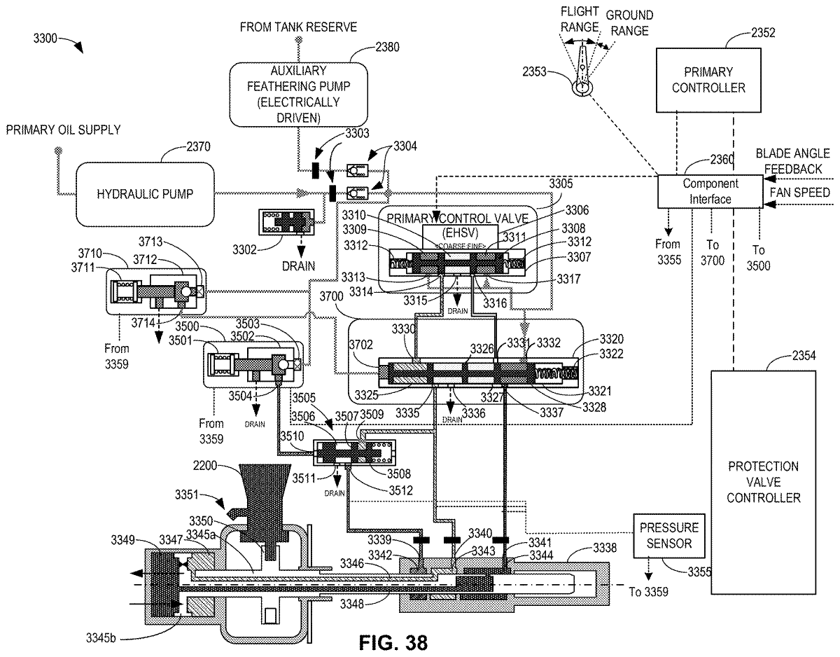

The spool position valve assembly 3710 includes the spool position valve controller 3711 to control the solenoid valve 3712 to allow hydraulic fluid to flow from the input 3713 to port 3714 or allow hydraulic fluid to flow from port 3714 to drain. The spool position valve controller 3711 obtains a control signal from the protection valve controller 2354 via the component interface 2360. The control signal may be a first or second amount of current. For example, if no current is applied to the spool position valve controller 3711, the spool position valve controller 3711 controls the solenoid valve 3712 (also referred to as a GBE solenoid) of the spool position valve assembly 3710 to allow hydraulic fluid to flow out from the port 3714 into the chamber 3702 of the protection valve 3700. When a threshold amount of current is applied to the spool position valve controller 3711, the spool position valve controller 3711 moves a valve spool of the solenoid valve 3712 to block the hydraulic fluid from flowing into the input 3713 and allow hydraulic fluid from the port 3714 to drain, as shown in FIG. 38.

In FIG. 37, the spool position valve controller 3711 has received a signal to open the spool valve assembly 3710. When the spool position valve assembly 3710 is open, the spool position valve assembly 3710 allows hydraulic fluid to flow and/or to be pumped from the outputs of one or more of the NRVs 3304 into the chamber 3702 of the protection valve 3700. The pressure of the hydraulic fluid is enough to overcome the pressure of the spring 3322 to cause the spool 3321 to be in the first position of FIG. 37. The first position of FIG. 37 corresponds to the first position of FIG. 31 (e.g., where hydraulic fluid to/from the first port 3330 can flow to/from the third port 3335 and hydraulic fluid to/from the second port 3331 can flow to/from the fourth port 337).

Although the protection valve 3318 of FIGS. 31-34 can be controlled to move the spool 3321 to be located into four positions/locations, the protection valve 3700 can be controlled by hydraulic fluid being pumped into the chamber 3702 or can be controlled by the spring 3322 to move the spool 3321 to be located into two locations (e.g., the first location of FIG. 37 corresponding to the flight/ground range enable location of FIG. 31 and the second location of FIG. 38 corresponding to the maximum drive source location of FIG. 34).

FIG. 38 illustrates the alternative example implementation of the pitch control protection system 3300 of FIG. 37 with the spool 3321 in a second position corresponding to maximum drive coarse (e.g., which corresponds to the position of the spool 3321 in FIG. 34).

The spool position valve assembly 3710 includes the spool position valve controller 3711 to control the solenoid valve 3712 to allow hydraulic fluid to flow from the input 3713 to port 3714 or allow hydraulic fluid to flow from port 3714 to drain. The spool position valve controller 3711 obtains a control signal from the protection valve controller 2354 via the component interface 2360. The control signal may be a first or second amount of current. For example, when a threshold amount of current is applied to the spool position valve controller 3711, the spool position valve controller 3711 moves a valve spool of the solenoid valve 3712 to block the hydraulic fluid from flowing into the input 3713 and cause hydraulic fluid from the chamber 3702 to flow out through the drain through port 3714.

In FIG. 38, the spool position valve controller 3711 has received a signal to close the spool valve assembly 3710. When the spool position valve assembly 3710 is closed, the spool position valve assembly 3710 prevents/blocks hydraulic fluid into the input 3713 and allows hydraulic fluid from the port 3714 to flow to the drain. Thus, hydraulic fluid is not pumped into the chamber 3702 of the protection valve 3700. Accordingly, there is little to no pressure in the chamber 3702, allowing the spring 3322 to push the spool 3321 to the left (in the orientation of FIG. 38) to the maximum drive coarse position. The movement of the spool 3321 can cause hydraulic fluid previously in the chamber 3702 to flow back into the port 3714 and out from toward a drain. The second (maximum drive coarse) position of FIG. 38 corresponds to the fourth position of FIG. 34 (e.g., where hydraulic fluid from the input 3332 can flow to the fourth port 3337 and into the coarse pitch chamber 3349).

In the disclosed examples, the valve spool 3308 of the primary control valve assembly 3305 can move to cause hydraulic fluid to be output via the first and third outputs 3314, 3316 to enable adjustments to blade pitch. In some examples, the valve spool 3308 and the valve spool 3321 of the protection valve assembly 3318 can move at the same time or substantially the same time. For example, while the primary control valve assembly 3305 operates to control pitch, the protection valve controller 2354 can override the actions of the primary control valve assembly 3305 if the protection valve controller 2354 detects, for example, a primary system malfunction.

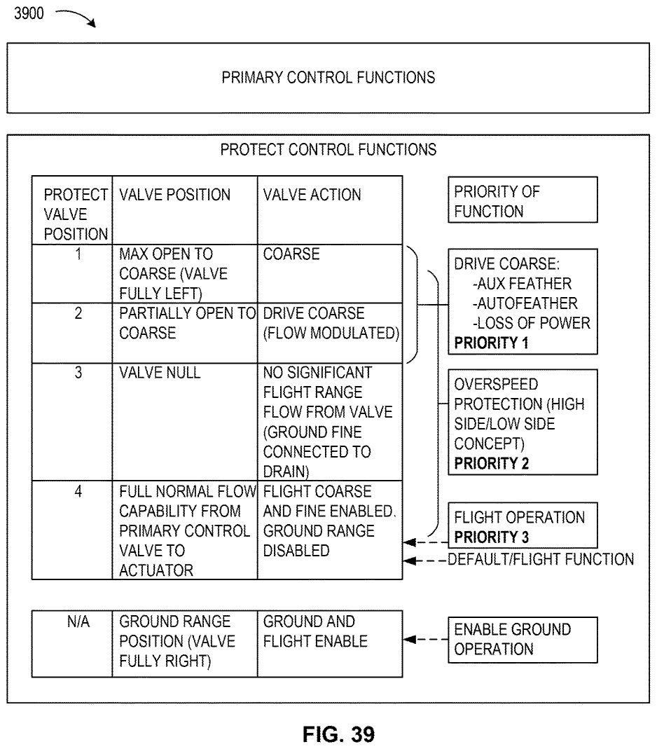

FIG. 39 illustrates the example protect control functions 3900 that can be implemented by the protection valve controller 2354 to control the position of the valve spool 3321 in the protection valve assembly 3318, the ground valve assembly 3360, 3500, and/or the spool position valve assembly 3710 of FIGS. 31-38. FIG. 39 includes five functions 3900 that correspond to the valve spool positions of FIGS. 31-38, namely, a maximum drive coarse position, a partial drive coarse position, a valve null position, a flight range position, and a ground range enabled position. For example, protect valve position 1 corresponds to placing the valve spool 3321 of the sleeve 3320 into the maximum drive coarse position illustrated in FIGS. 34 and 38. Protect valve position 2 corresponds to placing the valve spool 3321 of the sleeve 3320 into the partial drive coarse position illustrated in FIG. 32. Protect valve position 3 corresponds to placing the valve spool 3321 of the sleeve 3320 into the valve null position illustrated in FIG. 33. Protect valve position 4 corresponds to placing the valve spool 3321 of the sleeve 3320 into the flight/ground range position illustrated in FIGS. 31 and 37. In protect valve position 4, to enable ground range, the protection valve controller 2354 causes the ground valve assembly 3360, 3500 to open to enable hydraulic fluid to be able to be pumped into the first gallery 3342 to enable the additional hydraulic fluid to pump into the fine pitch chamber 3347 to move the blade 2200 into the ground pitch range, as further described above. Also, the valve spool 3321 of the sleeve 3320 can be placed into the ground range enabled position as disclosed in connection with FIGS. 35 and 36.

The protection valve controller 2354 outputs a different signal (e.g., a different amount of current) to the valve spool position controller 3319 via the component interface 2360 to cause the valve spool 3321 to move to one of the four valve positions and/or to cause the ground valve assembly 3360, 3500 to open or close. In some examples, the protection valve controller 2354 outputs a binary signal to the valve position controller 3711 via the component interface 2360 to cause the spool position valve assembly 3710 to output or block hydraulic fluid to/from the chamber 3702 of the protection valve 3700 to cause the valve spool 3321 to move to one of two valve positions. As described above, the protection valve controller 2354 moves the valve spool 3321 to the first position to cause the blade 2200 to move to a coarse pitch angle. The protection valve controller 2354 moves the valve spool 3321 to the second position to cause the blade 2200 to move to a coarse pitch angle at a slower pace than the pace associated with the maximum drive coarse position. The protection valve controller 2354 moves the valve spool 3321 to the third position to cause the blade 2200 to not move or to be controlled by the counterweight 3351. The protection valve controller 2354 moves the valve spool 3321 to the fourth position to cause the blade 2200 to move to a pitch angle based on the fluid output from the primary sleeve 3307 and/or to enable the blade 2200 to reach a ground pitch angle (e.g., when the ground valve assembly 3360, 3500 is open/enabled).

By default, the protection valve controller 2354 outputs a signal to the valve spool position controller 3319 of the sleeve 3320 or the valve position controller 3711 of the protection valve 3700 via the component interface 2360 to cause the valve spool 3321 to move to the fourth position, the full default (e.g., normal) flow capability position corresponding to FIGS. 3 and 9. When the protection valve controller 2354 determines that the fan speed is too high (e.g., relative to an overspeed limit) or the pitch of the blade 2200 is lower than intended (e.g., relative to a pitch threshold), the protection valve controller 2354 changes the signal to cause the valve spool 3321 to move to the third position (e.g., the valve null position) or the first position (e.g., maximum drive coarse position). When the protection valve controller 2354 determines that the fan speed has lowered (e.g., relative to an overspeed limit) or the pitch of the blade is higher (e.g., relative to a pitch threshold), the protection valve controller 2354 may change the signal back to move the valve spool 3321 back to the default (e.g., normal) flow/flight range position. When the protection valve controller 2354 determines that the fan speed is still too high (e.g., relative to an overspeed limit) or the pitch of the blade is still too low (e.g., relative to a pitch threshold), the protection valve controller 2354 changes the signal to the partial drive coarse position (e.g., position 2). When the protection valve controller 2354 determines that the fan speed has lowered (e.g., relative to an overspeed limit) or the pitch of the blade is higher (e.g., relative to a pitch threshold), the protection valve controller 2354 may change the signal back to move the valve spool 3321 back to the valve null position. When the protection valve controller 2354 determines that the fan speed is still too high (e.g., relative to an overspeed limit) or the pitch of the blade is still too low (e.g., relative to a pitch threshold), the protection valve controller 2354 changes the signal to a signal corresponding to the maximum drive coarse position (e.g., position 1). The protection valve controller 2354 maintains the signal corresponding to the maximum drive coarse position until the fan speed slows by a particular amount or the pitch of the blade increases by a particular amount. The protection valve controller 2354 executes control algorithm(s) that output signal demand(s) to, for example, the protection valve assembly 3318, for position(s) between the default (e.g., normal) flow/flight range position and the fully drive coarse position. The control algorithm(s) can include a Proportional-Integral-Derivative (PID) algorithm that calculates a control error from desired outputs and a valve position request. For example, if a speed increase exceeds an overspeed limit, the PID algorithm determines an amount to open the valve 3318 as a function of how fast the fan is accelerating and the amount the fan has accelerated. The control algorithm(s) executed by the protection valve controller 2354 continue to modulate the valve position to stabilize speed at a speed set point.

If there are contradictory instructions or feedback obtained via the component interface 2360, the protection valve controller 2354 utilizes a priority of positions to determine a position of the valve spool 321. The highest priority (e.g., priority 1) corresponds to driving coarse due for auxiliary (e.g., feathering caused by an electrically driven pump from a reserve oil supply), feathering, auto-feathering, and/or loss of power, the second highest priority (e.g., priority 2) corresponds to overspeed protection, and the lowest priority (e.g., priority 3) corresponds to default (e.g., normal) flight operation and/or ground operation. For example, when the aircraft is operating in flight operation (e.g., priority 3), the protection valve controller 2354 outputs a signal to move the valve spool 3321 via the component interface 2360 when a higher priority functionality is triggered. When the aircraft is operating in overspeed protection mode (e.g., priority 2) because the protection valve controller 2354 has determined that the fan speed is too high, as described above, the overspeed protection mode takes priority over a pilot selected flight operation mode. Thus, the protection valve controller 2354 may override the primary control valve assembly 3305 using one of the protect valve positions 1-4 to reduce fan speed. In the overspeed protection mode, the amount of opening of the protection valve 3318 (e.g., a proportional servo valve) is a function of fan overspeed at a point in time as computed by the protection valve controller 2354 (e.g., proportional valve position versus input signal). Thus, the amount of opening of the protection valve 3318 can be anywhere between protect valve positions 1-4. When ground mode is enabled, then the protection valve controller 2354 outputs a signal via the component interface 2360 to move the valve spool 3321 into the flight/ground range position and the ground valve assembly 3360, 3500 is enabled unless auxiliary feathering, auto-feathering, or loss of power occurs. When drive coarse is enabled, the protection valve controller 2354 outputs a signal via the component interface 2360 to move the valve spool 3321 to the maximum drive coarse position or the partial drive coarse position regardless of instructions from a pilot or the system.

Referring again to the block diagram of the protection valve controller 2354 of FIG. 29 and in connection with the example pitch control system 3300 of FIGS. 31-38, the interface(s) 2900 obtain(s) information from the primary controller 2352 (e.g., pilot instructions, flight modes, autopilot instructions, etc.) via the component interface 2360. Additionally, the interface(s) 2900 obtain(s) feedback information from one or more sensors that relates to the blade 2200 via the component interface 2360. For example, the interface(s) 2900 can obtain fan speed, pitch angles measurements of the blade 2200, and/or sensor readings from the pressure sensor 3355. The interface(s) 2900 may include one interface to obtain all signals, or multiple interface(s) 2900 to obtain the multiple signals.

Also, in connection with the example pitch control system 3300 of FIGS. 31-38, the drivers 2902 drive the valve spool position controller 3319 to move the valve spool 3321 to one or more particular positions and/or drive the ground valve assembly 3360, 3500 to enable or disable the ground valve assembly 3360, 3500. For example, a first one of the drivers 2902 is capable of outputting different amounts of current, each amount of current corresponding to moving the valve spool 3321 to a different position and a second one of the drivers 2902 is capable of a high current signal or a low (e.g., zero) current signal corresponding to enabling or disabling the ground valve assembly 3360, 3500. The drivers 2902 are controlled by the valve controller 2904.

In connection with the example pitch control system 3300 of FIGS. 31-38, the valve controller 2904 determines a position for the valve spool 3321 based on flight mode, pilot instructions, system instructions, autopilot instructions, feedback information, etc. By default, the valve controller 2904 determines the position for the valve spool 3321 to be the flight/ground range position of FIG. 31. However, when the valve controller 2904 determines that overspeed protection is needed, the valve controller 2904 determines a different position for the valve spool (e.g., corresponding to FIGS. 32-38), as further described above. When the valve controller 2904 obtains an indication that ground operation has been enabled (e.g., the aircraft is grounded), the valve controller 2904 determines the position for the valve spool 3321 to be the flight/ground range position of FIGS. 31 and 37 and enables the ground valve assembly 3360, 3500, as further described above. When the valve controller 2904 obtains an indication to drive coarse (e.g., due to loss of power, auto-feathering instructions, auxiliary feathering instructions, etc.), the valve controller 2904 determines the position for the valve spool 3321 to be the maximum drive coarse position of FIGS. 34 and 38 or the partial drive coarse position of FIG. 32. Additionally, the valve controller 2904 may determine that there is a friction issue, a valve issue, or an issue with the counterweight 3351, based on one or more pressure measurements from the pressure sensor 3355, as further described above. The valve controller 2904 can trigger alerts based on the determined issue(s). The valve controller 2904 controls the driver 2902 based on the determined valve spool position.

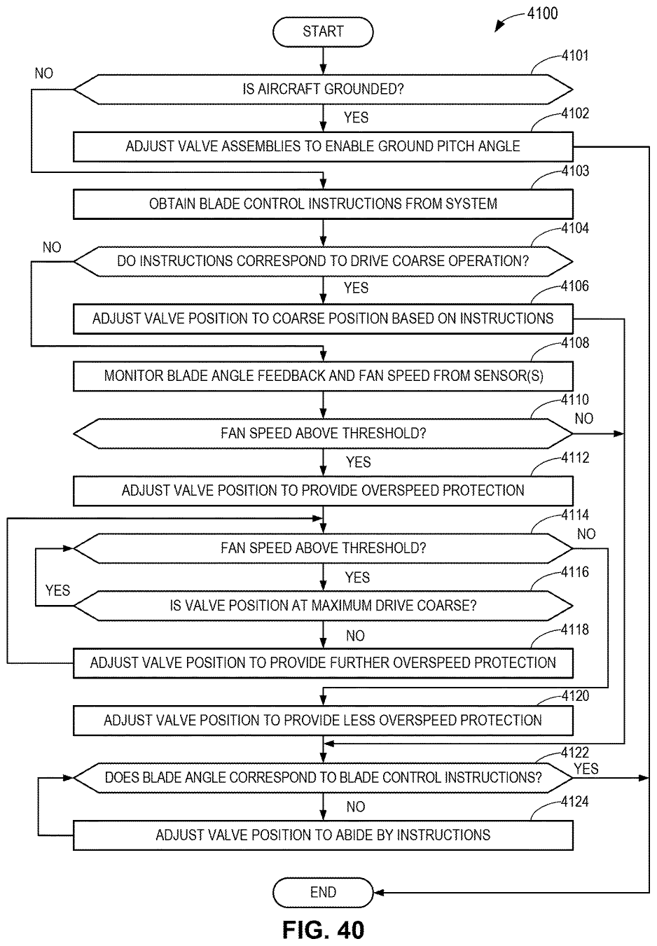

FIG. 40 is a flowchart representative of example machine-readable instructions and/or example operations 4100 that may be executed, instantiated, and/or performed by programmable circuitry (e.g., the protection valve controller 2354 of FIG. 29) to control the pitch control protection system 3300 of FIGS. 31-38. The example machine-readable instructions and/or the example operations 1300 of FIG. 40 begin at block 4101, at which valve controller 2904 determines whether the aircraft is grounded. For example, the valve controller 2904 can obtain data from sensors and/or obtain a signal from the FADEC 180 and/or the primary controller 2352 to indicate that the aircraft is grounded. When the valve controller 2904 determines that the aircraft is grounded (block 4101: YES), the valve controller 2904 causes the drivers 2902 to output control signals to the valve spool position controller 3319, the ground valve position controller 3361, and/or the spool position valve controller 3711 to cause the valve spool 3321 to move to the flight/ground position of FIG. 31 and enable/open the ground valve assemblies 3360, 3500 to enable hydraulic fluid to enter the first gallery 3342 of the hydraulic fluid transfer unit 3338 (block 4102).

If the valve controller 2904 determines that the aircraft is not grounded (e.g., is in flight) (block 4101: NO), the interface(s) 2900 obtains blade control instructions from the system (e.g., from the primary controller 2352) (block 4103). The blade control instructions may identify whether the aircraft is in flight or grounded, the operation mode of the aircraft (e.g., takeoff, autopilot, landing, etc.), instructions and/or triggers (e.g., auto-feathering instruction, power loss instructions, pilot instructions, etc.), etc. When no instructions are obtained, one of the drivers 2902 drives the valve spool 3321 of the sleeve 3320 to the flight/ground range position of FIG. 31 (e.g., the default position). In some examples, if no instructions are obtained, the one or more drivers 2902 do not output a signal and the springs 3322 position the valve spool 3321 to the flight/ground range position of FIG. 31.

At block 4104, the valve controller 2904 determines whether the instructions correspond to ground enable operation or drive coarse operation. As described above, ground enable operation is enabled when the aircraft is grounded and coarse operation may be based on a trigger (e.g., power loss, auto-feathering, auxiliary feathering, etc.). When the valve controller 2904 determines that the instructions do not correspond to ground operation of drive coarse operation (block 4104: NO), control continues to block 4108, as further described below. When the valve controller 2904 determines that the instructions correspond to ground operation or drive coarse operation (block 4104: YES), the valve controller 2904 causes the driver 2902 to output a control signal to the valve spool position controller 3319 of the protection valve assembly 3318 or the spool position valve controller 3711 to adjust the position of the valve spool 3321 to the ground position of FIG. 35 (e.g., when the instructions correspond to ground operation) or the maximum drive coarse or partial drive coarse position of FIG. 33, 34, or 38 (e.g., when the instructions correspond to drive coarse operation) (block 4106). As described above, drive coarse operation is based on a power loss event, an auto-feathering event, an auxiliary feathering event, etc. and ground operation corresponds to when the aircraft is grounded or not in flight.

At block 4108, the valve controller 2904 monitors the blade angle feedback information and/or fan speed from one or more sensor(s) (e.g., obtained via the interface(s) 2900). At block 4110, the valve controller 2904 determines whether the fan speed is above a threshold (e.g., between 102%-105% of the takeoff fan speed, where the fan speed may be 850 to 200 revolutions per minute, depending on fan diameter). When the valve controller 2904 determines that the fan speed is not above a threshold (block 4110: NO), control continues to block 4122, as further described below. When the valve controller 2904 determines that the fan speed is above a threshold (block 4110: YES), the valve controller 2904 causes the driver 2902 to output a signal to the valve spool position controller 3319 of the protection valve assembly 3318 or spool position valve controller 3711 to adjust the position of the valve spool 3321 to provide overspeed protection (block 4112). For example, the valve controller 2904 can cause the valve spool 3321 of the protection valve assembly 3318 to move (a) from the flight/ground range position of FIG. 31 to the valve null position of FIG. 33, (b) from the valve null position of FIG. 33 to the partial drive coarse position of FIG. 32, or (c) from the partial drive coarse position of FIG. 32 to the maximum drive coarse position of FIG. 34, causing the blade to either stop adjusting pitch angle or increasing the pitch angle to a coarser pitch angle.

At block 4114, the valve controller 2904 determines whether the fan speed is still above the threshold. When the valve controller 2904 determines that the fan speed is no longer above the threshold (block 4114: NO), the valve controller 2904 causes the driver 2902 to output a control signal to the valve spool position controller 3319 of the protection valve assembly 3318 or the spool position valve controller 3711 to cause the valve spool 3321 to provide less overspeed protection (block 4120) and control continues to block 4122, as further described below. For example, the valve controller 2904 can output a control signal to cause the valve spool 3321 to move to the flight/ground range position of FIG. 31. When the valve controller 2904 determines that the fan speed is still above the threshold (block 4114: YES), the valve controller 2904 determines whether the current position of the valve spool 3321 is at the maximum drive coarse position of FIG. 34 (block 4116). When the valve spool position is not at maximum drive coarse position, the valve spool 3321 can be moved to provide additional overspeed protection (i.e., because the valve spool position has not yet reached the maximum drive coarse position). If the valve controller 2904 determines that the current position of the valve spool 3321 is at the maximum drive coarse position of FIG. 34 (block 4116: YES), control returns to block 4114 for continued monitoring of whether the fan speed is still above the threshold. Control proceeds to block 4120 when the valve controller 2904 determines that the fan speed is no longer above the threshold, at which time the valve spool 3321 can be moved to provide less overspeed protection.

At block 4122, the valve controller 2904 determines whether the blade angle corresponds to the blade control instructions. The valve controller 2904 may process the blade control instructions and determine whether the blade pitch angle projected to a pitch angle that corresponds to the blade control instructions. For example, when the blade control instructions correspond to adjusting the pitch angle of the blade 2200 to a coarse pitch but the blade pitch is moving toward a fine pitch angle, the valve controller 2904 determines that the blade angle does not correspond to the blade control instructions. In another example, when the blade control instructions correspond to adjusting the pitch angle of the blade 2200 to a coarse pitch but the blade pitch is adjusting at a rate below a threshold rate, the valve controller 2904 determines that the blade angle does not correspond to the blade control instructions. When the valve controller 2904 determines that the blade angle corresponds to the blade control instructions (block 4122: YES), the instructions 4100 end. When the valve controller 2904 determines that the blade angle does not correspond to the blade control instructions (block 4122: NO), the valve controller 2904 causes the driver 2902 to output a control signal to the valve spool position controller 3319 or the spool position valve controller 3711 to adjust the position of the valve spool 3321 in the sleeve 3320 to abide by the instructions (block 4124). The instructions 4100 end when the valve controller 2904 determines that the blade angle corresponds to the blade control instructions (block 4122: YES).

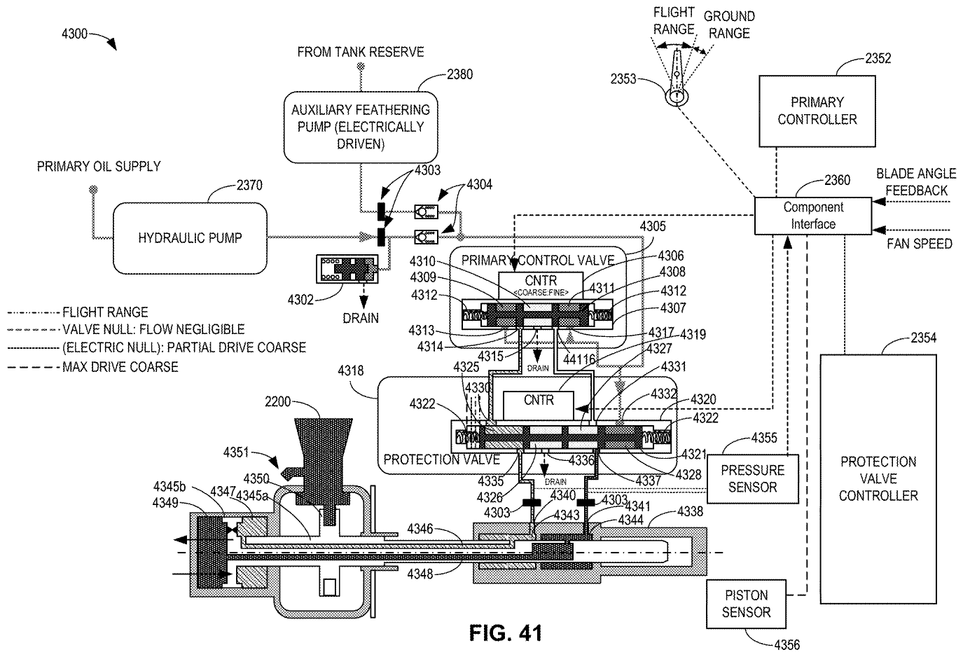

FIG. 41 illustrates an example implementation of a third pitch control protection system 4300. The pitch control protection system 4300 includes the hydraulic pump 2370, the auxiliary hydraulic pump 2380, a pressure relief valve 4302, strainers 4303, no return valves 4304, and a primary control valve assembly 4305 (also referred to as a servo valve or an electrohydraulic servo valve (EHSV)). The primary control valve assembly 4305 includes a valve spool position controller 4306; a primary sleeve 4307; a valve spool 4308; passages 4309, 4310, 4311 (also referred to as a first passage 4309, a second passage 4310, and a third passage 4311); springs 4312; inputs 4313, 4317 (also referred to as a first input 4313 and a second input 4317); and outputs 4314, 4315, 4316 (also referred to as a first output 4314, a second output 4315, and a third output 4316). The pitch control protection system 4300 further includes a protection valve assembly 4318 (also referred to as a servo valve or an electrohydraulic servo valve (EHSV)). The protection valve assembly 4318 includes a valve spool position controller 4319; a sleeve 4320; a valve spool 4321; springs 4322; passages 4325, 4326, 4327, 4328 (also referred to as a first passage 4325, a second passage 4326, a third passage 4327, and a fourth passage 4328); ports (e.g., inputs and/or outputs) 4330, 4331, 4335, 4337 (also referred to as a first port 4330, a second port 4331, a third port 4335, and a fourth port 4337); an input 4332; and an output 4336. The pitch control protection system 4300 further includes a hydraulic fluid transfer unit 4338. The hydraulic fluid transfer unit 4338 is a dual acting hydraulic pitch actuator. The hydraulic fluid transfer unit 4338 includes ports (e.g., inputs and/or outputs) 4340, 4341 (also referred to as a first port 4340 and a second portion 4341); galleries 4343, 4344 (also referred to as a first gallery 4343 and a second gallery 4344); an example beta tube 4345a, which includes a piston 4345b and connections 4346, 4348 (also referred to as a fine pitch chamber connection 4346 and a coarse pitch chamber connection 4348); chambers 4347, 4349 of the pitch change actuator on either side of the piston 4345b (also referred to as a fine pitch chamber 4347 and a coarse pitch chamber 4349); a crosshead 4350; a counterweight 4351; the primary controller 2352; the protection valve controller 2354; one or more pressure sensors 4355, and a piston sensor 4356. As used herein, inputs may be referred to as ports, inputs, inlets, input connections, inlet connection, input terminals, inlet terminals, etc. As used herein, outputs may be referred to as ports, outputs, outlets, output connections, outlet connection, output terminals, outlet terminals, etc. Components that are connected via a solid line are connected via a connection, a tube, a hose, a pipe, and/or other device that can transport fluid. Components that are connected via a dashed line are connected via an electrical connection (e.g., a wired connection, such as a wire, an etch, etc. or a wireless connection). In FIG. 41, the valves 4302, 4305, 4318, and the hydraulic fluid transfer unit 4338 are illustrated as cross sections of the respective components. The example pitch control protection system 4300 of FIG. 41 can be implemented with the blade 140 of the turbofan engine 110 of FIG. 1, the blade 254 of the turbofan engine 210 of FIG. 2, or with other types of turbo engine assemblies hybrid engine assemblies, electric propulsion assemblies, etc.

The hydraulic pump 2370 of FIG. 41 is a conveyer of hydraulic power that pumps a hydraulic fluid. The hydraulic pump 2370 acts as a pressure vessel to cause hydraulic fluid to flow (e.g., to be pumped) into the primary control valve assembly 4305 and/or the protection valve assembly 4318. The hydraulic fluid may be an oil-based fluid, a silicone-based fluid, a synthetic hydrocarbon-based fluid, and/or other type of hydraulic fluid.

The auxiliary hydraulic pump 2380 of FIG. 41 is a conveyer of hydraulic power that pumps a hydraulic fluid when the hydraulic fluid from the hydraulic pump 2370 is insufficient (e.g., due to a loss of primary oil supply). One or both of the hydraulic pumps 2370, 2380 cause(s) hydraulic fluid to flow (e.g., to be pumped) into the primary control valve assembly 4305 and/or the protection valve assembly 4318. The hydraulic fluid may be an oil-based fluid, a silicone-based fluid, a synthetic hydrocarbon-based fluid, and/or another type of hydraulic fluid.

The pressure relief valve 4302 of FIG. 41 keeps the pressure of the hydraulic fluid from the hydraulic pump 2370 below a threshold level (e.g., 1100 pounds per square inch (psi), etc.) by draining some of the hydraulic fluid toward a drain when the hydraulic fluid is above the threshold level. The pressure relief valve 4302 reduces the pressure of the hydraulic fluid to prevent pressure-induced damage when causing the hydraulic fluid to flow into other components of the pitch control protection system 4300. In some examples, the pressure relief valve 4302 is implemented within the hydraulic pump 2370.

The strainers 4303 of FIG. 41 strain the hydraulic fluid to block contaminants in the hydraulic fluid that may damage or jam the valves 4304, 4305, 4318. Although FIG. 41 has four strainers 4303, there may be any number of strainers. The no return valves (NRVs) 4304 are valves that prevent hydraulic fluid from returning back to the hydraulic pumps 2370, 2380.

The primary control valve assembly 4305 of FIG. 41 allows or prevents hydraulic fluid from the hydraulic pumps 2370, 2380 into the coarse pitch chamber 4349 and the fine pitch chamber 4347 via one or more of the connections 4346, 4348 of the beta tube 4345a based on a position of the valve spool 4308. The primary control valve assembly 4305 includes the valve spool position controller 4306. The valve spool position controller 4306 obtains an electrical signal (e.g., a current) from the primary controller 2352. The valve spool position controller 4306 moves the valve spool 4308 based on the electrical signal (e.g., based on the amount of current). For example, the valve spool position controller 4306 moves the valve spool 4308 to a first position based on obtaining a first current and moves the valve spool 4308 to a second position based on a second current. In some examples, the valve spool position controller 4306 may be a direct drive valve (also referred to as a proportional valve). In such examples, the valve spool 4308 is moved by an electric means (e.g., a linear motor, a stepper type motor, etc. through a gear drive with electronic feedback). As further described below, the primary controller 2352 generates the signal based on instructions from a pilot and/or based on instructions from one or more of a FADEC, a separate controller (e.g., a fan electronic controller), a separate control box, etc.

The primary sleeve 4307 of FIG. 41 is a cylindrical valve that includes the valve spool 4308. The valve spool 4308 is a cylindrical valve spool that fits within the primary sleeve 4307 and includes solid portions and open portions (also referred to as open areas). The open portions of the valve spool 4308 make up the passages 4309, 4310, 4311. The passages 4309, 4310, 4311 are separated so that any fluid in one passage cannot directly flow into another passage within the primary sleeve 4307. The valve spool 4308 can move within a cavity of the primary sleeve 4307 between the springs 4312. In some positions (e.g., locations), one or more solid portions of the valve spool 4308 can block or plug one or more of the inputs 4313, 4317 or outputs 4314, 4315, 4316. In other positions, one or more of the solid portions of the valve spool 4308 do not block or plug one or more of the inputs 4313, 4317 or outputs 4314, 4315, 4316 allowing the hydraulic fluid to flow into and/or out of one or more of the passages 4309, 4310, 4311.

The first input 4313 of the primary sleeve 4307 is connected to the hydraulic pumps 2370, 2380 (e.g., via the strainers 4303 and the NRVs 4304), the second input 4317, and the input 4332 of the sleeve 4320 of the protection valve assembly 4318. The first output 4314 is connected to the first port 4330 of the sleeve 4320. The second output 4315 is connected to a drain. The third output 4316 is connected to the second port 4331 of the sleeve 4320. The second input 4317 is connected to the hydraulic pumps 2370, 2380 (e.g., via the strainers 4303 and the NRVs 4304), the first input 4313, and the input 4332 of the sleeve 4320.

When the valve spool 4308 is in the position of FIG. 41, the first and third outputs 4314, 4316 are blocked by the valve spool 4308. Accordingly, the primary sleeve 4307 does not output hydraulic fluid to either the fine pitch chamber 4347 or the coarse pitch chamber 4349.

When the valve spool 4308 is moved forward in the orientation of FIG. 3, the first output 4314 of the primary sleeve 4307 opens into the second passage 4310 and the second passage 4310 opens to a drain via the second output 4315 of the primary sleeve 4307. Thus, no hydraulic fluid is pumped from the first output 4314 to the sleeve 4320. As described above, the term “forward” refers to a direction along the centerline axis 108 in the direction of movement of turbo engine assembly 100, such as to the left in FIG. 41, while the term “rearward” refers to a direction along the centerline axis 108 in the opposite direction, such as to the right in FIG. 41. Additionally, when the valve spool 4308 is moved forward in the orientation of FIG. 41, the second input 4317 of the primary sleeve 4307 opens into the third passage 4311 and the third passage 4311 opens into the second port 4331 of the sleeve 4320 via the third output 4316 of the sleeve 4320. Thus, the hydraulic fluid from the hydraulic pump(s) 2370, 2380 is pumped into the second port 4331 of the sleeve 4320 via the second input 4317 of the primary sleeve 4307 and the third passage 4311.

When the valve spool 4308 is moved rearward in the orientation of FIG. 41, the third output 4316 of the primary sleeve 4307 opens into the second passage 4310 and the second passage 4310 opens to a drain via the third output 4316 of the primary sleeve 4307. Thus, no hydraulic fluid is pumped from the third output 4316 to the sleeve 4320. Additionally, when the valve spool 4308 is moved rearward in the orientation of FIG. 41, the first input 4313 of the primary sleeve 4307 opens into the first passage 4309 and the first passage 4309 opens into the first port 4330 of the sleeve 4320 via the first output 4314 of the primary sleeve 4307. Thus, the hydraulic fluid from the hydraulic pump(s) 2370, 2380 is pumped into the first port 4330 of the sleeve 4320 via the first input 4313 of the primary sleeve 4307 and the first passage 4309.

The springs 4312 of FIG. 41 are structured to position the valve spool 4308 in a particular position when the valve spool position controller 4306 does not obtain a signal. In this manner, when there is a loss of signal or power, the springs 4312 causes the valve spool 4308 to move to a pre-selected position. In the example of FIG. 41, the springs 4312 are structured to move the valve spool 4308 to the position illustrated in FIG. 41, where the valve spool 4308 plugs the first and third outputs 4314, 4316. In some examples, one or more of the springs 4312 may be removed. For example, the spring 4312 on the left (with regards to the orientation of FIG. 41) of the sleeve 4307 may be removed. Removing the spring 4312 on the left provides greater chip-shearing capability in the desired direction. If there is no oil pressure in the first stage of the valve assembly 4305, the spring 4312 on the right (with regards to the orientation of FIG. 41) of the sleeve 4307 ensures the spool 4308 moves to connect fine pitch oil connected to drain, thereby allowing the counterweights 4351 to drive the blade 2200 coarse, as a failsafe.

The protection valve assembly 4318 of FIG. 41 allows or prevents hydraulic fluid from the primary sleeve 4307 and/or the hydraulic pumps 2370, 2380 into the coarse pitch chamber 4349 and the fine pitch chamber 4347 of the beta tube 4345a based on a position of the valve spool 4321. The primary control valve assembly 4305 includes the valve spool position controller 4319 to obtain an electrical signal (e.g., a current) from the protection valve controller 2354 via the component interface 2360. The valve spool position controller 4319 moves the valve spool 4321 based on the electrical signal (e.g., based on the amount of current). For example, the valve spool position controller 4319 moves the valve spool 4321 to a first position based on obtaining a first current, moves the valve spool 4321 to a second position based on a second current, etc. In some examples, the valve spool position controller 4319 may be a direct drive valve (also referred to as a proportional valve). In such examples, the valve spool 4321 is moved by an electric means (e.g., a linear motor, a stepper type motor, etc. through a gear drive with electronic feedback). As further described below, the protection valve controller 2354 generates the signal based on various data (e.g., fan speed, pressure sensor data, blade angle feedback, information from the primary controller 2352, etc.).

The valve spool 4321 of FIG. 41 is a cylindrical valve spool that fits within the cylindrical sleeve 4320 and includes solid portions and open portions. The open portions of the valve spool 4321 define (e.g., make up, correspond to, etc.) the passages 4325, 4326, 4327, 4328. The passages 4325, 4326, 4327, 4328 are separated so that any fluid in one passage cannot directly flow into another passage within the sleeve 4320. The valve spool 4321 can move within a cavity of the sleeve 4320 between the springs 4322. In some positions (e.g., locations), one or more solid portions of the valve spool 4321 can block or plug one or more of the ports 4330, 4331, 4335, 4337, the input 4332, or the output 4336. In other positions, one or more of the solid portions of the valve spool 4321 do not block or plug one or more of the ports 4330, 4331, 4335, 4337, the input 4332, or the output 4336 allowing the hydraulic fluid to flow into and/or out of one or more of the passages 4325, 4326, 4327, 4328. In some examples, one or more of the ports 4330, 4331, 4335, 4337 can be bi-directional (e.g., to allow hydraulic fluid to pass through the protection valve assembly 4318 in either direction).

The first port 4330 of FIG. 41 of the sleeve 4320 is connected to the first output 4314 of the primary sleeve 4307. The second port 4331 is connected to the third output 4316 of the primary sleeve 4307. The input 4332 is connected to the hydraulic pumps 2370, 2380 (e.g., via the strainers 4303, and the NRV 4304 and the first input 4313 and the second input 4317 of the primary sleeve 4307. The third port 4335 is connected to the first port 4340 of the hydraulic fluid transfer unit 4338. The output 4336 is connected to the drain. The fourth port 4337 is connected to the second port 4341 of the hydraulic fluid transfer unit 4338.

The valve spool position controller 4319 of FIG. 41 can move the valve spool 4321 into at least four different positions that correspond to four different actions based on a signal from the protection valve controller 2354 via the component interface 2360. For example, the valve spool 4321 can be moved to a maximum drive coarse position, a partial drive coarse position, a valve null position, and a flight/ground range position. The maximum drive coarse position corresponds to an automatic flow of hydraulic fluid at full pressure to the coarse pitch chamber 4349 of the valve spool assembly to cause the blade 2200 to move to a coarse and/or feathered pitch angle at a maximum rate. The partial drive coarse position corresponds to an automatic flow of hydraulic fluid at partial pressure to the coarse pitch chamber 4349 of the valve spool assembly to cause the blade 2200 to move to a coarse and/or feathered pitch angle at a rate less than maximum. The valve null position corresponds to preventing hydraulic fluid from flowing to either the coarse pitch chamber 4349 or the fine pitch chamber 4347 maintaining the pitch of the blade 2200. The flight/ground range position corresponds to control of the pitch angle based on the hydraulic fluid output by the primary sleeve 4307 and/or control of the pitch angle to the ground range. The ground range position corresponds to pumping hydraulic fluid into the fine pitch chamber 4347 to cause the blade 2200 to move to a ground pitch angle. In some examples, the ground pitch angle is restricted when the aircraft is in flight. Accordingly, as further described below, the protection valve controller 2354 can monitor the position of the beta tube 4345a of the hydraulic fluid transfer unit 4338 to prevent the beta tube 4345a from moving to a position that corresponds to a ground pitch angle of the blade 2200. The example of FIG. 41 is described in conjunction with the flight/ground range position. However, each position is illustrated in one of FIGS. 41-44.

In FIG. 41, the valve spool 4321 is in the flight/ground range position. In the flight/ground range position, the first port 4330 opens to the first passage 4325 and the third passage opens to the third port 4335. Thus, hydraulic fluid from the first port 4330 is pumped out of the third port 4335. The second port 4331 opens to the third passage 4327 and the third passage 4327 opens to the fourth port 4337. Thus, hydraulic fluid from the second port 4331 is pumped out of the fourth port 4337. The input 4332 opens to the fourth passage 4328 (which does not open to an output). The second passage 4326 opens to the output 4336 and the output 4336 opens to the drain. Thus, any fluid in the second passage 4326 is drained to the drain. Accordingly, in the flight/ground range position, hydraulic fluid from either the first output 4314 and/or third output 4316 of the primary sleeve 4307 is pumped into the hydraulic fluid transfer unit 4338 through the first passage 4325 and/or the third passage 4327 of the sleeve 4320.

The springs 4322 of FIG. 41 are structured to position the valve spool 4321 in the partial drive coarse position when the valve spool position controller 4319 does not obtain a signal. In this manner, when there is a loss of signal or power, the springs 4322 cause the valve spool 4321 to move to the partial drive coarse position. Because a coarse pitch angle is safer than a fine pitch angle in flight, the springs 4322 can be structured to position the valve spool 4321 into the partial drive coarse position. In some examples, one or more of the springs 4322 may be removed. For example, the spring 4322 on the left (with regards to the orientation of FIG. 3) of the sleeve 4320 may be removed. Removing the spring on the left provides greater chip-shearing capability in the desired direction. If there is no oil pressure in the first stage of the valve assembly 4318, the spring 4322 on the right (with regards to the orientation of FIG. 41) of the sleeve 4320 ensures the spool 4321 moves to connect fine pitch oil connected to drain, thereby allowing the counterweights 4351 to drive the blade 2200 coarse, as a failsafe.

Although the example of FIGS. 41-44 provide a particular structure for implementing the valve assembly 4318, there may be other ways to implement the valve assembly 4318 to perform the same and/or substantially similar functionality.

The hydraulic fluid transfer unit 4338 of FIG. 41 houses the beta tube 4345a and components structured to move the beta tube 4345a into different positions. In some examples, the hydraulic fluid transfer unit 4338 may be combined with one or more components of the pitch control protection system 4300. As further described below, as the beta tube 4345a moves, the pitch angle of the blade 2200 changes. The hydraulic fluid transfer unit 4338 includes a first port 4340, and a second port 4341. The first port 4340 is connected to the third port 4335 of the sleeve 4320 and the first gallery 4343. The second port 4341 is connected to the fourth port 4337 of the sleeve 4320 and the second gallery 4344. The galleries 4343, 4344 may be a 360-degree open space that connects the ports 4340, 4341 to the chambers 4347, 4349 via one or more of the fine pitch chamber connection 4346 or the coarse pitch chamber connection 4348. Accordingly, the galleries 4343, 4344 convey hydraulic fluid from one location to another. For example, hydraulic fluid pumped into the first gallery 4343 can be pumped into the fine pitch chamber 4347 when the beta tube 4345a is in a position where the first gallery 4343 opens to the fine pitch chamber connection 4346. Additionally, hydraulic fluid pumped into the second gallery 4344 can be pumped into the coarse pitch chamber 4349 when the beta tube 4345a is in a position where the second gallery 4344 opens to the coarse pitch chamber connection 4348. When the beta tube 4345a rotates, hydraulic fluid can still be pumped in, because regardless of the orientation of the connections 4346, 4348, the 360-degree galleries 4343, 4344 can open up to the connections 4346, 4348.

The connections 4346, 4348 of FIG. 41 are tubes, pipes, hoses, and/or openings within the beta tube 4345a that can pump obtained hydraulic fluid from the sleeve 4320 into one or more of the fine pitch chamber 4347 and the coarse pitch chamber 4349. When hydraulic fluid is pumped into the coarse pitch chamber 4349, the beta tube 4345a moves rearward in the orientation of FIG. 41 causing the blade 2200 to move to a coarse pitch angle. When the hydraulic fluid is pumped into the fine pitch chamber 4347, the beta tube 4345a moves forward in the orientation of FIG. 41 causing the blade 2200 to move to a fine pitch angle. The coarse pitch chamber 4349 and the fine pitch chamber 4347 may include a piston bleed structure to bleed out hydraulic fluid that has been pumped into the respective chambers 4347, 4349. The beta tube 4345a includes the piston 4345b to separate the chambers 4347, 4349. When hydraulic fluid is pumped into the fine pitch chamber 4347, the piston 4345b is moved forward and hydraulic fluid in the coarse pitch chamber 4349 is pumped out of one or more of the drain outputs 4315, 4336 via the primary control valve 4305 and/or the protection valve 4318 (e.g., depending on the positions of the valve spools 4308, 4321). When hydraulic fluid is pumped into the coarse pitch chamber 4349, the piston 4345b is moved rearward and hydraulic fluid in the fine pitch chamber 4347 is pumped out of one or more of the drain outputs 4315, 4336 via the primary control valve 4305 and/or the protection valve 4318 (e.g., depending on the positions of the valve spools 4308, 4321).

The beta tube 4345a of FIG. 41 includes a crosshead 4350 that transfers the lateral movement (e.g., forward and rearward in the orientation of FIG. 41) into rotational movement to adjust the pitch of the blade 2200. The yoke arrangement of the crosshead 4350 locates the operating pin on the base of each blade 2200. The pin may be offset from the centerline of the blade 2200 such that axial movement of the pitch beta tube 4345a results in rotation of the blade 2200.

The blade 2200 of FIG. 41 includes the counterweight 4351. The counterweight 4351 causes the blade 2200 to naturally reduce pitch when a load is present on the blade 2200. The counterweight 4351 causes the blade 2200 to naturally position to a higher blade angle. As further described below, one or more of the pressure sensor(s) 4355 can measure pressure at the one or more of the third or fourth ports 4335, 4337 of the protection valve assembly 4318 so that the protection valve controller 2354 can determine, based on the pressure measurement, when there is any friction in the blade 2200 that prevents the counterweight 4351 from naturally reducing pitch of the blade 2200 and/or determine that the counterweight 4351 has been compromised.

The primary controller 2352 of FIG. 41 is a pitch controller that outputs a control signal to the valve spool position controller 4306 via the component interface 2360 based on instructions from a pilot and/or autopilot instructions. For example, when a pilot engages the power lever 2353, the primary controller 2352 can determine a pitch angle that corresponds to the control of the power lever 2353 and adjust the pitch of the blade 2200 by sending a signal (e.g., a current) to the valve spool position controller 4306. The primary controller 2352 can execute control algorithm(s) to determine an amount to change the pitch angle at a given time. For example, in flight, the primary controller 2352 varies pitch to maintain fan speed. Varying the pitch in flight changes the fan torque absorbed. If the fan torque is greater than the engine torque, the fan speed will be reduced. If the fan torque is less than the engine torque, the fan speed will increase. The control algorithm(s) executed by the primary controller 2352 provide for stability with respect to the fan speed. When the fan is in the ground range, the control algorithm sets the pitch as a function of the position of the power lever 2353 while the engine maintains speed. As described above, the valve spool position controller 4306 controls the position of the valve spool 4308 in the primary sleeve 4307 based on the signal, which causes hydraulic fluid to be pumped into one of the fine pitch chamber 4347 or the coarse pitch chamber 4349 to adjust the pitch of the blade 2200. The primary controller 2352 may output the desired pitch position, flight mode (e.g., grounded, take-off, landing, cruise altitude, etc.), and/or other information to the protection valve controller 2354 via the component interface 2360. In some examples, the primary controller 2352 may be in communication with and/or implemented within a FADEC.

The protection valve controller 2354 of FIG. 41 outputs control signals to the protection valve assembly 4318 via the component interface 2360 to facilitate and/or override operation of the primary sleeve 4307. For example, during default (e.g., normal) operation, the protection valve controller 2354 outputs a signal to the valve spool position controller 4319 via the component interface 2360 to cause the valve spool 4321 of the sleeve 4320 to be positioned in the flight range location. As described above, when the valve spool 4321 is in the flight range location, the position of the valve spool 4308 of the primary sleeve 4307 controls the position of the beta tube 4345a by pumping hydraulic fluid into the fine pitch chamber 4347 and/or the coarse pitch chamber 4349. The protection valve controller 2354 also monitors the fan speed, blade angle feedback, pressure information, and/or information from the primary controller 2352 to determine whether to override the control of the primary control valve assembly 4305 and/or otherwise control the pitch of the blade 2200. For example, when the fan speed is above one or more thresholds, the protection valve controller 2354 can adjust the position of the valve spool 4321 to cause the blade 2200 to adjust the tilt to decrease the pitch angle to a coarser pitch angle by pumping hydraulic fluid into the coarse pitch chamber 4349. Additionally, when blade pitch angle feedback indicates that the blade 2200 is not approaching the intended pitch angle, the protection valve controller 2354 can adjust the position of the valve spool 4321 to attempt to move the blade 2200 to the intended pitch angle.

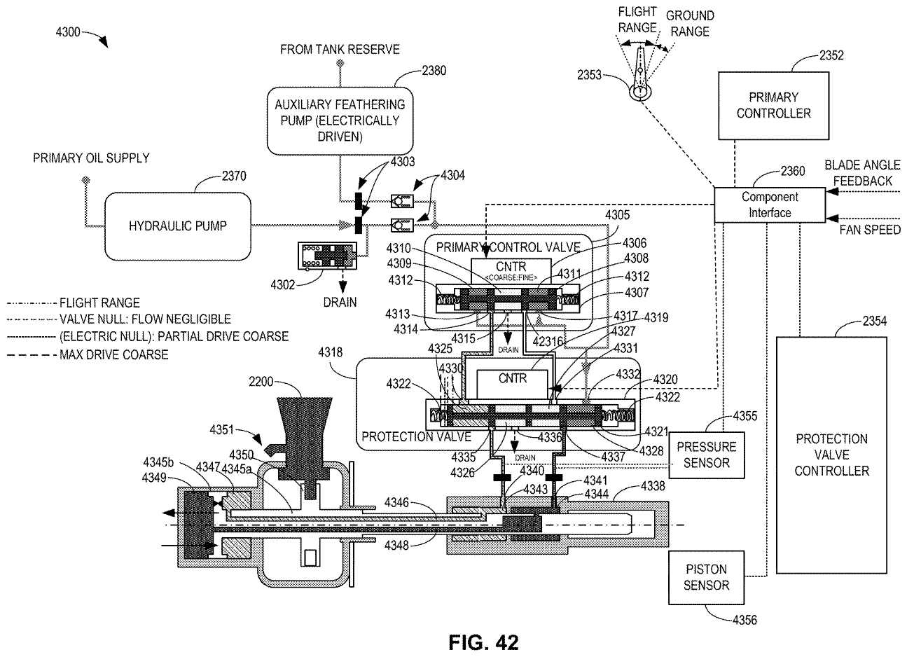

Additionally, the protection valve controller 2354 can prevent the blade 2200 from reaching a pitch angle below a threshold pitch angle (e.g., a ground pitch) unless the aircraft is grounded. For example, the protection valve controller 2354 can determine the position of the beta tube 4345a and prevent the beta tube 4345a from moving to a position that corresponds to a ground pitch angle unless the aircraft is grounded. The protection valve controller 2354 can determine the position of the beta tube 4345a based on information from the piston sensor 4356. The piston sensor 4356 can be one or more sensors that can sense the position of the beta tube 4345a and/or the pitch angle of the blade 2200. When the protection valve controller 2354 determines that the position of the beta tube 4345a and/or the pitch angle of the blade 2200 does not satisfy a threshold (e.g., the pitch angle corresponds to a ground pitch angle during flight and, thus, is below a threshold pitch angle), the protection valve controller 2354 can output a signal to the valve spool position controller 4319 to position the valve spool 4321 of the sleeve 4320 into the null position or the coarse position(s) of FIGS. 42-44. As further described below, the null position of the valve spool 4321 prevents the hydraulic fluid from reaching the first gallery 4343 preventing the beta tube 4345a from further moving to a position corresponding to a ground pitch angle of the blade 2200. The coarse position (partial drive coarse or maximum drive coarse) of the valve spool 4321 causes the hydraulic fluid to be pumped into the coarse pitch chamber 4349 and the second gallery 4344 to move the valve spool 4321 into a position corresponding to a coarse pitch angle, which provides a coarse-seeking force on the piston 4345b.

In some examples, the protection valve controller 2354, via the component interface 2360, determines and/or alerts the pilot or another component to an issue associated with the pressure measured by the pressure sensor(s) 4355. In some examples, the pressure sensor(s) 4355 can measure a pressure at the third port 4335 that can be used to determine a valve failure, excess friction at the crosshead 4350, and/or an issue with the counterweight 4351. In some examples, the pressure sensor(s) 4355 can measure a pressure at the fourth port 4337. In such examples, the protection valve controller 2354 can determine a delta (e.g., difference) between the pressure at the third port 4335 and the pressure at the fourth port 4337. The protection valve controller 2354 can determine in flight system friction based on the delta and take appropriate action based on the flight system friction. The protection valve controller 2354 may monitor the pressure as the pitch of the blade 2200 is reduced to determine an amount of pressure needed to overcome friction. When the amount of pressure needed to overcome friction changes, the protection valve controller 2354 can flag, via the component interface 2360, the potential issue to the pilot, a mechanic, etc. For example, because the pressure at the third port 4335 is supposed to be zero when the aircraft is in flight, the protection valve controller 2354 can generate an alert when the pressure at the third port 4335 is not zero at any time during flight.

The component interface 2360 of FIG. 41 may include one or more interfaces to transmit and/or obtain electrical signal to/from one or more of the controllers 4306, 4319, 2352, 2354, the power lever 2353, the sensors 4355, 4356, and/or any other aircraft components have can provide or obtain an electrical signal. The component interface 2360 allows independent control functionality between the primary controller 2352 and the protection valve controller 2354. Accordingly, if a failure occurs at one of the primary controller 2352 or the protection valve controller 2354, the other controller can continue operation.

FIG. 42 illustrates an example implementation of the pitch control protection system 4300 when the valve spool 4321 of the sleeve 4320 is in a valve null position.

In the valve null position of FIG. 42, the first port 4330 opens to the first passage 4325 (which does not open to an output). The second port 4331 opens to the third passage 4327 (which does not open to an output). The input 4332 opens to the fourth passage 4328 (which does not open to an output). The second passage 4326 opens to the output 4336 and the output 4336 opens to a drain. Thus, any fluid in the second passage 4326 is drained to the drain. Additionally, in the valve null position, the third port 4335 and the fourth port 4337 are plugged and/or blocked by the valve spool 4321. Accordingly, no hydraulic fluid from the sleeve 4320 flows into the hydraulic fluid transfer unit 4338. For example, the sleeve 4320 blocks the fluid output of the primary sleeve 4307 from the hydraulic fluid transfer unit 4338. Thus, in the valve null position, hydraulic fluid is not used to adjust the pitch of the blade 2200 (e.g., pitch angle is maintained and/or controlled by the counterweight 4351, where the counterweight provides a force on the piston 4345b in a direction to increase pitch so that the pitch angle does not move below a threshold pitch angle).

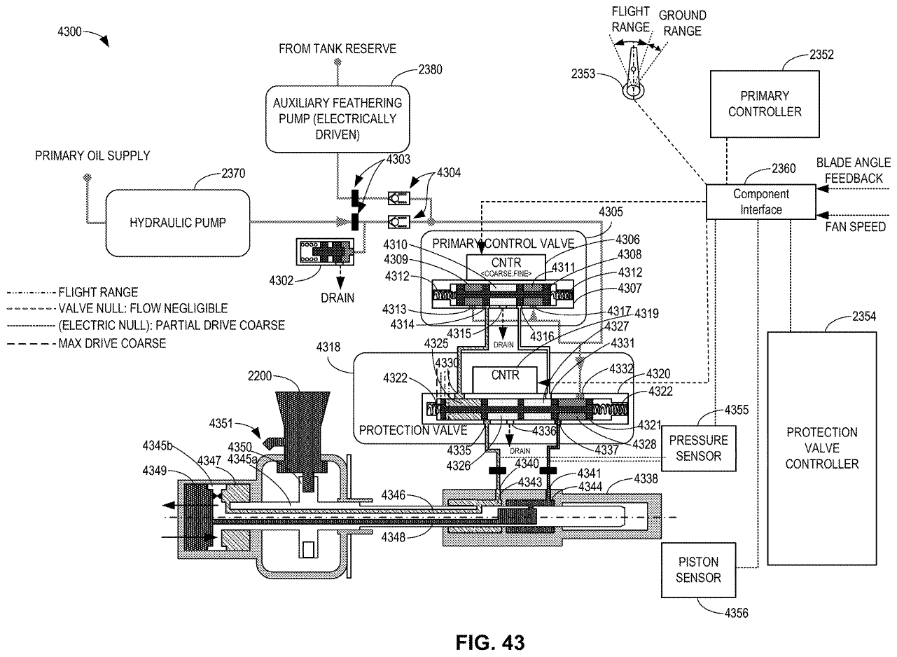

FIG. 43 illustrates an example implementation of the pitch control protection system 4300 when the valve spool 4321 of the sleeve 4320 is in a partial drive coarse position.

In the partial drive coarse position of FIG. 43, the first port 4330 opens to the first passage 4325 (which does not open to an output). The second port 4331 opens to the third passage 4327 (which does not open to an output). The input 4332 opens to the fourth passage 4328 and the fourth passage 4328 partially opens to the fourth port 4337. For example, the valve spool 4321 partially blocks the fourth port 4337 limiting the amount of hydraulic fluid that is pumped into the hydraulic fluid transfer unit 4338. The hydraulic fluid from at least one of the hydraulic pumps 2370, 2380 is pumped into the second gallery 4344 of the hydraulic fluid) transfer unit 4338 via the second port 4341 by bypassing (e.g., without going through the primary sleeve 4307. Accordingly, in the partial drive coarse position of FIG. 43, the protection valve assembly 4318 overrides the pitch control of the primary control valve assembly 4305 by blocking the fluid output of the primary sleeve 4307. Additionally, in the partial drive coarse position of FIG. 43, the second passage 4326 opens to the output 4336, which opens to a drain. Thus, any fluid in the second passage 4326 and/or from the third port 4335 is drained to the drain.

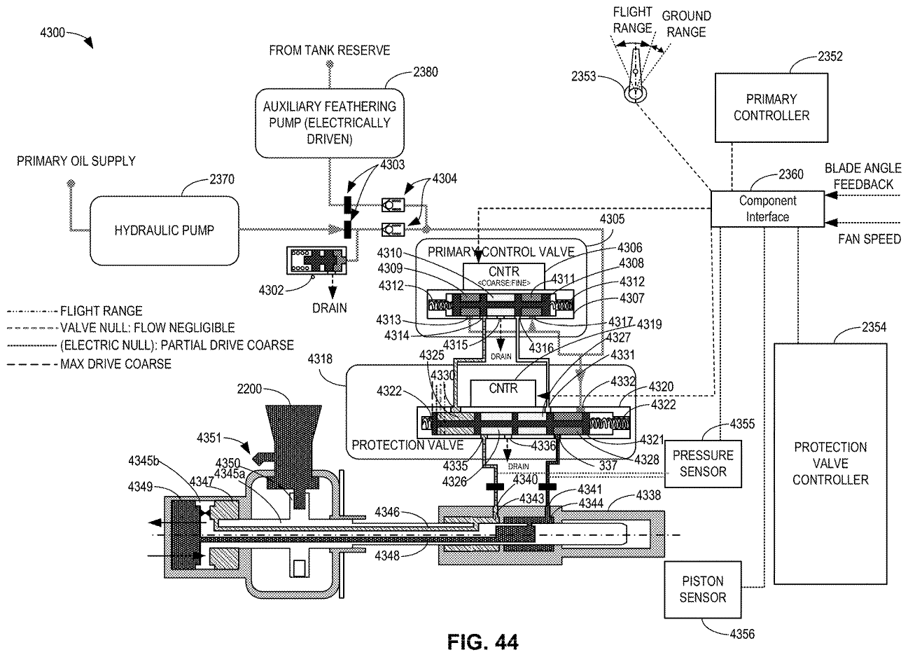

FIG. 44 illustrates an example implementation of the pitch control protection system 4300 when the valve spool 4321 of the sleeve 4320 is in a maximum drive coarse position.

In the maximum drive coarse position of FIG. 44, the first port 4330 opens to the first passage 4325 (which does not open to an output). The second port 4331 is blocked by the valve spool 4321 or can open to the third passage 4327 (which does not open to an output). The input 4332 opens to the fourth passage 4328 and the fourth passage 4328 which fully opens to the fourth port 4337. For example, the valve spool 4321 does not block the fourth port 4337 allowing maximum hydraulic flow into the hydraulic fluid transfer unit 4338. The hydraulic fluid from at least one of the hydraulic pumps 2370, 2380 is pumped into the second gallery 4344 of the hydraulic fluid transfer unit 4338 via the second port 4341 without going through the primary sleeve 4307. Accordingly, in the maximum drive coarse position of FIG. 44, the protection valve assembly 4318 overrides the pitch control of the primary control valve assembly 4305 by blocking the fluid output by the primary sleeve 4307. Additionally, in the maximum drive coarse position of FIG. 44, the third port 4335 opens to the second passage 4326 and the second passage 4326 opens to the output 4336, which opens to the drain. Thus, any fluid from the fine pitch chamber 4347 can be drained to the drain via the first gallery 4343, the third port 4335, and the second output 4336.

In the disclosed examples, the valve spool 4308 of the primary control valve assembly 4305 can move to cause hydraulic fluid to be output via the first and third outputs 4314, 4316 to enable adjustments to blade pitch. In some examples, the valve spool 4308 and the valve spool 4321 of the protection valve assembly 4318 can move at the same time or substantially the same time. For example, while the primary control valve assembly 4305 operates to control pitch, the protection valve controller 2354 can override the actions of the primary control valve assembly 4305 if the protection valve controller 2354 detects, for example, a primary system malfunction.

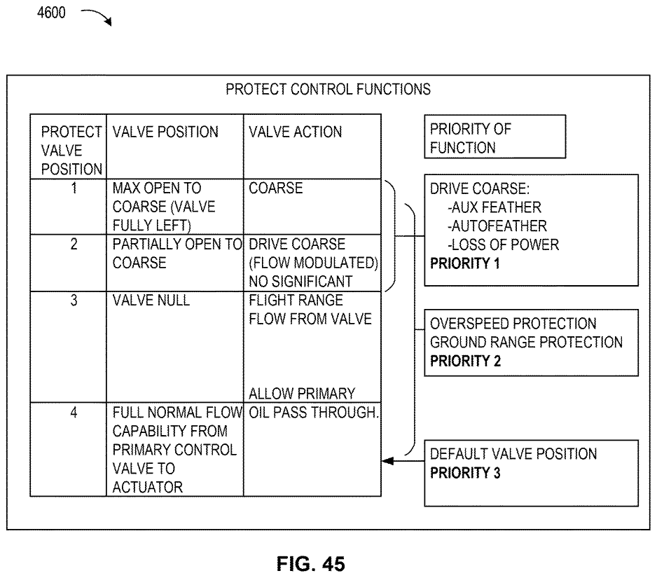

FIG. 45 illustrates the example protect control functions 4600 that can be implemented by the protection valve controller 2354 to control the position of the valve spool 4321 in the protection valve assembly 4318 of FIGS. 41-44. FIG. 45 includes four functions 4600 that correspond to the valve spool positions of FIGS. 41-44 namely, a maximum drive coarse position, a partial drive coarse position, a valve null position, and a flight/ground range position. For example, protect valve position 1 corresponds to placing the valve spool 4321 of the sleeve 4320 into the maximum drive coarse position illustrated in FIG. 44. Protect valve position 2 corresponds to placing the valve spool 4321 of the sleeve 4320 into the partial drive coarse position illustrated in FIG. 43. Protect valve position 3 corresponds to placing the valve spool 4321 of the sleeve 4320 into the valve null position illustrated in FIG. 42. Protect valve position 4 corresponds to placing the valve spool 4321 of the sleeve 4320 into the flight/ground range position illustrated in FIG. 41. As described above, in protect valve position 4, the protection valve controller 2354 monitors the position of the beta tube 4345a of the hydraulic fluid transfer unit 4338 and/or the blade 2200. When the monitored position(s) fail to satisfy a threshold (e.g., the pitch angle is below a threshold pitch angle due to the pitch angle corresponding to a ground pitch angle) and the aircraft is in flight (e.g., not grounded), the protection valve controller 2354 automatically positions the valve spool 4321 of the sleeve 4320 to the null position or drive coarse position(s) of FIGS. 42-44 to prevent the valve spool 4321 from moving the blade 2200 to the ground angle.

The protection valve controller 2354 outputs a different signal (e.g., a different amount of current) to the valve spool position controller 4319 to cause the valve spool 4321 to move to one of the four valve positions. As described above, the protection valve controller 2354 moves the valve spool 4321 to the first position to cause the blade 2200 to move to a coarse pitch angle. The protection valve controller 2354 moves the valve spool 4321 to the second position to cause the blade 2200 to move to a coarse pitch angle at a slower pace than the pace associated with the maximum drive coarse position. The protection valve controller 2354 moves the valve spool 4321 to the third position to cause the blade 2200 to not move or to be controlled by the counterweight 4351. The protection valve controller 2354 moves the valve spool 4321 to the fourth position to cause the blade 2200 to move to a pitch angle based on the fluid output by the primary sleeve 4307.

By default, the protection valve controller 2354 outputs a signal to the valve spool position controller 4319 of the sleeve 4320 to cause the valve spool 4321 to move to the fourth position, the flight/ground range position (e.g., where the pitch angle of the blade 2200 is controlled by the primary sleeve 4307). When the protection valve controller 2354 determines that the fan speed is too high (e.g., relative to an overspeed limit) or the pitch of the blade 2200 is lower than intended (e.g., relative to a pitch threshold), the protection valve controller 2354 changes the signal to cause the valve spool 4321 to move to the third position (e.g., the valve null position). When the protection valve controller 2354 determines that the fan speed has lowered (e.g., relative to an overspeed limit) or the pitch of the blade is higher (e.g., relative to a pitch threshold), the protection valve controller 2354 may change the signal back to move the valve spool 4321 back to the flight/ground range position. When the protection valve controller 2354 determines that the fan speed is still too high (e.g., relative to an overspeed limit) or the pitch of the blade is still too low (e.g., relative to a pitch threshold), the protection valve controller 2354 changes the signal to the partial drive coarse position (e.g., position 2). When the protection valve controller 2354 determines that the fan speed has lowered (e.g., relative to an overspeed limit) or the pitch of the blade is higher (e.g., relative to a pitch threshold), the protection valve controller 2354 may change the signal back to move the valve spool 4321 back to the valve null position. When the protection valve controller 2354 determines that the fan speed is still too high (e.g., relative to an overspeed limit) or the pitch of the blade is still too low (e.g., relative to a pitch threshold), the protection valve controller 2354 changes the signal to a signal corresponding to the maximum drive coarse position (e.g., position 1). The protection valve controller 2354 maintains the signal corresponding to the maximum drive coarse position until the fan speed slows by a particular amount or the pitch of the blade increases by a particular amount. The protection valve controller 2354 executes control algorithm(s) that output signal demand(s) to, for example, the protection valve assembly 4318, for position(s) between the default (e.g., normal) flow/flight range position and the fully drive coarse position. The control algorithm(s) can include a Proportional-Integral-Derivative (PID) algorithm that calculates a control error from desired outputs and a valve position request. For example, if a speed increase exceeds an overspeed limit, the PID algorithm determines an amount to open the valve 4318 as a function of how fast the fan is accelerating and the amount the fan has accelerated. The control algorithm(s) executed by the protection valve controller 2354 continue to modulate the valve position to stabilize speed at a speed set point.

If there are contradictory instructions or feedback obtained via the component interface 2360, the protection valve controller 2354 utilizes a priority of positions to determine a position of the valve spool 4321. The highest priority (e.g., priority 1) corresponds to driving coarse due for auxiliary feathering (e.g., feathering caused by an electrically driven pump from a reserve oil supply), auto-feathering, and/or loss of power; the second highest priority (e.g., priority 2) corresponds to overspeed protection/ground range protection in which valve position varies as a function of blade pitch; and the lowest priority (e.g., priority 3) corresponds to default (e.g., normal) flight operation and/or ground operation in which the valve is in a default position (e.g., the flight/ground range position of FIG. 41). For example, when the aircraft is operating in flight operation (e.g., priority 3), the protection valve controller 2354 outputs a signal via the component interface 2360 to move the valve spool 4321 when a higher priority functionality is triggered. When the aircraft is operating in overspeed protection mode (e.g., priority 2) because the protection valve controller 2354 has determined that the fan speed is too high, as described above, the overspeed protection mode takes priority over a pilot selected flight operation mode. Thus, the protection valve controller 2354 may override the primary control valve assembly 4305 using one of the protect valve positions 1-4 to reduce fan speed. In the overspeed protection mode, the amount of opening of the protection valve 4318 (e.g., a proportional servo valve) is a function of fan overspeed at a point in time as computed by the protection valve controller 2354 (e.g., proportional valve position versus input signal). Thus, the amount of opening of the protection valve 4318 can be anywhere between protect valve positions 1-4. As described above, the protection valve controller 2354 may only allow the beta tube 4345a to move to a position corresponding to a ground pitch angle when the aircraft is grounded. For example, the protection valve controller 2354 may, based on the pitch angle of the blade decreasing below a threshold pitch angle and the aircraft being in flight, adjust the position of the valve spool 4321 to cause the valve spool 4321 to stop moving or move toward a position corresponding to a coarse pitch angle. When drive coarse is enabled, the protection valve controller 2354 outputs a signal to move the valve spool 4321 to the maximum drive coarse position or the partial drive coarse position regardless of instructions from a pilot or the system.

Referring again to the block diagram of the protection valve controller 2354 of FIG. 29 and in connection with the example pitch control system 4300 of FIGS. 41-45, the interface(s) 2900 obtain(s) information from the primary controller 2352 (e.g., pilot instructions, flight modes, autopilot instructions, etc.). Additionally, the interface(s) 2900 obtain(s) feedback information from one or more sensors that relates to the blade 2200. For example, the interface(s) 2900 can obtain fan speed, pitch angles measurements of the blade 2200, and/or sensor readings from the pressure sensor 4355. The interface(s) 2900 may include one interface to obtain all signals, or multiple interface(s) 2900 to obtain the multiple signals.

Also, in connection with the example pitch control system 4300 of FIGS. 41-45, the driver 2902 drives the valve spool position controller 4319 to move the valve spool 4321 to one or more particular positions. For example, the driver 2902 is capable of outputting different amounts of current, each amount of current corresponding to moving the valve spool 4321 to a different position. The driver 2902 is controlled by the valve controller 2904.

In connection with the example pitch control system 4300 of FIGS. 41-45, the valve controller 2904 selects a position for the valve spool 4321 based on flight mode, pilot instructions, system instructions, autopilot instructions, feedback information, etc. By default, the valve controller 2904 selects the position for the valve spool 4321 to be the flight/ground range position of FIG. 41. However, when the valve controller 2904 determines that overspeed protection is needed, the valve controller 2904 selects a different position for the valve spool (e.g., corresponding to FIGS. 41-44), as further described above. When the valve controller 2904 obtains an indication that ground operation has been enabled (e.g., the aircraft is grounded), the valve controller 2904 selects the position for the valve spool 4321 to be the flight/ground range position of FIG. 41 so that the hydraulic fluid can be pumped into the fine pitch chamber 4347 (e.g., via the first gallery 4343) until the blade 2200 reaches the ground pitch angle. When ground operation is not enabled (e.g., the aircraft is in flight), the valve controller 2904 monitors the position of the valve spool 4321 and/or the pitch angle of the blade 2200 to determine whether the position and/or pitch angle fail to satisfy a threshold (e.g. a threshold pitch angle). When the valve controller 2904 determines that the position and/or pitch angle fail to satisfy the threshold, the valve controller 2904 selects the null position of FIG. 42 or one of the drive coarse positions of FIGS. 43 and/or 44 to prevent the beta tube 4345a of the hydraulic fluid transfer unit 4338 from moving rearward (with respect to the orientation of FIG. 3) preventing the blade 2200 from reaching the ground pitch angle. When the valve controller 2904 obtains an indication to drive coarse (e.g., due to loss of power, auto-feathering instructions, auxiliary feathering instructions, etc.), the valve controller 2904 selects the position for the valve spool 4321 to be the maximum drive coarse position of FIG. 44 or the partial drive coarse position of FIG. 43. Additionally, the valve controller 2904 may determine that there is a friction issue, a valve issue, or an issue with the counterweight 4351, based on one or more pressure measurements from the pressure sensor 4355, as further described above. The valve controller 2904 can trigger alerts based on the determined issue(s). The valve controller 2904 controls the driver 2902 based on the determined valve spool position.

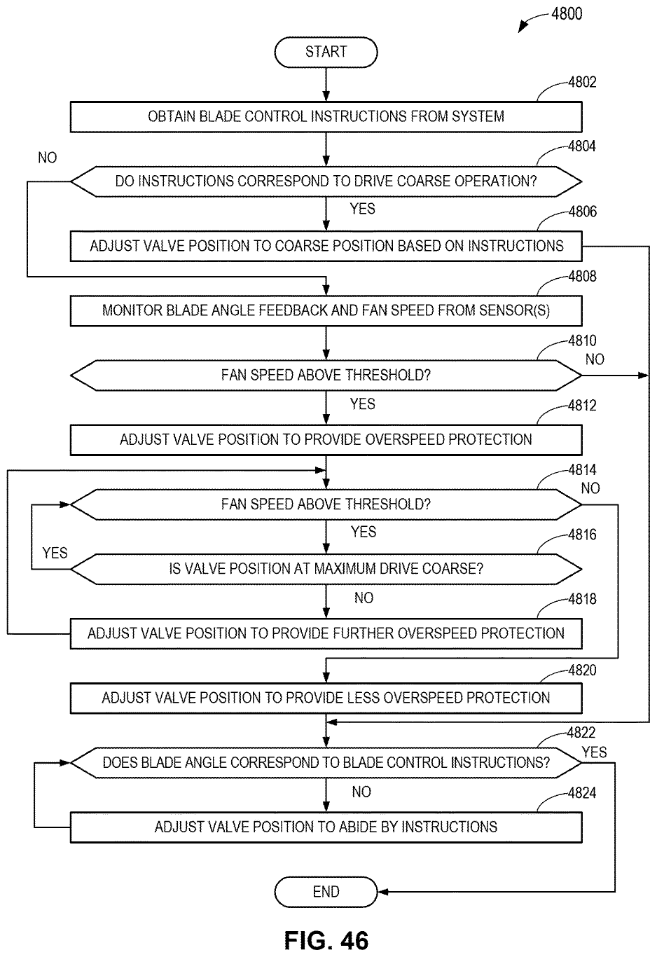

FIG. 46 is a flowchart representative of example machine-readable instructions and/or example operations 4800 that may be executed, instantiated, and/or performed by programmable circuitry (e.g., the protection valve controller 2354 of FIG. 29) to control the pitch control protection system 4300 of FIGS. 42-46. The example machine-readable instructions and/or the example operations 4800 of FIG. 46 begin at block 4802, at which the interface(s) 2900 obtains blade control instructions from the system (e.g., from the primary controller 2352). The blade control instructions may identify whether the aircraft is in flight or grounded, the operation mode of the aircraft (e.g., takeoff, autopilot, landing, etc.), instructions and/or triggers (e.g., auto-feathering instruction, power loss instructions, pilot instructions, etc.), etc. When no instructions are obtained, the driver 2902 drives the valve spool 4321 of the sleeve 4320 to the flight/ground range position of FIG. 41 (e.g., the default position). In some examples, if no instructions are obtained, the driver 2902 does not output a signal and the springs 4322 position the valve spool 4321 to the flight/ground range position of FIG. 41.

At block 4804, the valve controller 2904 determines whether the instructions correspond to drive coarse operation. When the valve controller 2904 determines that the instructions do not correspond to drive coarse operation (block 4804: NO), control continues to block 4808, as further described below. When the valve controller 2904 determines that the instructions correspond to drive coarse operation (block 4804: YES), the valve controller 2904 causes the driver 2902 to output a control signal to the valve spool position controller 4319 of the protection valve assembly 4318 to adjust the position of the valve spool 4321 to the maximum drive coarse or partial drive coarse position of FIG. 43 or 44 (block 4806). As described above, drive coarse operation is based on a power loss event, an auto-feathering event, an auxiliary feathering event, etc. and ground operation corresponds to when the aircraft is grounded or not in flight.

At block 4808, the valve controller 2904 monitors the blade angle feedback information and/or fan speed from one or more sensor(s) (e.g., obtained via the interface(s) 2900). At block 4810, the valve controller 2904 determines whether the fan speed is above a threshold (e.g., between 102%-105% of the takeoff fan speed, where the fan speed may be 850 to 200 revolutions per minute, depending on fan diameter). When the valve controller 2904 determines that the fan speed is not above a threshold (block 4810: NO), control continues to block 4822, as further described below. When the valve controller 2904 determines that the fan speed is above a threshold (block 4810: YES), the valve controller 2904 causes the driver 2902 to output a signal to the valve spool position controller 4319 of the protection valve assembly 4318 to adjust the position of the valve spool 4321 to provide overspeed protection (block 4812). For example, the valve controller 2904 can cause the valve spool 4321 of the protection valve assembly 4318 to move (a) from the flight/ground range position of FIG. 41 to the valve null position of FIG. 42, (b) from the valve null position of FIG. 42 to the partial drive coarse position of FIG. 43, or (c) from the partial drive coarse position of FIG. 43 to the maximum drive coarse position of FIG. 44 causing the blade to either stop adjusting pitch angle or increasing the pitch angle to a coarser pitch angle.

At block 4814, the valve controller 2904 determines whether the fan speed is still above the threshold. When the valve controller 2904 determines that the fan speed is no longer above the threshold (block 4814: NO), the valve controller 2904 causes the driver 2902 to output a control signal to the valve spool position controller 4319 of the protection valve assembly 4318 to cause the valve spool 4321 to provide less overspeed protection (block 4820) and control continues to block 4822, as further described below. For example, the valve controller 2904 can output a control signal to cause the valve spool 4321 to move to the flight/ground range position of FIG. 41. When the valve controller 2904 determines that the fan speed is still above the threshold (block 4814: YES), the valve controller 2904 determines the current position of the valve spool 4321 is at the maximum drive coarse position of FIG. 44 (block 4816). When the valve spool position is not at maximum drive coarse position, the valve spool 4321 can be moved to provide additional overspeed protection (i.e., because the valve spool position has not yet reached the maximum drive coarse position). If the valve controller 2904 determines that the current position of the valve spool 4321 is at the maximum drive coarse position of FIG. 44 (block 4816: YES), control returns to block 4814 for continued monitoring of whether the fan speed is still above the threshold. Control proceeds to block 4820 when the valve controller 2904 determines that the fan speed is no longer above the threshold, at which time the valve spool 4321 can be moved to provide less overspeed protection.

At block 4822, the valve controller 2904 determines whether the blade angle corresponds to the blade control instructions. The valve controller 2904 may process the blade control instructions and determine whether the blade pitch angle projected to a pitch angle that corresponds to the blade control instructions. For example, when the blade control instructions correspond to adjusting the pitch angle of the blade 2200 to a coarse pitch but the blade pitch is moving toward a fine pitch angle, the valve controller 2904 determines that the blade angle does not correspond to the blade control instructions. In another example, when the blade control instructions correspond to adjusting the pitch angle of the blade 2200 to a coarse pitch but the blade pitch is adjusting at a rate below a threshold rate, the valve controller 2904 determines that the blade angle does not correspond to the blade control instructions. When the valve controller 2904 determines that the blade angle corresponds to the blade control instructions (block 4822: YES), the instructions 4800 end. When the valve controller 2904 determines that the blade angle does not correspond to the blade control instructions (block 4822: NO), the valve controller 2904 causes the driver 2902 to output a control signal to the valve spool position controller 4319 to adjust the position of the valve spool 4321 in the sleeve 4320 to abide by the instructions (block 4824). The instructions 4800 end when the valve controller 2904 determines that the blade angle corresponds to the blade control instructions (block 4822: YES).

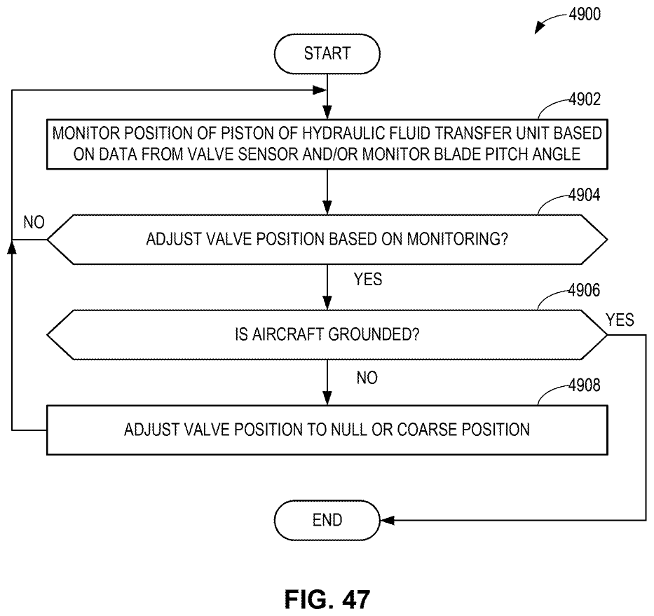

FIG. 47 is a flowchart representative of example machine-readable instructions and/or example operations 4900 that may be executed, instantiated, and/or performed by programmable circuitry (e.g., the protection valve controller 2354 of FIG. 29) to allow or prevent the blade 2200 from moving to a position corresponding to the ground pitch angle. The example machine-readable instructions and/or the example operations 4900 of FIG. 47 begin at block 4902, at which valve controller 2904 monitors the position of the beta tube 4345a of the hydraulic fluid transfer unit 4338. In some examples, the valve controller 2904 monitors the position of the piston based on information from the piston sensor 4356. In some examples, another sensor may be included that senses the pitch angle of the blade 2200. In such examples, the valve controller 2904 can monitor the pitch angle of the blade 2200.

At block 4904, the valve controller 2904 determines whether the position of the valve spool 4321 of the protection valve assembly 4318 should be adjusted based on the monitoring (e.g., based on the piston position failing to satisfy a threshold position), based on the pitch angle of the blade 2200 failing to satisfy a threshold blade angle). As described above, when the valve spool 4321 is pushed past a threshold position, the blade 2200 is moved to a ground pitch angle. The ground pitch angle may be restricted with in flight due to regulations (e.g., safety regulations).

At block 4906, the valve controller 2904 determines whether the aircraft is grounded. For example, the interface(s) 2900 may obtain an instruction and/or information related to the aircraft being grounded (e.g., an altitude measurement, a speed measurement, instructions from the FADEC, etc.). When the valve controller 2904 determines that the aircraft is grounded (block 4906: YES), the valve controller 2904 does not adjust control of the protection valve and allows the blade 2200 to move to the ground pitch angle. When the valve controller 2904 determines that the aircraft is not grounded (e.g., the aircraft is in flight) (block 4906: NO), the valve controller 2904 outputs a control signal to the valve spool position controller 4319 to adjust the valve spool 4321 to one of the valve positions of FIGS. 41-44 (e.g., the null valve position, the partial drive coarse position, or the maximum drive coarse position) (block 4908). In this manner, hydraulic fluid stops being pumped into the fine pitch chamber 4347 and/or start being pumped into the coarse pitch chamber 4349 preventing the blade 2200 from reaching the ground pitch angle.

While an example manner of implementing the protection valve controller 2354 of FIGS. 23-27, 31-38, and 41-44 is illustrated in FIG. 292354, one or more of the elements, processes, and/or devices illustrated in FIG. 29 may be combined, divided, re-arranged, omitted, eliminated, and/or implemented in any other way. Further, the interface(s) 2900, the driver 2902, the valve controller 2904, and/or, more generally, the example protection valve controller 2354 of FIG. 29, may be implemented by hardware alone or by hardware in combination with software and/or firmware. Thus, for example, the interface(s) 2900, the driver 2902, the valve controller 2904, and/or, more generally, the example protection valve controller 2354, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example protection valve controller 2354 of FIG. 29 may include one or more elements, processes, and/or devices in addition to, or instead of, those illustrated in FIG. 29, and/or may include more than one of any or all of the illustrated elements, processes, and devices.

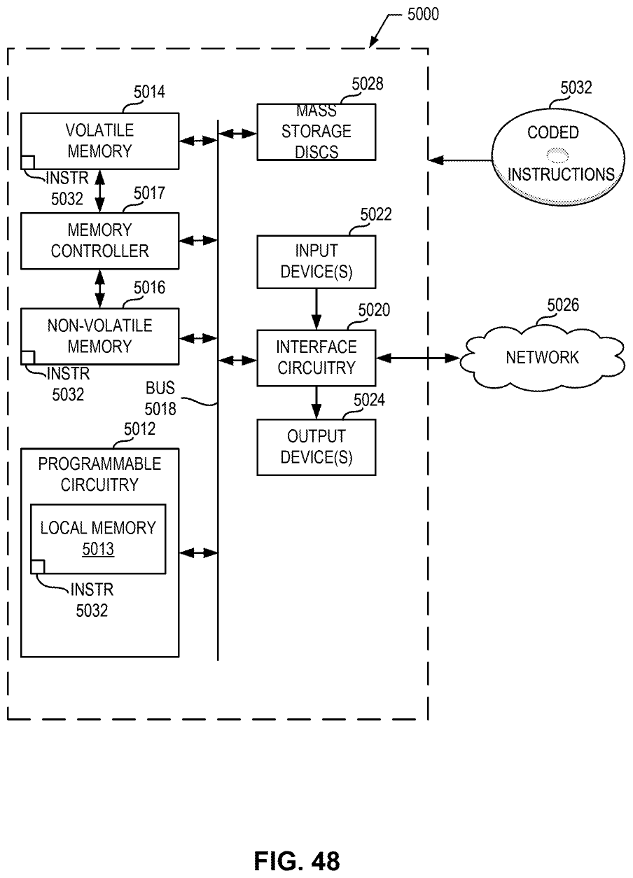

The flowcharts of FIGS. 30, 40, 46, and 47 are representative of example machine-readable instructions, which may be executed by programmable circuitry to implement and/or instantiate the protection valve controller 2354 of FIG. 29. The machine-readable instructions may be one or more executable programs or portion(s) of one or more executable programs for execution by programmable circuitry such as the programmable circuitry 5012 shown in the example processor platform 5000 discussed below in connection with FIG. 48 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart illustrated in FIGS. 30, 40, 46, and/or 47, many other methods of implementing the example protection valve controller 2354 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 30, 40, 47, and 48 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 48 is a block diagram of an example programmable circuitry platform 5000 structured to execute and/or instantiate the example machine-readable instructions and/or the example operations of FIGS. 30, 40, 46, and 47 to implement the protection valve controller 2354 of FIG. 29. The programmable circuitry platform 5000 can be, for example, a server, a computer, a controller, a self-learning machine (e.g., a neural network), or any other type of computing and/or electronic device.

The programmable circuitry platform 5000 of the illustrated example includes programmable circuitry 5012. The programmable circuitry 5012 of the illustrated example is hardware. For example, the programmable circuitry 5012 can be implemented by one or more integrated circuits, logic circuits, FPGAs, microprocessors, CPUs, GPUs, DSPs, and/or microcontrollers from any desired family or manufacturer. The programmable circuitry 5012 may be implemented by one or more semiconductor based (e.g., silicon based) devices. The programmable circuitry 5012 can implement the interface(s) 2900, driver 2902, and the valve controller 2904 of FIG. 29.

The programmable circuitry 5012 of the illustrated example includes a local memory 5013 (e.g., a cache, registers, etc.). The programmable circuitry 5012 of the illustrated example is in communication with main memory 5014, 5016, which includes a volatile memory 5014 and a non-volatile memory 5016, by a bus 5018. The volatile memory 5014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 5016 may be implemented by flash memory and/or any other desired type of memory device. Access to the main memory 5014, 5016 of the illustrated example is controlled by a memory controller 5017. In some examples, the memory controller 5017 may be implemented by one or more integrated circuits, logic circuits, microcontrollers from any desired family or manufacturer, or any other type of circuitry to manage the flow of data going to and from the main memory 5014, 5016.

The programmable circuitry platform 5000 of the illustrated example also includes interface circuitry 5020. The interface circuitry 5020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 5022 are connected to the interface circuitry 5020. The input device(s) 5022 permit(s) a user (e.g., a human user, a machine user, etc.) to enter data and/or commands into the programmable circuitry 5012. The input device(s) 5022 can be implemented by, for example, an audio sensor, a microphone, a camera (still or video), a keyboard, a button, a mouse, a touchscreen, a trackpad, and/or a voice recognition system.

One or more output devices 5024 are also connected to the interface circuitry 5020 of the illustrated example. The output device(s) 5024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 5020 of the illustrated example, thus, typically includes a graphics driver card, a graphics driver chip, and/or graphics processor circuitry such as a GPU.

The interface circuitry 5020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 5026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 5000 of the illustrated example also includes one or more mass storage discs or devices 5028 to store firmware, software, and/or data. Examples of such mass storage discs or devices 5028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

Machine-readable instructions 5032, which may be implemented by the machine-readable instructions of FIG. 9, may be stored in the volatile memory 5014, in the non-volatile memory 5016, and/or on at least one non-transitory computer-readable storage medium such as a CD or DVD which may be removable.

Further aspects are provided by the subject matter of the following clauses.

A turbofan engine for an aircraft, the turbofan engine comprising a fan having a plurality of fan blades, each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 300 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

A turbofan engine for an aircraft, the turbofan engine comprising a fan having a plurality of fan blades, each of the plurality of fan blades being rotatable about a pitch axis, a nacelle that circumferentially surrounds the fan, and a fan actuation system including one or more actuators for rotating the plurality of fan blades about the pitch axis and one or more radial thrust bearings, wherein the fan actuation system is characterized by a fan actuation system envelope in a range from 300 to 660, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more thrust bearings.

A turbofan engine for an aircraft, the turbofan engine comprising a fan having a plurality of fan blades, the fan being an open fan, and each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 660 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

The turbofan engine of any preceding clause, wherein the fan actuation system includes a hydraulic system that supplies hydraulic fluid for rotating the plurality of fan blades about the pitch axis.

The turbofan engine of any preceding clause, wherein the cruise operating conditions occur at a mid-level power range of the turbofan engine.

The turbofan engine of the preceding clause, wherein the mid-level power range is 30% to 85% of a sea level static maximum engine rated thrust for the turbofan engine.

The turbofan engine of any preceding clause, wherein the turbofan engine is rated for use on a regional aircraft having a maximum takeoff thrust of 10,000 lbf to 20,000 lbf.

The turbofan engine of any preceding clause, wherein the turbofan engine is rated for use on a narrow body aircraft having a maximum takeoff thrust of 15,000 lbf to 30,000 lbf.

The turbofan engine of any preceding clause, wherein the turbofan engine is rated for use on a wide body aircraft having a maximum takeoff thrust of 40,000 lbf to 110,000 lbf.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 168.0 inches.

The turbofan engine of any preceding clause, wherein R_{TB} is in a range from 14 inches to 27 inches.

The turbofan engine of any preceding clause, wherein R_{TB} is in a range from 14 inches to 19 inches.

The turbofan engine of any preceding clause, wherein R_{TB} is in a range from 19 inches to 27 inches.

The turbofan engine of any preceding clause, wherein Mcᵣᵤᵢₛₑ is in a range from 0.7 to 0.92.

The turbofan engine of any preceding clause, wherein Mcᵣᵤᵢₛₑ is in a range from 0.75 to 0.9.

The turbofan engine of any preceding clause, wherein Mcruiₛₑ is in a range from 0.8 to 0.88.

The turbofan engine of any preceding clause, wherein the fan actuation system includes a pressurized pneumatic chamber that is filled with a pressurized gas that biases the plurality of fan blades to a feather position.

The turbofan engine of any preceding clause, wherein the fan actuation system is devoid of counterweights for reducing inertial loading associated with rotation of fan blades.

The turbofan engine of any preceding clause, further comprising core cowl, wherein the turbofan engine has a longitudinal centerline axis, and the core cowl is annular about the longitudinal centerline axis.

The turbofan engine of the preceding clause, further comprising a core inlet that is annular about the longitudinal centerline axis.

The turbofan engine of any preceding clause, further comprising a gearbox assembly, wherein the turbine section includes a low-pressure shaft, and the fan has a fan shaft that is coupled to the low-pressure shaft through the gearbox assembly.

The turbofan engine of the preceding clause, wherein the gearbox assembly has a gear ratio in a range 3.5:1 to 5:1 for a ducted engine.

The turbofan engine of any preceding clause, wherein the gearbox assembly has a gear ratio in a range from 4:1 and 10:1 for an unducted fan engine.

The turbofan engine of any preceding clause, wherein the low-pressure shaft, the gearbox assembly, and the fan shaft are coaxial along the longitudinal centerline axis.

The turbofan engine of any preceding clause, wherein the fan actuation system envelope is in a range from 660 to 1020.

The turbofan engine of any preceding clause, the fan actuation system envelope being in a range from 300 to 660.

The turbofan engine of any preceding clause, the fan actuation system envelope being in a range from 660 to 1860.

The turbofan engine of any preceding clause, the fan actuation system envelope being in a range from 660 to 1020.

The turbofan engine of any preceding clause, further comprising a nacelle that circumferentially surrounds the fan.

The turbofan engine of any preceding clause, wherein the turbofan engine is an open fan engine.

The turbofan engine of any preceding clause, further comprising a fan hub, the plurality of fan blades extending radially from the fan hub.

The turbofan engine of any preceding clause, the fan actuation system being disposed within the fan hub.

The turbofan engine of any preceding clause, further comprising a compressor section, a combustor, and a turbine section.

The turbofan engine of any preceding clause, the compressor section including a low-pressure compressor and a high-pressure compressor, and the turbine section including a high-pressure turbine and a low-pressure turbine.

The turbofan engine of any preceding clause, further comprising a high-pressure shaft that couples the high-pressure compressor and the high-pressure turbine.

The turbofan engine of any preceding clause, further comprising a low-pressure shaft that couples the low-pressure compressor and the low-pressure turbine.

The turbofan engine of any preceding clause, the low-pressure shaft being disposed through the high-pressure shaft.

The turbofan engine of any preceding clause, the gearbox assembly comprising a gear assembly comprising a plurality of gears.

The turbofan engine of any preceding clause, the gearbox assembly including one or more gear bearings.

The turbofan engine of any preceding clause, each of the plurality of fan blades extending from a fan root to a fan tip.

The turbofan engine of any preceding clause, the fan tip diameter DFT being defined from the longitudinal centerline axis to the fan tip of each of the plurality of fan blades.

The turbofan engine of any preceding clause, the fan actuation system including a trunnion mechanism that includes a plurality of trunnions, each fan blade being disposed in a respective trunnion.

The turbofan engine of any preceding clause, the fan blades extending from a disk.

The turbofan engine of any preceding clause, the disk including a plurality of disk segments.

The turbofan engine of any preceding clause, each fan blade being coupled to a respective disk segment at the trunnion mechanism.

The turbofan engine of any preceding clause, the plurality of trunnions being rotatable to rotate the plurality of fan blades about the pitch axis.

The turbofan engine of any preceding clause, the fan actuation system including one or more actuators coupled to the plurality of trunnions.

The turbofan engine of any preceding clause, the fan actuation system including a plurality of trunnion links and a unison ring, the plurality of trunnion links being coupled to the plurality of trunnions and to the unison ring.

The turbofan engine of any preceding clause, the plurality of trunnion links including a plurality of forward trunnion links and a plurality of aft trunnion links.

The turbofan engine of any preceding clause, the unison ring including a plurality of unison rings including a forward unison ring that is positioned forward of the plurality of trunnions and an aft unison ring that is disposed aft of the plurality of trunnions.

The turbofan engine of any preceding clause, the plurality of forward trunnion links being coupled to the forward unison ring.

The turbofan engine of any preceding clause, the plurality of aft trunnion links being coupled to the aft unison ring.

The turbofan engine of any preceding clause, further comprising a plurality of pins that couple the plurality of trunnion links to the unison ring.

The turbofan engine of any preceding clause, the plurality of forward trunnion links being coupled to the forward unison ring by a plurality of forward pins.

The turbofan engine of any preceding clause, the plurality of aft trunnion links being coupled to the aft unison ring by a plurality of aft pins.

The turbofan engine of any preceding clause, the one or more actuators including a hydraulic cylinder and a piston disposed within the hydraulic cylinder.

The turbofan engine of the preceding clause, the hydraulic cylinder and the piston being movable along an axial direction.

The turbofan engine of any preceding clause, the forward unison ring being coupled to the hydraulic cylinder such that the forward unison ring moves when the hydraulic cylinder moves.

The turbofan engine of any preceding clause, the aft unison ring being coupled to the piston such that the aft unison ring moves as the piston moves.

The turbofan engine of any preceding clause, the fan actuation system rotating the plurality of fan blades between a first end position and a second end position.

The turbofan engine of any preceding clause, the first end position being a feather position in which the plurality of fan blades is substantially aligned with a flow of a volume of air across the plurality of fan blades.

The turbofan engine of the preceding clause, the fan actuation system rotating the plurality of fan blades to any position between the first end position and the second end position.

The turbofan engine of any preceding clause, the second end positioned being a reverse position in which the plurality of fan blades exceeds a plane that is transverse to the longitudinal centerline axis by at least 300 to assist with braking the aircraft.

The turbofan engine of any preceding clause, the fan actuation system moving the hydraulic cylinder in a first direction and moving the piston in a second direction.

The turbofan engine of any preceding clause, movement of the hydraulic cylinder and the piston causing the plurality of fan blades to rotate about the pitch axis.

The turbofan engine of any preceding clause, the one or more actuators including a piston retainer.

The turbofan engine of the preceding clause, the piston retainer being coupled to the fan shaft such that the piston retainer rotates with the fan shaft.

The turbofan engine of any preceding clause, the piston being coupled to the piston retainer such that the piston rotates with the piston retainer.

The turbofan engine of any preceding clause, the hydraulic cylinder being axially slidable with respect to the piston and the piston retainer.

The turbofan engine of any preceding clause, the piston retainer comprising a first portion, a second portion that extends radially outward from the first portion, and a third portion that extends axially from the second portion.

The turbofan engine of any preceding clause, the third portion of the piston retainer being coupled to the fan shaft.

The turbofan engine of any preceding clause, the piston being coupled to, and extending forward from, the first portion of the piston retainer.

The turbofan engine of any preceding clause, the hydraulic cylinder being disposed radially outward of the piston retainer and the piston.

The turbofan engine of any preceding clause, the hydraulic cylinder being coupled to the unison ring at a joint such that movement of the hydraulic cylinder in the axial direction causes the plurality of fan blades to pitch about the pitch axis.

The turbofan engine of any preceding clause, the hydraulic cylinder having a first portion, a second portion, a third portion, and a fourth portion.

The turbofan engine of the preceding clause, the first portion of the hydraulic cylinder extending generally in the axial direction and being coupled to the unison ring at the joint.

The turbofan engine of any preceding clause, the second portion of the hydraulic cylinder being disposed radially inward of the first portion and being coupled to the first portion and to the unison ring at the joint.

The turbofan engine of any preceding clause, the third portion of the hydraulic cylinder extending forward from the joint.

The turbofan engine of any preceding clause, the fourth portion of the hydraulic cylinder being coupled to, and extending axially within, the third portion of the hydraulic cylinder.

The turbofan engine of any preceding clause, the first portion of the hydraulic cylinder being sealingly engaged with the third portion of the piston retainer.

The turbofan engine of any preceding clause, the second portion of the piston retainer being sealingly engaged with the first portion of the hydraulic cylinder.

The turbofan engine of any preceding clause, the piston being sealingly engaged with the second portion and the fourth portion of the hydraulic cylinder.

The turbofan engine of any preceding clause, the fan actuation system including one or more hydraulic chambers defined between the hydraulic cylinder, the piston, and the piston retainer.

The turbofan engine of the preceding clause, the one or more hydraulic chambers including a first hydraulic chamber, a second hydraulic chamber, and a third hydraulic chamber.

The turbofan engine of any preceding clause, the first hydraulic chamber being defined between first portion of the hydraulic cylinder, the second portion of the piston retainer, and the third portion of the piston retainer.

The turbofan engine of any preceding clause, the second hydraulic chamber being defined between the first portion of the hydraulic cylinder, the second portion of the hydraulic cylinder, the first portion of the piston retainer, and the second portion of the piston retainer.

The turbofan engine of any preceding clause, the third hydraulic chamber being defined between the second portion of the hydraulic cylinder, an aft end of the piston, and the first portion of the piston retainer,

The turbofan engine of any preceding clause, the first hydraulic chamber and the third hydraulic chamber being supplied with a hydraulic fluid at a first pressure, and the second hydraulic chamber being supplied with the hydraulic fluid at a second pressure.

The turbofan engine of any preceding clause, the first pressure and the second pressure being increased or decreased to cause the hydraulic cylinder to move axially forward or axially rearward to rotate the plurality of fan blades about the pitch axis.

The turbofan engine of any preceding clause, the fan actuation system comprising a hydraulic system that supplies the hydraulic fluid to the one or more hydraulic chambers.

The turbofan engine of any preceding clause, the hydraulic system including a pump to supply the hydraulic fluid to the one or more hydraulic chambers.

The turbofan engine of the preceding clause, the hydraulic system comprising an oil transfer bearing including a fixed portion with a plurality of fluid lines coupled to the pump.

The turbofan engine of the preceding clause, the oil transfer bearing including a sleeve that is rotatable about the fixed portion.

The turbofan engine of any preceding clause, the plurality of fluid lines including a first fluid line in fluid communication with the first hydraulic chamber, a second fluid line in fluid communication with the second hydraulic chamber, and a third fluid line in fluid communication the third hydraulic chamber.

The turbofan engine of any preceding clause, the plurality of fluid lines being coupled to the sleeve.

The turbofan engine of any preceding clause, the first hydraulic chamber and the third hydraulic chamber being provided with the hydraulic fluid at the same first pressure.

The turbofan engine of any preceding clause, the pump supplying the hydraulic fluid to the first hydraulic chamber and the third hydraulic chamber to increase the first pressure P1 and supplying the hydraulic fluid to the second hydraulic chamber to decrease the second pressure P2, to move the hydraulic cylinder in the rearward direction to rotate the plurality of fan blades towards the reverse position.

The turbofan engine of any preceding clause, the pump supplying the hydraulic fluid to the second hydraulic chamber to increase the second pressure P2 and supplying the hydraulic fluid to the first hydraulic chamber and the third hydraulic chamber to decrease the first pressure P1, to move the hydraulic cylinder in the forward direction to rotate the plurality of fan blades towards the feather position.

The turbofan engine of any preceding clause, the one or more actuators further comprising a pressurized pneumatic chamber filled with a pressurized gas to bias the hydraulic cylinder to move the plurality of fan blades to the feather position.

The turbofan engine of any preceding clause, a pressure of the pressurized gas in the pressurized pneumatic chamber being in a range from 720 psi to 920 psi.

The turbofan engine of any preceding clause, the pressurized gas in the pressurized pneumatic chamber causing the hydraulic cylinder to move rearward when the hydraulic system or the turbofan engine fails or is shut down.

The turbofan engine of any preceding clause, the fan actuation system not including a pitch lock device.

The turbofan engine of any preceding clause, the one or more radial thrust bearings being disposed between the plurality of trunnions and the disk such that the plurality of trunnions rotates with respect to the disk to rotate the plurality of fan blades about the pitch axis.

The turbofan engine of any preceding clause, the one or more radial thrust bearings transmitting a load from the plurality of fan blades to a static structure of the turbofan engine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the fan actuation system includes a pressurized pneumatic chamber that is filled with a pressurized gas that biases the plurality of fan blades to a feather position.

The turbofan engine of any preceding clause, wherein the fan actuation system includes one or more counterweights for reducing inertial loading associated with rotation of the plurality of fan blades.

The turbofan engine of any preceding clause, further comprising a core cowl, wherein the turbofan engine has a longitudinal centerline axis, and the core cowl is annular about the longitudinal centerline axis wherein the core cowl includes a core inlet that is annular about the longitudinal centerline axis.

The turbofan engine of any preceding clause, wherein the fan actuation system includes a hydraulic system that supplies hydraulic fluid for rotating the plurality of fan blades about the pitch axis.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 180.0 inches.

The turbofan engine of any preceding clause, wherein R_{TB} is in a range from 12 inches to 27 inches.

The turbofan engine of any preceding clause, wherein R_{TB} is in a range from 12 inches to 19 inches.

The turbofan engine of any preceding clause, wherein R_{TB} is in a range from 19 inches to 27 inches.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein A_{FH} is in a range from 25 inches to 75 inches.

The turbofan engine of any preceding clause, wherein A_{FB} is in a range from 16 inches to 23 inches.

The turbofan engine of any preceding clause, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 13, the fan actuation system length envelope being given by

$$\frac{{N}_{FB} \times {D}_{FT}}{{L}_{AXIAL} ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 40 inches, and A_{FB} is in a range from 17 inches to 20 inches.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 75 inches, and A_{FB} is in a range from 16 inches to 23 inches, and D_{FT} is in a range from 120.0 inches to 180.0 inches.

The turbofan engine of the preceding clause, wherein R_{TB} is in a range from 12 inches to 27 inches.

A turbofan engine for an aircraft, the turbofan engine including a fan having a plurality of fan blades coupled to a fan disk that is drivingly coupled to a fan shaft, the fan disk defining a disk bore, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by:

$$\frac{{N}_{FB} \times {D}_{FT}}{{L}_{AXIAL} ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan disk that is drivingly coupled to a fan shaft, the fan disk defining a disk bore, and the fan being an open fan, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{FT}}{{L}_{AXIAL} ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 85 inches, and A_{FB} is in a range of 10 inches to 23 inches, and D_{FT} is in a range of 120.0 inches to 192.0 inches.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine comprising a fan having a plurality of fan blades coupled to a fan shaft having one or more fan bearings, each of the plurality of fan blades being rotatable about a pitch axis and extending from a fan hub; a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings; and a control system including a hydraulic pump configured to output a hydraulic fluid to a first actuator of the one or more actuators; a primary control valve; a first controller configured to output a first control signal to the primary control valve when the control system is in a first control system state, the primary control valve configured to, responsive to the first control signal, direct a flow of the hydraulic fluid from the hydraulic pump to a first actuator of the one or more actuators to change a pitch angle of a first fan blade of the plurality of fan blades; a protection valve; and a protection valve controller configured to output a second control signal to the protection valve when the control system is in the first control system state, the protection valve configured to, responsive to the second control signal, adjust the flow of the hydraulic fluid from the primary control valve to the first actuator of the one or more actuators to adjust the pitch angle of the first fan blade, the fan actuation system configured to bias the plurality of fan blades to a feather position responsive to the control system being in a second control system state, the second control system state different than the first control system state.

The turbofan engine of any preceding clause, wherein the pressurized pneumatic chamber is filled with a pressurized gas that biases the plurality of fan blades to the feather position when the control system is in the second control system state.

The turbofan engine of any preceding clause, wherein the fan actuation system includes one or more counterweights for reducing inertial loading associated with rotation of the plurality of fan blades.

The turbofan engine of any preceding clause, wherein the one or more counterweights are to bias the plurality of fan blades to the feather position when the control system is in the second control system state.

The turbofan engine of any preceding clause, further comprising a turbo-engine, wherein the turbofan engine has a longitudinal centerline axis, and the turbo-engine is annular about the longitudinal centerline axis wherein the turbo-engine includes a core inlet that is annular about the longitudinal centerline axis.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein the protection valve controller is output the second control signal responsive to the pitch angle of the first fan blade being below a threshold pitch angle and an aircraft including the turbofan engine being in flight, the second control signal to prevent the hydraulic fluid from reaching a fine pitch chamber of a piston assembly.

The turbofan engine of any preceding clause, wherein the protection valve controller is to determine the pitch angle based on outputs of a sensor.

The turbo fan engine of any preceding clause, further including a piston, the first actuator operatively coupled to the position, wherein the outputs of the sensor are indicative of a position of the piston.

The turbofan engine of any preceding clause, wherein the fan is an open fan.

The turbofan engine of any preceding clause, wherein the fan is a ducted fan.

The turbofan engine of any preceding clause, wherein the first control signal is to cause the primary control valve to direct the hydraulic fluid to cause the first actuator to move the first fan blade to one of a fine pitch angle or a coarse pitch angle.

The turbofan engine of any preceding clause, wherein the protection valve includes a first port, a second port, a third port, a fourth port, and a valve spool, the first port and the second port of the protection valve fluidly coupled to a first port of the primary control valve, the third port of the protection valve fluidly coupled to a second port of the primary control valve, and the fourth port of the protection valve fluidly coupled to the hydraulic pump, wherein, when the valve spool is in a first position, the protection valve is to connect at least one of (a) the second port of the protection valve to a fine pitch chamber via the first actuator or (b) the third port of the protection valve to a coarse pitch chamber via first actuator.

The turbofan engine of any preceding clause, wherein the first actuator includes a first gallery and a second gallery, the second port coupled to the first gallery and the third port coupled to the second gallery.

The turbofan engine of any preceding clause, wherein, when the valve spool is in a second position, the protection valve is to connect the fourth port of the protection valve to the coarse pitch chamber via first actuator, and wherein, when the valve spool is in a third position, the protection valve is to connect the first port of the protection valve to the fine pitch chamber via the first actuator.

The turbofan engine of any preceding clause, wherein the protection valve controller is configured to cause the valve spool to move to the first position or the second position based on a speed of the fan.

The turbofan engine of any preceding clause, wherein the control system further includes a valve spool controller, the valve spool controller configured to cause the valve spool to move based on the control signal from the protection valve controller when the control system is in the first control system state.

The turbofan engine of any preceding clause, wherein, when the valve spool of the protection valve is in a third position, the valve spool plugs a fifth port of the protection valve and a sixth port of the protection valve to prevent the hydraulic fluid from the hydraulic pump from entering the coarse pitch chamber or the fine pitch chamber.

The turbofan engine of any preceding clause, wherein the control system further includes a ground valve assembly including a solenoid valve, the ground valve assembly to, when enabled, cause the hydraulic fluid to flow to a fine pitch chamber via the first actuator when the control system is in the first control system state.

The turbofan engine of any preceding clause, wherein the protection valve controller is to disable the ground valve assembly when the aircraft is in flight and the control system is in the first control system state; and enable the ground valve assembly when the aircraft is grounded and the control system is in the first control system state.

A turbofan engine for an aircraft, the turbofan engine including a fan having a plurality of fan blades coupled to a fan shaft having one or more fan bearings, each of the plurality of fan blades being rotatable about a pitch axis and extending from a fan hub; a nacelle that circumferentially surrounds the fan; a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches; and a control system including a hydraulic pump configured to output a hydraulic fluid to a first actuator of the one or more actuators; a primary control valve; a first controller configured to output a first control signal to the primary control valve when the control system is in a first control system state, the primary control valve configured to, responsive to the first control signal, direct a flow of the hydraulic fluid from the hydraulic pump to a first actuator of the one or more actuators to change a pitch angle of a first fan blade of the plurality of fan blades; a protection valve; and a protection valve controller configured to output a second control signal to the protection valve when the control system is in the first control system state, the protection valve configured to, responsive to the second control signal, adjust the flow of the hydraulic fluid from the primary control valve to the first actuator of the one or more actuators to adjust the pitch angle of the first fan blade, the fan actuation system configured to bias the plurality of fan blades to a feather position responsive to the control system being in a second control system state, the second control system state different than the first control system state.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub; a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches; and a control system including a hydraulic pump configured to output a hydraulic fluid to a first actuator of the one or more actuators; a primary control valve; a first controller configured to output a first control signal to the primary control valve when the control system is in a first control system state, the primary control valve configured to, responsive to the first control signal, direct a flow of the hydraulic fluid from the hydraulic pump to a first actuator of the one or more actuators to change a pitch angle of a first fan blade of the plurality of fan blades; a protection valve; and a protection valve controller configured to output a second control signal to the protection valve when the control system is in the first control system state, the protection valve configured to, responsive to the second control signal, adjust the flow of the hydraulic fluid from the primary control valve to the first actuator of the one or more actuators to adjust the pitch angle of the first fan blade, the fan actuation system configured to bias the plurality of fan blades to a feather position responsive to the control system being in a second control system state, the second control system state different than the first control system state.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings; and
a control system including:
a hydraulic pump configured to output a hydraulic fluid to a first actuator of the one or more actuators;
a primary control valve;
a first controller configured to output a first control signal to the primary control valve when the control system is in a first control system state, the primary control valve configured to, responsive to the first control signal, direct a flow of the hydraulic fluid from the hydraulic pump to a first actuator of the one or more actuators to change a pitch angle of a first fan blade of the plurality of fan blades;
a protection valve; and
a protection valve controller configured to output a second control signal to the protection valve when the control system is in the first control system state, the protection valve configured to, responsive to the second control signal, adjust the flow of the hydraulic fluid from the primary control valve to the first actuator of the one or more actuators to adjust the pitch angle of the first fan blade,
the fan actuation system configured to bias the plurality of fan blades to a feather position responsive to the control system being in a second control system state, the second control system state different than the first control system state.

2. The turbofan engine of claim 1, wherein the fan actuation system includes a pressurized pneumatic chamber is filled with a pressurized gas that biases the plurality of fan blades to the feather position when the control system is in the second control system state.

3. The turbofan engine of claim 1, wherein the fan actuation system includes one or more counterweights for reducing inertial loading associated with rotation of the plurality of fan blades.

4. The turbofan engine of claim 2, wherein the one or more counterweights are to bias the plurality of fan blades to the feather position when the control system is in the second control system state.

5. The turbofan engine of claim 1, further comprising a turbo-engine, wherein the turbofan engine has a longitudinal centerline axis, and the turbo-engine is annular about the longitudinal centerline axis wherein the turbo-engine includes a core inlet that is annular about the longitudinal centerline axis.

6. The turbofan engine of claim 1, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

7. The turbofan engine of claim 1, wherein the protection valve controller is output the second control signal responsive to the pitch angle of the first fan blade being below a threshold pitch angle and an aircraft including the turbofan engine being in flight, the second control signal to prevent the hydraulic fluid from reaching a fine pitch chamber of a piston assembly.

8. The turbofan engine of claim 1, wherein the protection valve controller is to determine the pitch angle based on outputs of a sensor.

9. The turbo fan engine of claim 1, further including a piston, the first actuator operatively coupled to the position, wherein the outputs of the sensor are indicative of a position of the piston.

10. The turbofan engine of claim 1, wherein the fan is an open fan.

11. The turbofan engine of claim 1, wherein the fan is a ducted fan.

12. The turbofan engine of claim 1, wherein the first control signal is to cause the primary control valve to direct the hydraulic fluid to cause the first actuator to move the first fan blade to one of a fine pitch angle or a coarse pitch angle.

13. The turbofan engine of claim 1, wherein the protection valve includes a first port, a second port, a third port, a fourth port, and a valve spool, the first port and the second port of the protection valve fluidly coupled to a first port of the primary control valve, the third port of the protection valve fluidly coupled to a second port of the primary control valve, and the fourth port of the protection valve fluidly coupled to the hydraulic pump, wherein, when the valve spool is in a first position, the protection valve is to connect at least one of (a) the second port of the protection valve to a fine pitch chamber via the first actuator or (b) the third port of the protection valve to a coarse pitch chamber via first actuator.

14. The turbofan engine of claim 13, wherein the first actuator includes a first gallery and a second gallery, the second port coupled to the first gallery and the third port coupled to the second gallery.

15. The turbofan engine of claim 13, wherein, when the valve spool is in a second position, the protection valve is to connect the fourth port of the protection valve to the coarse pitch chamber via first actuator, and wherein, when the valve spool is in a third position, the protection valve is to connect the first port of the protection valve to the fine pitch chamber via the first actuator.

16. The turbofan engine of claim 15, wherein the protection valve controller is configured to cause the valve spool to move to the first position or the second position based on a speed of the fan.

17. The turbofan engine of claim 16, wherein the control system further includes a valve spool controller, the valve spool controller configured to cause the valve spool to move based on the control signal from the protection valve controller when the control system is in the first control system state.

18. The turbofan engine of claim 16, wherein, when the valve spool of the protection valve is in a third position, the valve spool plugs a fifth port of the protection valve and a sixth port of the protection valve to prevent the hydraulic fluid from the hydraulic pump from entering the coarse pitch chamber or the fine pitch chamber.

19. The turbofan engine of claim 1, wherein the control system further includes a ground valve assembly including a solenoid valve, the ground valve assembly to, when enabled, cause the hydraulic fluid to flow to a fine pitch chamber via the first actuator when the control system is in the first control system state.

20. The turbofan engine of claim 19, wherein the protection valve controller is to:
disable the ground valve assembly when the aircraft is in flight and the control system is in the first control system state; and
enable the ground valve assembly when the aircraft is grounded and the control system is in the first control system state.
